(19) United States
(12) Patent Application Publication
(10) Pub. No.: US 2010/0101955 A1
(43) Pub. Date: Apr. 29, 2010

(54) CATALYTIC MATERIALS, ELECTRODES, AND SYSTEMS FOR WATER ELECTROLYSIS AND OTHER ELECTROCHEMICAL TECHNIQUES

(75) Inventors: Daniel G. Nocera, Winchester, MA (US); Matthew W. Kanan, Palo Alto, CA (US); Yogesh Surendranath, Cambridge, MA (US); Mircea Dinca, Cambridge, MA (US); Daniel A. Lutterman, Somerville, MA (US); Steven Y. Reece, Cambridge, MA (US); Arthur J. Esswein, Boston, MA (US)

Correspondence Address: WOLF GREENFIELD & SACKS, P.C., 600 ATLANTIC AVENUE, BOSTON, MA, 02210-2206, US

(73) Assignees: Massachusetts Institute of Technology, Cambridge, MA (US); Sun Catalytix Corporation, Cambridge, MA (US)

(21) Appl. No.: 12/486,694

(22) Filed: Jun. 17, 2009

Related U.S. Application Data
(60) Provisional application No. 61/073,701, filed on Jun. 18, 2008.
(60) Provisional application No. 61/084,948, filed on Jul. 30, 2008.
(60) Provisional application No. 61/103,879, filed on Oct. 8, 2008.
(60) Provisional application No. 61/146,484, filed on Jan. 22, 2009.
(60) Provisional application No. 61/179,581, filed on May 19, 2009.

(51) Int. Cl. C02F 1/469; C25B 11/06

(52) U.S. Cl. 204/547; 204/293

(57) ABSTRACT

Catalysts, electrodes, devices, kits, and systems for electrolysis which can be used for energy storage, particularly in the area of energy conversion, and/or production of oxygen, hydrogen, and/or oxygen and/or hydrogen containing species. Compositions and methods for forming electrodes and other devices are also provided.

### RELATED APPLICATIONS

This application claims the benefit of U.S. Provisional Patent Application Ser. No. 61/073,701, filed Jun. 18, 2008, entitled “Catalyst Compositions and Electrodes for Photosynthesis Replication and Other Electrochemical Techniques,” by Nocera, et al., U.S. Provisional Patent Application Ser. No. 61/084,948, filed Jul. 30, 2008, entitled “Catalyst Compositions and Electrodes for Photosynthesis Replication and Other Electrochemical Techniques,” by Nocera, et al., U.S. Provisional Patent Application Ser. No. 61/103,879, filed Oct. 8, 2008, entitled “Catalyst Compositions and Electrodes for Photosynthesis Replication and Other Electrochemical Techniques,” by Nocera, et al., U.S. Provisional Patent Application Ser. No. 61/146,484, filed Jan. 22, 2009, entitled “Catalyst Compositions and Electrodes for Photosynthesis Replication and Other Electrochemical Techniques,” by Nocera, et al., and U.S. Provisional Patent Application Ser. No. 61/179,581, filed May 19, 2009, entitled “Catalyst Compositions and Electrodes for Photosynthesis Replication and Other Electrochemical Techniques,” by Nocera, et al., each incorporated herein by reference.

### STATEMENT REGARDING FEDERALLY SPONSORED RESEARCH OR DEVELOPMENT

This invention was made with the support under the following government contract F32GM07782903 awarded by the National Institutes of Health and CHE-0533150 awarded by the National Science Foundation. The government has certain rights in the invention.

### FIELD OF THE INVENTION

The present invention relates to catalytic materials that can be used in the electrolysis of water, which can be used for energy storage, energy conversion, oxygen and/or hydrogen production, and the like. The invention also relates to compositions and methods for making and using catalytic materials, electrodes associated with such catalytic materials, related electrochemical and energy storage and delivery systems, and product delivery systems. The invention greatly affects the storage and/or transformation of energy, including solar energy, wind energy, and other renewable energy sources.

### BACKGROUND OF THE INVENTION

Electrolysis of water, that is, splitting water into its constituent elements oxygen and hydrogen gases, is a very important process not only for the production of oxygen and/or hydrogen gases, but for energy storage. Energy is consumed in splitting water into hydrogen and oxygen gases and, when hydrogen and oxygen gases are re-combined to form water, energy is released.

In order to store energy via electrolysis, catalysts are required which efficiently mediate the bond rearranging “water splitting” reaction to O₂ and H₂. The standard reduction potentials for the O₂/H₂O and H₂O/H₂ half-cells are given by Equation 1 and Equation 2.

O₂+4H⁺+4e⁻ [symbol] H₂O E°=+1.23−0.059(pH)V (1)

2H₂ [symbol] 4H⁺+4e⁻ E°=0.00−0.059(pH)V (2)

2H₂+O₂ [symbol] 2H₂O

For a catalyst to be efficient for this conversion, the catalyst should operate close to the thermodynamically-limiting value of each half reaction, which are defined by half-cell potentials, E°. Voltage in addition to E° that is required to attain a given catalytic activity, referred to as overpotential, limits the conversion efficiency and considerable effort has been expended by many researchers in efforts to reduce overpotential in this reaction. Of the two reactions, anodic water oxidation may be considered to be more complicated and challenging. It may be considered that oxygen gas production from water at low overpotential and under benign conditions presents the greatest challenge to water electrolysis. The oxidation of water to form oxygen gas requires removing four electrons coupled to the removal of four protons in order to avoid prohibitively high-energy intermediates. In addition to controlling multi-proton-coupled electron transfer reactions, a catalyst, in some cases, should also be able to tolerate prolonged exposure to oxidizing conditions.

Many researchers have explored water electrolysis. As an example, V.V. Strelets and co-workers used a rotating disc platinum electrode, a cobalt salt and, in some experiments, a phosphate-borate buffer, in water under generally alkaline conditions (pH of, for example, 8-14), varied the potential applied to the rotating platinum disc, and determined the half-cell potential of the catalytic wave as a function of pH. Strelets reports production of oxygen and, in some cases, hydrogen peroxide. Strelets reports catalysis in solution and the formation of a catalytically active particle in acidic form, for example, cobalt hydroxide. See Strelets et al., Union Conference on Polarography, October 1978, 256-258; and Shafirovich et al., Nouveau Journal de Chimie, 2(3), 1978, 199-201. In some his work, Strelets works to move the reaction into the body of the solution, for example using photochemical oxidants. See Shafirovich et al., Doklady Akademii Nauk SSSR, 250(5), 1980, 1197-1200; Shafirovich et. al., Nouveau Journal de Chimie, 4(2), 81-84; and Shafirovich et al., Nouveau Journal de Chimie, 6(4), 1982, 183-186. In addition, Strelets notes in some reviews that, “the problem of developing metal complex catalysts for water oxidation is still far from being solved.” See Efimov et al., Uspekhi Khimii, 57(2), 1988, 228-253; Efimov et al., Coordination Chemistry Reviews, 99, 1990, 15-53; and Strelets et al., Bulletin of Electrochemistry, 7(4) 1991, 175-185.

As another example, U.S. Pat. No. 3,399,966 to Suzuki, et al., describes a crystalline cobalt oxide compound deposited on an electrode for use in electrolysis. Suzuki, et al. described their electrode for use in electrolysis of water, sodium chloride, chlorate, or the like and measure, among other things, chlorine-evolving and oxygen-evolving potentials of electrodes.

While there have been significant studies involving materials and electrodes for electrolysis and other electrochemical reactions, there remains significant room for improvement.

### SUMMARY OF THE INVENTION

The present invention relates to catalytic materials for electrolysis of water, related electrodes, and systems for electrolysis. The invention provides systems that can operate at surprisingly low overpotentials, significant efficiency, at or near neutral pH, do not necessarily require highly pure water sources, or any combination of one or more of the above. Combinations of various aspects of the invention are useful in significantly improved energy storage, energy use, and optional commercial production of hydrogen and/or oxygen. The systems operate reproducibly, robustly, and can be made at low or moderate expense. The subject matter of the present invention involves, in some cases, interrelated products, alternative solutions to a particular problem, and/or a plurality of different uses of one or more systems and/or articles.

In some embodiments, the invention is directed to an electrode. In a first set of embodiments, an electrode comprises a catalytic material comprising cobalt ions and anionic species comprising phosphorus. In another set of embodiments, an electrode comprises a current collector and a catalytic material associated with the current collector, in an amount of at least about 0.01 mg of catalytic material per cm² of current collector surface interfacing the catalytic material, wherein the electrode is capable of catalytically producing oxygen gas from water with an overpotential of less than 0.4 volts at an electrode current density of at least 1 mA/cm².

In some embodiments, an electrode comprises a catalytic material absorbed or deposited on the electrode during at least some point of a reaction catalyzed by the catalytic material, wherein the electrode does not consist essentially of platinum, and is capable of catalytically producing oxygen gas from water at about neutral pH, with an overpotential of less than 0.4 volts at an electrode current density of at least 1 mA/cm².

In another set of embodiment, an electrode for catalytically producing oxygen gas from water comprises a current collector, wherein the current collector does not consist essentially of platinum, metal ionic species with an oxidation state of (n+x), and anionic species, wherein the metal ionic species and the anionic species define a substantially non-crystalline composition and have a Kₛₚ value which is less, by a factor of at least 10³, than the Kₛₚ value of a composition comprising the metal ionic species with an oxidation state of (n) and the anionic species.

In yet another set of embodiments, an electrode for catalytically producing oxygen gas from water comprises a current collector, wherein the current collector has a surface area of greater than about 0.01 m²/g, metal ionic species with an oxidation state of (n+x), and anionic species, wherein the metal ionic species and the anionic species define a substantially non-crystalline composition and have a Kₛₚ value which is less, by a factor of at least 10³, than the Kₛₚ value of a composition comprising the metal ionic species with an oxidation state of (n) and the anionic species. In some cases, an electrode for catalytically producing oxygen gas from water, comprises a current collector, metal ionic species with an oxidation state of (n+x), and anionic species, wherein the metal ionic species and the anionic species define a substantially non-crystalline composition and have a Kₛₚ value which is less, by a factor of at least 10³, than the Kₛₚ value of a composition comprising the metal ionic species with an oxidation state of (n) and the anionic species, and wherein the electrode is capable of catalytically producing oxygen gas from water with an overpotential of less than 0.4 volts at an electrode current density of at least 1 mA/cm².

In some embodiments, the invention is directed to systems. In one set of embodiments, a system for catalytically producing oxygen gas from water comprises an electrode, the electrode comprising a catalytic material comprising cobalt ions and anionic species comprising phosphorus. In another set of embodiments, a system for catalytically producing oxygen gas from water comprises a solution comprising water, cobalt ions, and anionic species comprising phosphorus and a current collector submerged in the solution, wherein, during use of the system, at least a portion of the cobalt ions and anionic species comprising phosphorus associate and dissociate from the current collector. In yet another set of embodiments, a system for catalytically producing oxygen gas from water comprises a first electrode comprising a current collector, metal ionic species, and anionic species, wherein the current collector does not consist essentially of platinum, a second electrode, wherein the second electrode is biased negatively with respect to the first electrode, and a solution comprising water, wherein the metal ionic species and the anionic species are in dynamic equilibrium with the solution.

In some cases, a system for catalytically producing oxygen gas from water comprises a first electrode comprising a current collector, metal ionic species, and anionic species, wherein the current collector has a surface area of greater than about 0.01 m²/g, a second electrode, wherein the second electrode is biased negatively with respect to the first electrode, and a solution comprising water, wherein the metal ionic species and the anionic species are in dynamic equilibrium with the solution. In other cases, a system for catalytically producing oxygen gas from water comprises a first electrode comprising a current collector, metal ionic species, and anionic species, a second electrode, wherein the second electrode is biased negatively with respect to the first electrode, and a solution comprising water, wherein the metal ionic species and the anionic species are in dynamic equilibrium with the solution, and wherein the first electrode is capable of catalytically producing oxygen gas from water at an overpotential of less than 0.4 volts at an electrode current density of at least 1 mA/cm². In yet other cases a system for electrolysis of water comprises a photovoltaic cell and a device for electrolysis of water, constructed and arranged to be electrically connected to and driven by the photovoltaic cell, the device comprising an electrode capable of catalytically converting water to oxygen gas at about ambient conditions, the electrode comprising a catalytic material that does not consist essentially of a metal oxide or metal hydroxide. In still yet other cases, a system for electrolysis of water comprises a container, an electrolyte in the container, a first electrode mounted in the container and in contact with the electrolyte, wherein the first electrode comprises metal ionic species with an oxidation state of (n+x) and anionic species, the metal ionic species and the anionic species defining a substantially non-crystalline composition, the composition having a to Kₛₚ value which is less, by a factor of at least 10³, than the Kₛₚ value of a composition comprising the metal ionic species with an oxidation state of (n) and the anionic species, a second electrode mounted in the container and in contact with the electrolyte, wherein the second electrode is biased negatively with respect to the first electrode, and means for connecting the first electrode and the second electrode, whereby when a voltage is applied between the first electrode and the second electrode, gaseous hydrogen is evolved at the second electrode and gaseous oxygen is produced at the first electrode.

In some embodiments, the invention is directed to a composition. In a first set of embodiments, a composition for an electrode comprises cobalt ions, and anionic species comprising phosphorus, wherein the ratio of cobalt ions to anionic species comprising phosphorus is between about 10:1 and about 1:10, and wherein the composition is capable of catalytically forming oxygen gas from water. In another set of embodiments, a composition able to catalyze the formation of oxygen gas from water obtainable by a process comprising exposing at least one surface of a current collector to a source of cobalt ions and anionic species comprising phosphorus, and applying a voltage to the current collector for a period of time to accumulate, proximate the surface of the current collector, a composition comprising at least a portion of the cobalt ions and anionic species comprising phosphorus. In yet another set of embodiments, a composition able to catalyze the formation of oxygen gas from water, is made by a process comprising exposing at least one surface of a current collector to a source of cobalt ions and an anionic species comprising phosphorus, and applying a voltage to the current collector for a period of time to accumulate, proximate the surface of the current collector, a composition comprising at least a portion of the cobalt ions and the anionic species comprising phosphorus.

In some embodiments, the invention is directed to methods. In a first set of embodiments a method comprises producing oxygen gas from water at an overpotential of less than 0.4 volts at an electrode current density of at least 1 mA/cm², wherein the water is obtained from an impure water source, and is not purified in a manner that changes its resistivity by a factor of more than 25% after being drawn from the source prior to use in the electrolysis. In another set of embodiments, a method comprises producing oxygen gas from water at an overpotential of less than 0.4 volts at an electrode current density of at least 1 mA/cm², wherein the water comprises at least one impurity that is substantially non-participative in the catalytic reaction, present in an amount of at to least 1 part per million in the water. In yet another set of embodiments, a method comprises producing oxygen gas from water at an overpotential of less than 0.4 volts at an electrode current density of at least 1 mA/cm², using water from a water source having a resistivity of less than 16 MΩ·cm that is not purified in a manner that changes its resistivity by a factor of more than 25% after being drawn from the source prior to use in the electrolysis.

In some cases, a method of catalytically producing oxygen gas from water comprises providing an electrochemical system comprising an electrolyte, a first electrode comprising a current collector, metal ionic species, and anionic species, wherein the current collector does not consist essentially of platinum, and a second electrode biased negatively with respect to the first electrode and causing the electrochemical system to catalyze the production of oxygen gas from water, wherein the metal ionic species and the anionic species participate in a catalytic reaction involving a dynamic equilibrium in which at least a portion of the metal ionic species are cyclically oxidized and reduced. In other cases, a method of catalytically producing oxygen gas from water, comprises providing an electrochemical system, comprising an electrolyte a first electrode comprising a current collector, metal ionic species and anionic species and a second electrode biased negatively with respect to the first electrode, and causing the electrochemical system to catalyze the production of oxygen gas from water, wherein the metal ionic species and the anionic species participate in a catalytic reaction involving a dynamic equilibrium in which at least a portion of the metal ionic species are cyclically oxidized and reduced. In yet other cases a method of catalytically producing oxygen gas from water comprises providing an electrochemical system comprising an electrolyte, a first electrode comprising a current collector, metal ionic species, and anionic species, wherein the current collector has a surface area of greater than about 0.01 m²/g, and a second electrode biased negatively with respect to the first electrode, and causing the electrochemical system to catalyze the production of oxygen gas from water, wherein the metal ionic species and the anionic species participate in a catalytic reaction involving a dynamic equilibrium in which at least a portion of the metal ionic species are cyclically oxidized and reduced. In still yet other cases, a method of catalytically producing oxygen gas from water comprises providing an electrochemical system comprising an electrolyte, a first electrode comprising a current collector, metal ionic species, and anionic species, and a second electrode biased negatively with respect to the first to electrode, and causing the electrochemical system to catalyze the production of oxygen gas from water, wherein the metal ionic species and the anionic species participate in a catalytic reaction involving a dynamic equilibrium in which at least a portion of the metal ionic species are cyclically oxidized and reduced, thereby associating and disassociating, respectively, from the current collector, and wherein the system is capable of catalyzing the producing oxygen gas from water with an overpotential of less than about 0.4 volts at an electrode current density of at least 1 mA/cm².

In a first set of embodiments, a method for making an electrode comprising providing a solution comprising metal ionic species and anionic species, providing a current collector, and causing the metal ionic species and the anionic species to form a composition associated with the current collector by application of a voltage to the current collector, wherein the metal ionic species and anionic species are able to catalytically producing oxygen gas from water with an overpotential of less than 0.4 volts at an electrode current density of at least 1 mA/cm². In another set of embodiments, a method for making an electrode comprises providing a solution comprising metal ionic species and anionic species, providing a current collector, and causing the metal ionic species and the anionic species to form a composition associated with the current collector by application of a voltage to the current collector, wherein the metal ionic species and anionic species are able to catalyze water electrolysis at a pH of from about 5.5 to about 9.5.

In some cases, a method for making an electrode comprises providing a solution comprising metal ionic species and anionic species, providing a current collector, wherein the current collector does not consist essentially of platinum, and causing the metal ionic species and the anionic species to form a composition associated with the current collector by application of a voltage to the current collector, wherein the composition does not consist essentially of metal oxide or metal hydroxide, and wherein the electrode can catalytically produce oxygen gas from water. In other cases, a method for making an electrode comprises providing a solution comprising metal ionic species and anionic species, providing a current collector, wherein the current collector has a surface area of greater than about 0.01 m²/g, and causing the metal ionic species and the anionic species to form a composition associated with the current collector by application of a voltage to the current collector, wherein the composition does not consist essentially of metal oxide or metal hydroxide, and wherein the electrode can catalytically produce oxygen gas from water. In yet other cases, a method for making an electrode comprises providing a solution comprising metal ionic species and anionic species, providing a current collector, and causing the metal ionic species and the anionic species to form a composition associated with the current collector by application of a voltage to the current collector, wherein the composition does not consist essentially of metal oxide or metal hydroxide, and wherein the electrode can catalytically produce oxygen gas from water with an overpotential of less than about 0.4 volts at an electrode current density of at least 1 mA/cm².

### BRIEF DESCRIPTION OF THE DRAWINGS

Non-limiting embodiments of the present invention will be described by way of example with reference to the accompanying figures, which are schematic and are not intended to be drawn to scale. Unless indicated as representing the prior art, the figures represent aspects of the invention. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B illustrate the formation of an electrode, according to one embodiment.

FIGS. 2A-2E illustrate the formation of a catalytic material on a current collector, according to one embodiment.

FIGS. 3A-3C illustrate a non-limiting example of a dynamic equilibrium of a catalytic material, according to one embodiment.

FIGS. 4A-4C represent an illustrative example of changes in oxidation state that may occur for a single metal ionic species during a dynamic equilibrium of an electrode, according to one embodiment, during use.

FIG. 5 shows an SEM image of a film grown from a KHCO₃ electrolyte, according to one embodiment.

FIG. 6 shows a non-limiting example of an electrolytic device.

FIG. 7 shows a non-limiting example of an electrochemical device of the invention.

FIG. 8A illustrates a non-limiting example of a regenerative fuel cell device.

FIG. 8B illustrates a non-limiting example of an electrolytic device employing water in a gaseous state.

FIG. 9A shows a cyclic voltammogram of a neutral phosphate buffer in the (i) absence and (ii) presence of Co⁺², according to one embodiment.

FIG. 9B shows a magnified area of the voltammogram shown in FIG. 9A.

FIG. 9C shows the current density profile for bulk electrolysis in a neutral phosphate electrolyte containing Co²⁺, in one embodiment.

FIG. 9D shows the current density profile as in FIG. 9C, but in the absence of co²⁺.

FIG. 10A shows an SEM image of a catalytic material, in a non-limiting embodiment.

FIG. 10B shows the powder X-ray diffraction pattern of a catalytic material, according to one embodiment.

FIG. 11 shows a graph of the overpotential vs. thickness of a catalytic material, according to some embodiments.

FIG. 12 shows the X-ray photoelectron spectroscopy of the catalytic material, in a non-limiting example.

FIG. 13A shows the mass spectrometric detection of isotopically-labeled (i) ^{16,16}O₂, (ii) ^{16,18}O₂, and (iii) ^{18,18}O₂ during electrolysis using an electrode in a neutral phosphate electrolyte containing 14.5% ¹⁸OH₂, according to one embodiment.

FIG. 13B shows an expansion of the ^{18,18}O₂ signal from FIG. 13A.

FIG. 13C shows the percent abundance of each isotope over the course of the experiment.

FIG. 13D shows the O₂ production (i) measured by fluorescent sensor and (ii) the theoretical amount of O₂ produced assuming a Faradaic efficiency of 100%, according to one embodiment.

FIG. 14A shows a Tafel plot of an electrode of the present invention in a phosphate buffer, according to one embodiment.

FIG. 14B shows the current density dependence on pH in an electrolyte comprising phosphate, according to one embodiment of the present invention.

FIG. 15 shows a graph of the current density of an electrode, in one embodiment, versus time for (i) an activated electrode in 0.1 M MePO₃ at pH 8.0 and (ii) an activated electrode in 0.1 M MePO₃ and 0.5 M NaCl at pH 8.0.

FIG. 16 shows the mass spectrometry results for the detection of (i) O₂, (ii) CO₂, and (iii) ³⁵Cl during electrolysis of water, in one embodiment.

FIG. 17 shows SEM images of film grown from MePi electrolyte upon passing 2 C/cm² (top) and 6 C/cm² (bottom), according to some embodiments.

FIG. 18 shows a graph of the dependence of solution resistance with pH for a H₃BO₃/KH₂BO₃ electrolyte (circles) overlaid on top of the speciation diagram for H₃BO₃ as a function of pH (lines).

FIG. 19 shows SEM images of film grown from Bi electrolyte upon passing 2 C/cm² (top) and 6 C/cm² (bottom), according to some embodiments.

FIG. 20 shows powder X-ray diffraction pattern of a catalytic material deposited from (i) Pi, (ii) MePi, and (iii) Bi.

FIG. 21 shows (A) bright field and (B) dark-field TEM images of the edge of a small particle detached from a Co-Pi film.

FIG. 21C shows an electron diffraction image with no diffraction spots, indicating an amorphous nature of a catalytic material, according to a non-limiting embodiment.

FIG. 22 shows a Tafel plot of a catalytic material deposited from and operated in 0.1 M Pi electrolyte at pH 7.0 (), in 0.1 M MePi electrolyte at pH 8.0 (▪), and in 0.1 M Bi electrolyte at pH 9.2 (▴), according to some embodiments.

FIG. 23 shows a photograph of an auxiliary chamber of a two compartment cell after prolonged electrolysis (8 h) starting with 0.5 M Co(SO₄) in the working chamber and 0.1 M K₂SO₄, pH 7.0, in the auxiliary chamber.

FIG. 24 shows a graph of the percentage of ⁵⁷Co leached from films of the Co-Pi catalytic material on an electrode with a potential bias of 1.3 V vs. NHE (▪) turned on and off at the times designated, and without an applied potential bias (), according to some embodiments.

FIG. 25 shows plots monitoring (A) ³²P leaching from Co-Pi catalytic material, and (B) ³²P uptake by the Co-Pi catalytic material on an electrode with an applied potential bias of 1.3 V vs. NHE (▪, dashed blocks) and on an unbiased electrode (, solid blocks), according to some embodiments.

FIG. 26 shows photographs of (A) two, (B) four, and (C) eight electrode arrays.

FIG. 27 shows a graph of the percentage of ⁵⁷Co leached from Co—X films on an electrode under a potential bias of 1.3 V () and 1.5 V (▪) vs. NHE and an unbiased electrode (▴), according to some embodiments.

FIG. 28 shows plots monitoring ⁵⁷Co leaching from Co—X films operated with no potential bias wherein (A) the electrode remained in solution throughout the experiment, and (B) the electrode was removed from solution prior to phosphate addition.

FIG. 29 shows plots monitoring ³²P leaching from Co-Pi films operated in 1 M KPi (pH 7.0) electrolyte with a potential bias of 1.3 V vs. NHE (▪) and without a bias ().

FIG. 30A shows the Fourier transforms of the extended x-ray absorption fine structure spectra of (i) Co-Pi at open circuit potential and (ii) CO₃O₄.

FIG. 30B shows the X-ray absorption near edge structure spectra for Co-Pi at (i) open current potential and at (ii) 1.25 V.

FIG. 31A shows a Tafel plot of a catalytic material operated using (i) a pure water source and (ii) and impure water source.

FIG. 31B shows a plot of the current density versus time for a catalytic material operated using an impure water source, according to one embodiment.

FIG. 32 shows an SEM image of a film comprising cobalt ions, manganese ions, and anionic species comprising phosphorus.

FIG. 33A shows the (i) first and (ii) second CV traces of a current collector in a solution comprising nickel anions and anionic species comprising boron, and (iii) a CV trace in the absence of Ni²⁺. The inset shows an expanded view of this figure.

FIG. 33B shows a Tafel plot of a catalytic material deposited from and operated in 0.1 M Bi, pH 9.2, according to one embodiment.

FIGS. 33C-E shows SEM images of a catalytic material comprising nickel anion and anionic species comprising boron, at various magnifications.

FIG. 33F shows the powder X-ray diffraction patterns for (i) ITO anode, and for (ii) a catalytic material comprising nickel anion and anionic species comprising boron deposited on an ITO substrate.

FIG. 33G shows the absorbance spectra of a catalytic material comprising nickel anion and anionic species comprising boron.

FIG. 33H shows the O₂ production (i) measured by fluorescent sensor and (ii) the theoretical amount of O₂ produced assuming a Faradaic efficiency of 100%, according to to one embodiment.

Other aspects, embodiments, and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

The present invention relates to a monumental leap forward in the electrolysis of water by providing a class of catalytic materials that facilitate the production of oxygen and/or hydrogen gas from water (Equations 1, 2 above) at low energy input (low “overpotential”). The ramifications of the invention are great: electrolysis of water, facilitated by the invention, is useful in a wide variety of areas, including in the storage of energy. The invention allows for the facile, low-energy conversion of water to hydrogen gas and/or oxygen gas, where this process can be easily driven by a standard solar panel (e.g., a photovoltaic cell), wind-driven generator, or any other power source that provides an electrical output. The solar panel or other power source can be used to directly provide energy to a user, and/or energy can be stored, via a reaction catalyzed by materials of the invention, in the form of oxygen gas and/or hydrogen gas. In some cases, the hydrogen and oxygen gases may be recombined at any time, for example, using a fuel cell, whereby they form water and release significant energy that can be captured in the form of mechanical energy, electricity, or the like. In other cases, the hydrogen and/or oxygen gases may be used together, or separately, in another process.

The invention provides not only new catalytic materials and compositions, but related electrodes, devices, systems, kits, processes, etc. Non-limiting examples of electrochemical devices provided by the invention include electrolytic devices and fuel cells. Energy can be supplied to electrolytic devices by photovoltaic cells, wind power generators, or other energy sources. These and other devices are described herein.

Many catalytic materials provided by the invention are made of readily-available, to low-cost material, and are easy to make. Accordingly, the invention has the potential to dramatically change the field of energy capture, storage, and use, as well as oxygen and/or hydrogen production, and/or production of other oxygen and/or hydrogen-containing products obtainable via systems and methods described herein. Described below are examples of catalytic materials, including metal ionic species such as cobalt, and anionic species containing phosphorus.

In all descriptions of the use of water for catalysis herein, it is to be understood that the water may be provided in a liquid and/or gaseous state. The water used may be relatively pure, but need not be, and it is one advantage of the invention that relatively impure water can be used. The water provided can contain, for example, at least one impurity (e.g., halide ions such as chloride ions). In some cases, the device may be used for desalination of water. It should be understood that while much of the application herein focuses on the catalytic formation of oxygen gas from water, this is by no means limiting, and the compositions, electrodes, methods, and/or systems described herein may be used for other catalytic purposes, as described herein. For example, the compositions, electrodes, methods and/or systems may be used for the catalytic formation of water from oxygen gas.

As noted, in some embodiments of the invention, catalytic materials and electrodes are provided which may produce oxygen gas and/or hydrogen gas from water. As shown in Equation 1, water may be split to form oxygen gas, electrons, and hydrogen ions. Although it need not be, an electrode and/or device may be operated in benign conditions (e.g., neutral or near-neutral pH, ambient temperature, ambient pressure, etc.). In some cases, the electrodes described herein operate catalytically. That is, an electrode may be able to catalytically produce oxygen gas from water, but the electrode might not necessarily participate in the related chemical reactions such that it is consumed to any appreciable degree. Those of ordinary skill in the art will understand the meaning of “catalytically” in this context. An electrode may also be used for the catalytic production of other gases and/or materials.

In some embodiments, an electrode of the present invention comprises a current collector and a catalytic material associated with the current collector. A “catalytic material” as used herein, means a material that is involved in and increases the rate of a chemical electrolysis reaction (or other electrochemical reaction) and which, itself, undergoes reaction as part of the electrolysis, but is largely unconsumed by the reaction itself, and may participate in multiple chemical transformations. A catalytic material may also be referred to as a catalyst and/or a catalyst composition. A catalytic material is not simply a bulk current collector material which provides and/or receives electrons from an electrolysis reaction, but a material which undergoes a change in chemical state of at least one ion during the catalytic process. For example, a catalytic material might involve a metal center which undergoes a change from one oxidation state to another during the catalytic process. Thus, catalytic material is given its ordinary meaning in the field in connection with this invention. As will be understood from other descriptions herein, a catalytic material of the invention that may be consumed in slight quantities during some uses and may be, in many embodiments, regenerated to its original chemical state.

In some embodiments, an electrode of the present invention comprising a current collector and a catalytic material associated with the current collector. A “current collector,” as used herein, is given two alternative definitions. In a typical arrangement of the invention, a catalytic material is associated with a current collector which is connected to an external circuit for application of voltage and/or current to the current collector, for receipt of power in the form of electrons produced by a power source, or the like. Those of ordinary skill in the art will understand the meaning of current collector in this context. More specifically, the current collector refers to the material between the catalytic material and the external circuit, through which electric current flows during a reaction of the invention or during formation of the electrode. Where a stack of materials are provided together including both an anode and a cathode, and one or more catalytic materials associated with the cathode and/or anode, where current collectors may be separated by membranes or other materials, the current collector of each electrode (e.g., anode and/or cathode) is that material through which current flows to or from the catalytic material and external circuitry connected to the current collector. In the case of a current collector thus far described, the current collector will typically be an object, separate from the external circuit, easily identifiable as such by those of ordinary skill in the art. The current collector may comprise more than one material, as described herein. In another arrangement, a wire connected to an external circuit may, itself, define the current collector. For example, a wire connected to external circuitry may have an end portion on which is absorbed a catalytic material for contact with a solution or other material for electrolysis. In such a case, the current collector is defined as that portion of the wire on which catalytic material is absorbed.

As used herein, a “catalytic electrode” is a current collector, in addition to any catalytic material adsorbed thereto or otherwise provided in electrical communication with (as defined herein) the current collector. The catalytic material may comprise metal ionic species and anionic species (and/or other species), wherein the metal ionic species and anionic species are associated with the current collector. The metal ionic species and anionic species may be selected such that, when exposed to an aqueous solution (e.g., an electrolyte or water source), the metal ionic species and anionic species may associate with the current collector though a change in oxidation state of the metal ionic species and/or through a dynamic equilibrium with the aqueous solution, as described herein. Where “electrode” is used herein to describe what those of ordinary skill in the art would understand to be the “catalytic electrode,” it is to be understood that a catalytic electrode as defined above is intended.

“Electrolysis,” as used herein, refers to the use of an electric current to drive an otherwise non-spontaneous chemical reaction. For example, in some cases, electrolysis may involve a change in redox state of at least one species and/or formation and/or breaking of at least one chemical bond, by the application of an electric current. Electrolysis of water, as provided by the invention, can involve splitting water into oxygen gas and hydrogen gas, or oxygen gas and another hydrogen-containing species, or hydrogen gas and another oxygen-containing species, or a combination. In some embodiments, devices of the present invention are capable of catalyzing the reverse reaction. That is, a device may be used to produce energy from combining hydrogen and oxygen gases (or other fuels) to produce water.

There are many benefits to the electrode compositions of the invention, and to the provided methods for producing the electrodes and compositions. For example, the electrodes may reduce and/or avoid the use of noble metals (e.g., platinum), and therefore, may be low in cost to produce. Methods for forming an electrode can be easily adapted and may be used to produce electrodes of varying sizes and shapes, as described herein. In addition, the electrodes produced by the provided methods may be robust and long-lived, and may be resistant to poisoning by acidic, basic, and/or environmental conditions (e.g., the presence of carbon monoxide). Electrode poisoning may be described as any chemical or physical change in the status of the electrode that may to diminish or limit the use of an electrode in an electrochemical device and/or lead to erroneous measurements. Electrode poisoning may manifest itself as the development of unwanted coatings, and/or precipitates, associated with the electrode. For example, platinum catalysts are often poisoned by the presence of carbon monoxide. Resistance to poisoning exhibited by electrodes of the invention may be facilitated by regenerative properties, exhibited in accordance with some embodiments, as described herein.

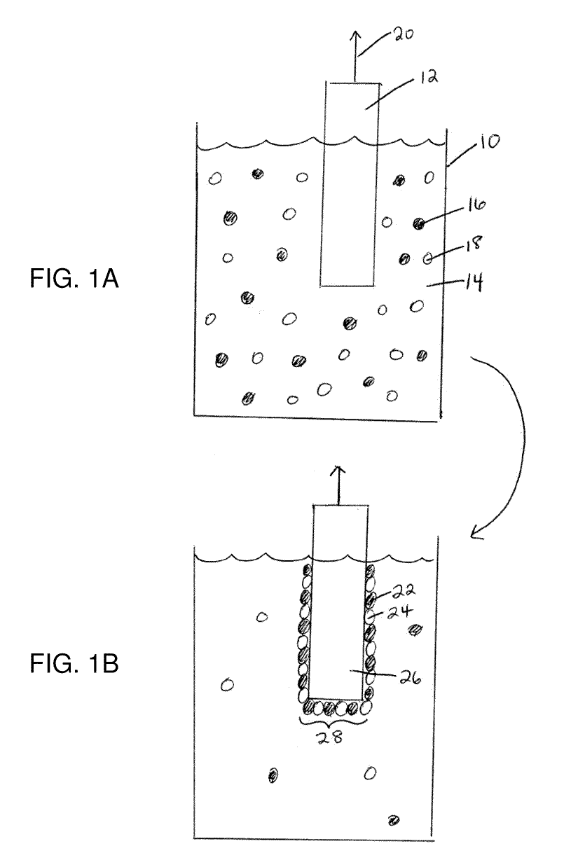

FIG. 1 depicts a non-limiting example of an electrode, and also depicts a non-limiting example of a formation of an electrode, according to one embodiment of the invention. FIG. 1A shows container 10 comprising current collector 12 and source (e.g., an aqueous solution) 14 in which are suspended, but more typically dissolved, metal ionic species 16 and anionic species 18. Current collector 12 is in electrical communication 20 with a circuit including a power source (not shown) such as a photovoltaic cell, wind power generator, electrical grid, or the like. It should be understood, however, that the catalytic material associated with the current collector may comprise additional components (e.g., a second type of anionic species), as described herein. FIG. 1B shows the arrangement of FIG. 1A upon application of a sufficient voltage to the current collector under conditions causing association of catalytic material to the current collector. As shown, metal ionic species 22 and anionic species 24 associate with the current collector 26 to form a deposited catalytic material 28 under these conditions. In some cases, when associating with the current collector, the metal ionic species may be oxidized or reduced as compared to the metal ionic species in solution, as described herein. In some cases, association of the metal ionic species with the current collector may comprise a change in oxidation state of the metal ionic species from (n) to (n+x), wherein x may be 1, 2, 3, and the like.

Where a catalytic material is associated with a current collector in this manner in accordance with the invention, it typically accumulates in the form of a solid or near-solid at the current collector surface, upon exposure to an appropriate precursor solution and application of a voltage under appropriate conditions as described herein. Some of those conditions involve exposing the current collector to the forming conditions for a period of time, and at a voltage, such that a threshold amount of catalytic material associates with the current collector. Various embodiments of the invention involve various amounts of such material, as described elsewhere herein.

Electrodes as described herein may be formed prior to incorporation in a to functional device (e.g., electrolysis device, fuel cell, or the like) or may be formed during operation of such a device. For example, in some cases, an electrode may be formed using methods described herein (e.g., exposing a current collector to a solution comprising metal ionic species and anionic species, followed by application of a voltage to the current collector and association of a catalytic material comprising the metal ionic species and anionic species with the current collector). The electrode may then be incorporated into a device (e.g., a fuel cell). As another example, in some cases, a device may comprise a current collector, and a solution (e.g., electrolyte) comprising metal ionic species and anionic species. Upon operation of the device (e.g., application of a potential between the current collector and a second electrode), a catalytic material (e.g., comprising the metal ionic species and anionic species from the solution) may be associated with the current collector, thereby forming an electrode in the device. After formation of the electrode, the electrode can be used for purposes described herein with or without change in environment (e.g., change in solution or other medium to which the electrode is exposed), depending upon the desired formation and/or use medium, which would be apparent to those of ordinary skill in the art.

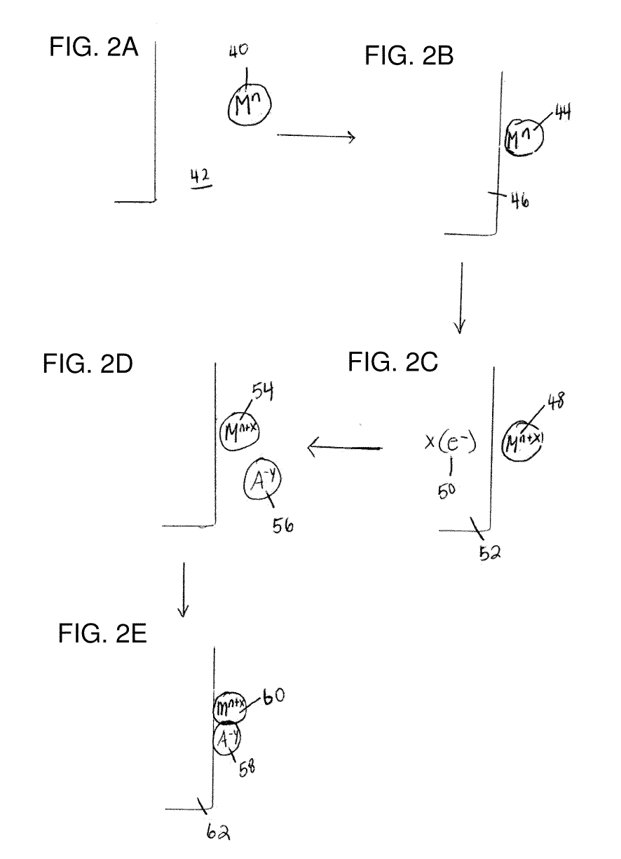

Without wishing to be bound by theory, the formation of a catalytic material on a current collector may proceed according to the following example. A current collector may be immersed in a solution comprising metal ionic species (M) with an oxidation state of (n) (e.g., Mⁿ) and anionic species (e.g., A^{-y}). As voltage is applied to the current collector, metal ionic species near to the current collector may be oxidized to an oxidation state of (n+x) (e.g., M^{(n+x)}). The oxidized metal ionic species may interact with an anionic species near the electrode to form a substantially insoluble complex, thereby forming a catalytic material. In some cases, the catalytic material may be in electrical communication with the current collector. A non-limiting example of this process is depicted in FIG. 2. FIG. 2A shows a single metal ionic species 40 with an oxidation state of (n) in solution 42. Metal ionic species 44 may be near current collector 46, as depicted in FIG. 2B. As shown in FIG. 2C, metal ionic species may be oxidized to an oxidized metal ionic species 48 with an oxidation state of (n+x) and (x) electrons 50 may be transferred to current collector 52 or to another species near or associated with the metal ionic species and/or the current collector. FIG. 2D depicts a single anionic species 54 nearing oxidized metal ionic species 56. In some instances, as depicted in FIG. 2E, anionic species 58 and oxidized metal ionic species 60 may associate with current collector 62 to form a catalytic material. In some instances, the oxidized metal ionic species and the anionic species may interact and form a complex (e.g., a salt) before associating with the electrode. In other instances, the metal ionic species and anionic species may associate with each other prior to oxidation of the metal ionic species. In other instances, the oxidized metal ionic species and/or anionic species may associate directly with the current collector and/or with another species already associated with the current collector. In these instances, the metal ionic species and/or anionic species may associate with the current collector (either directly, or via formation of a complex) to form the catalytic material (e.g., a composition associated with the current collector).

In some cases, an electrode may be formed by immersing a current collector comprising metal ionic species and/or anionic species (e.g., an electrode comprising cobalt ions, an electrode comprising cobalt ions and anionic species, and/or an electrode comprising a current collector and a catalytic material, the catalytic material associated with the current collector and comprising cobalt ions and hydroxide and/or oxide ions) in a solution comprising ionic species (e.g., phosphate). The metal ionic species (e.g., in an oxidation state of Mⁿ) may be oxidized and/or may dissociate from the current collector into solution. The metal ionic species that are oxidized and/or dissociated from the current collector may interact with anionic species and/or other species, and may re-associate with the current collector, thereby re-forming a catalytic material.

As noted above, one aspect of the invention involves an efficient and robust catalytic material for electrolysis of water (and/or other electrochemical reactions) that is primarily current collector-associated, rather than functioning largely as a homogeneous solution-based catalytic materials. Such a catalytic material “associated with” a current collector will now be described with reference to a metal ionic species and/or anionic species which can define a catalytic material of the invention. In some cases, the anionic species and the metal ionic species may interact with each other prior to, simultaneously to, and/or after the association of the species with the current collector, and result in a catalytic material with a high degree of solid content resident on, or otherwise immobilized with respect to, the current collector. In this arrangement, the catalytic material can be solid including various degrees of electrolyte or solution (e.g., the material can be hydrated with various amounts of water), and/or other species, fillers, or the like, but a unifying feature among such catalytic material associated with current collectors is that they can be observed, visually or through other techniques described more fully below, as largely resident on or immobilized with respect to the current collector, either in electrolyte solution or after removal of the current collector from solution.

In some cases, the catalytic material may associate with the current collector via formation of a bond, such as an ionic bond, a covalent bond (e.g., carbon-carbon, carbon-oxygen, oxygen-silicon, sulfur-sulfur, phosphorus-nitrogen, carbon-nitrogen, metal-oxygen, or other covalent bonds), a hydrogen bond (e.g., between hydroxyl, amine, carboxyl, thiol, and/or similar functional groups), a dative bond (e.g., complexation or chelation between metal ions and monodentate or multidentate ligands), Van der Waals interactions, and the like. “Association” of the composition (e.g., catalytic material) with the current collector would be understood by those of ordinary skill in the art based on this description. In some embodiments, the interaction between a metal ionic species and an anionic species may comprise an ionic interaction, wherein the metal ionic species is directly bound to other species and the anionic species is a counterion not directly bound to the metal ionic species. In a specific embodiment, an anionic species and a metal ionic species form an ionic bond and the complex formed is a salt.

A catalytic material associated with a current collector will most often be arranged with respect to the current collector so that it is in sufficient electrical communication with the current collector to carry out purposes of the invention as described herein. “Electrical communication,” as used herein, is given its ordinary meaning as would be understood by those of ordinary skill in the art whereby electrons can flow between the current collector and the catalytic material in a facile enough manner for the electrode to operate as described herein. That is, charge may be transferred between the current collector and the catalytic material (e.g., the metal ionic species and/or anionic species present in the catalytic material).

In some embodiments, the catalytic material and the current collector may be integrally connected. The term “integrally connected,” when referring to two or more objects or materials, means objects and/or materials that do not become separated from each other during the course of normal use, e.g., separation requires at least the use of tools, and/or by causing damage to at least one of the components, for example, by breaking, peeling, dissolving, etc. A catalytic material may be considered to be associated with, or otherwise in direct electrical communication with a current collector to during operation of an electrode comprising the catalytic material and current collector even in instances where a portion of the catalytic material may be dissociated from the current collector (e.g., when taking part in a catalytic process involving a dynamic equilibrium in which catalytic material is repeatedly removed from and re-associated with a current collector).

One aspect of the invention involves the development of a regenerative catalytic electrode. As used herein, a “regenerative electrode” refers to an electrode which is capable of being compositionally regenerated as it is used in a catalytic process, and/or over the course of a change between catalytic use settings. Thus, a regenerative catalytic electrode of the invention is one that includes one more species associated with the electrode (e.g., adsorbed on the electrode) which, under certain conditions, dissociate from the electrode, and then a significant portion or substantially all of those species re-associate with the electrode at a later point in the electrode's life or use cycle. For example, at least a portion of the catalytic material may dissociate from the electrode and become solvated or suspended in a fluid to which the electrode is exposed, and then become re-associated (e.g., adsorbed) at the electrode. The disassociation/re-association may take place as a part of the catalytic process itself, as catalytic species cycle between various states (e.g., oxidation states), in which they are more or less soluble in the fluid. This phenomenon during use, for example nearly or essentially steady-state use of the electrode, can be defined as a dynamic equilibrium. “Dynamic equilibrium,” as used herein, refers to an equilibrium comprising metal ionic species and anionic species, wherein at least a portion of the metal ionic species are cyclically oxidized and reduced (as discussed elsewhere herein). Regeneration over the course of a change between catalytic use settings can be defined by a dynamic equilibrium which experiences a significant delay in its cyclical nature.

In some embodiments, at least a portion of the catalytic material may dissociate from the electrode and become solvated or suspended in the fluid (or solution and/or other medium) as a result of a significant reaction setting change, and then become re-associated at a later stage. A significant reaction setting change, in this context, can be a significant change in potential applied to the electrode, significantly different current density at the electrode, significantly different properties of a fluid to which the electrode is exposed (or removal and/or changing of the fluid), or the like. In one embodiment, the electrode is exposed to catalytic conditions under which the catalytic material catalyzes a reaction, then the circuit of which the electrode is a part is changed so that the catalytic reaction is significantly slowed or even essentially stopped (e.g., the process is turned off), and then the system can be returned to the original catalytic conditions (or similar conditions that promote the catalysis), and at least a portion or essentially all of the catalytic material can re-associate with the electrode. Re-association of some or essentially all of the catalytic material with the electrode can occur during use and/or upon change in conditions as noted above, and/or can occur upon exposure of the catalytic material, the electrode, or both to a regenerative stimulus such as a regenerative electrical potential, current, temperature, electromagnetic radiation, or the like. In some cases, the regeneration may comprise a dynamic equilibrium mechanism involving oxidation and/or reduction processes, as described elsewhere herein.

Regenerative electrodes of the invention can exhibit disassociation and re-association of catalytic species at various levels. In one set of embodiments, at least 0.1% by weight of catalytic material associated with the electrode disassociates as described herein, and in other embodiments as much as about 0.25%, about 0.5%, about 0.6%, about 0.8%, about 1.0%, about 1.25%, about 1.5%, about 1.75%, about 2.0%, about 2.5%, about 3%, about 4%, about 5%, or more of the catalytic material disassociates, and some or all re-associates as discussed. In various embodiments, of the amount of material that disassociates, at least about 50%, at least about 60%, at least about 70%, at least about 80%, at least about 85%, at least about 90%, at least about 95%, at least about 97%, at least about 98%, at least about 99%, or essentially all material re-associates. Those of ordinary skill in the art will understand the meaning of disassociation and re-association of material in this regard, and will know of techniques for measuring these factors (for example, scanning electron microscopy and/or elemental analyses of the electrode, chemical analysis of the fluid, electrode performance, or any combination). Further, those of ordinary skill in the art will quickly be able to select catalytic materials which meet these parameters with knowledge of solubilities and/or catalytic reaction screening, or combinations. As a specific example, in some cases, during use of a catalytic material comprising cobalt ions and anionic species comprising phosphorus, at least a portion of the cobalt ions and the anionic species comprising phosphorus periodically associate and dissociate from the electrode.

Catalytic materials of the invention may also exhibit significant robustness through varying levels of use in a way that is a significant improvement over the general state of the art. Through a mechanism that may be related to regeneration as described herein, systems and/or electrodes employing catalytic materials of the invention may be operated at varying rates of applied energy, as would result from being driven by power sources which vary wind power which can vary, solar power which generally varies over the daily cycle and weather patterns, etc., and including going through full on/off cycles, with robustness. In particular, systems and/or electrodes of the invention may be cycled such that potential and/or current supplied to the system and/or electrode is reduced by at least about 20%, at least about 40%, at least about 60%, at least about 80%, at least about 90%, at least about 95%, or essentially 100% from peak use current, for at least from a period of about 2 minutes, at least about 5 minutes, at least about 10 minutes, at least about 20 minutes, at least about 30 minutes, at least about 1 hour, at least about 2 hours, at least about 3 hours, at least about 5 hours, at least about 8 hours, at least about 12 hours, at least about 24 hours or greater, and cycled at least about five times, at least about 10 times, at least about 20 times, at least about 50 times, or more, while overall performance (e.g., overpotential at a selected current density, production of oxygen gas, production of water, etc.) of the system and/or electrode, decreases by no more than about 20%, no more than about 10%, no more than about 8%, no more than about 6%, no more than about 4%, no more than about 3%, no more than about 2%, no more than about 1%, or the like. In some cases, the performance measurement may be taken at about the same period of time after reapplication of the voltage/current to the electrode/system (e.g., after voltage/current has been reapplied to the electrode/system for about 1 minute, about 5 minutes, about 10 minutes, about 30 minutes, about 60 minutes, etc.).

It should be understood, however, in some embodiments, that not every metal ionic species and/or anionic species which exhibits a change in oxidation state will dissociate and re-associate with a current collector. In some cases, only a small portion (e.g., less than about 20%, less than about 15%, less than about 10%, less than about 5%, less than about 2%, less than about 1%, or less) of the oxidized/reduced metal ionic species may dissociate/associate with the current collector during operation or between uses.

Those of ordinary skill in the art also will quickly recognize the significance of the contribution of this aspect (e.g., regeneration mechanism) of the invention to the to field. It is known that degradation of catalytic materials and electrodes can be problematic during their use, or especially when they are shut off between uses, especially in the case of metal organic, inorganic, and/or organometallic catalytic materials exposed to conditions previously assumed necessary for standard catalytic processes, and/or conditions described in accordance with catalysis according to the present invention (e.g., metal oxides and/or hydroxides or other catalytic materials used in processes at high pH). Without wishing to be bound by any theory, the inventors believe their development of regenerative catalytic electrodes relates to selection of species with high enough stability under catalytic conditions described herein, and/or combination of this feature with the process of some amount of catalytic material loss from the electrode followed by re-association of the material with the electrode, which is believed to involve a material cleansing process. The regeneration mechanism may also inhibit unwanted coating or other accumulation of auxiliary species, which do not play a role in the catalytic process and which may inhibit catalysis and/or other performance characteristics.

Regenerative electrodes of the invention also exhibit strong and surprising performance associated with their regenerative properties. Thus, in various embodiments, a regenerative catalytic electrode of the invention not only has good long-term robustness, but exhibits surprisingly good stability even upon significant variations in its use. Significant use variations can involve the electrode and its corresponding catalysis system being switched from on to off states, or other significant changes in use profile. This can be particularly important where the electrode is used in a process driven by a source of energy such as wind power or solar power, tidal power capture, where variation in the energy source (e.g., wind strength or sun intensity) can vary dramatically. In such a situation, an electrode of the invention may be operating at essentially full capacity at times, and be switched off at times (e.g., where an electrical circuit in which the electrode exists is in an “open” position). The electrode of the invention exhibits robustness such that, when it is operated at or close to its highest capacity for catalysis, i.e., at its highest rate of catalysis, and then switched off (“open circuit”), and this is repeated at least ten times, the electrode exhibits less than about 10%, less than about 5%, less than about 4%, less than about 3%, less than about 2%, less than about 1%, less than about 0.5%, or less than about 0.25% loss in performance. In this case, performance can be measured as current density at a particular set overpotential, with all other conditions being essentially identical between all tests. Of course, the electrode need not necessarily be switched between essentially full capacity and off in this way, but an electrode of the invention, when treated in this way, can exhibit a level of robustness.

In some cases, the electrode may be capable of regeneration, as described herein, in a closed system. That is, the electrode may be capable of regeneration without removal and/or addition of any material(s) that aids and/or assists in the regeneration of the electrode. Alternatively, removal of and/or addition of such material in only small amounts in various embodiments, such as, for example, no more than about 1% by weight, or no more than about 2%, 4%, 6%, 10%, or more, by weight of such material. For example, in instances where the electrode comprises a regenerative catalytic material, the catalytic material may be capable of regeneration without addition of any of the components comprised in the catalytic material (e.g., metal ionic species and/or anionic species where the catalytic material is composed of these materials) in such a closed system, or addition of one or such components in amounts no more than those described above in various embodiments. It should be understood, however, that a “closed system” as used herein does not exclude addition or removal of species that do not define, or can not react within the system to define, the catalytic material. For example, additional fuel and/or water may be provided to such a system.

In many cases, catalytic materials, in general, suffer from instability. Many catalytic materials that would be ideally used for water electrolysis, ammonia production, polymerization, hydrocarbon cracking, or other processes, specifically catalytic materials that are metal-centered redox catalytic materials, can be unstable by virtue of the redox process itself. For example, where a metal center contained in a catalytic material is transformed through various redox states (different states of charge of the metal center), in one or more of those redox states inherent in the catalytic process, the metal center and surrounding atoms may be unstable and may decompose to varying degrees. This characteristic has driven significant research towards developing stable catalytic materials for a variety of purposes. However, instability remains a significant challenge in many areas of catalysis.

The principals of the present invention can be used to increase stability in connection with essentially any redox-active catalytic material in which, in at least one redox state, the catalytic material is less stable than desired under the specific conditions of catalysis. For example, in the case of a catalytic material desirably used in essentially solid form associated with an electrode or other substrate, where, during the catalytic cycle, the catalytic material in one or more of the metal center redox states is appreciably soluble in the medium to which it is exposed, the catalytic material can migrate from the catalytic material and, in many cases, be lost. In connection with the present invention, a species such as an anionic species can be selected based upon Kₛₚ characteristics of the metal ionic species comprised in the catalytic material, where the anionic species promotes catalytic material deposition rather than dissolution. The anionic species can be selected to establish a pathway through which the catalytic material solubilized (e.g., metal ionic species) during one of its redox states is captured by the added anionic species by transformation into a form that is less soluble and causes the catalytic material to be retained at or returned to the electrode or other substrate. A cycle can be established, in this way, in which the metal ionic species is effective catalytically but rather than being lost to the surrounding medium by being solubilized in one of its redox states, is involved in a cycle in which it is returned to the electrode for further catalytic activity. Based upon the teachings herein, those of ordinary skill in the art can select suitable anionic species or other additives for a particular catalytic material for regeneration in this way.

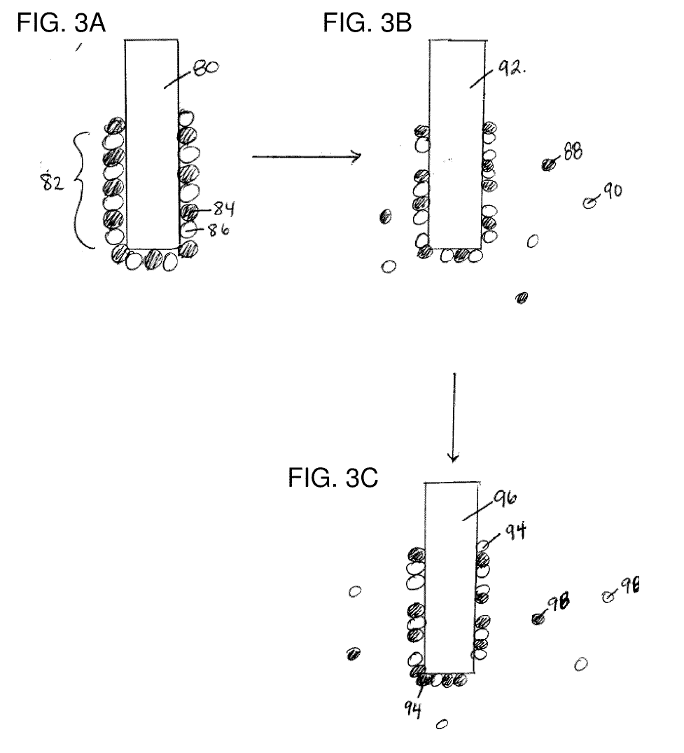

In some embodiments, a dynamic equilibrium may comprise at least a portion of the metal ionic species being cyclically oxidized and reduced, wherein the metal ionic species are thereby associated and disassociated, respectively, from the current collector. An example of a dynamic equilibrium (or regenerative mechanism) which can, but need not necessarily, take place in accordance with the invention is depicted in FIG. 3. FIG. 3A depicts an electrode comprising current collector 80 and catalytic material 82 comprising metal ionic species 84 and anionic species 86. The dynamic equilibrium is depicted in FIGS. 3B-3C. FIG. 3B shows the same electrode, wherein a portion of metal ionic species 88 and anionic species 90 have disassociated from current collector 92. FIG. 3C shows the same electrode at some point later in time where a portion of the metal ionic species and anionic species (e.g., 94) which disassociated from the current collector have re-associated with current collector 96. Additionally, different metal ionic species and anionic species (e.g., 98) may have disassociated from the current collector. Metal ionic species and anionic species can repeatedly disassociate and associate with the current collector. For example, the same metal ionic species and anionic species may to disassociate and associate with the current collector. In other instances, the metal ionic species and/or anionic species may only disassociate and/or associate with the current collector once. A single metal ionic species may associate with the current collector simultaneously as a second single metal ionic species disassociates from the electrode. The number of single metal ionic species and/or single anionic species that may disassociate and/or associate simultaneously and/or within the lifetime of the electrode has no numerical limit.

It should be understood that a solution in which metal ionic species and/or anionic species may be solubilized may be transiently present (e.g., the solution might not necessarily be in contact with the current collector during the entire operation and/or formation of the electrode). For example, in instances where water is provided to the electrode in a gaseous state, in some embodiments, the solution may be comprised of transiently formed aqueous molecules and/or droplets on the surface of the electrode and/or electrolyte. In other instances, where the electrolyte is a solid, the solution may be present in addition to the electrolyte (e.g., as water droplets on the surface of the electrode and/or solid electrolyte) or in combination with the fuel (e.g., water). The electrode may be operated with a combination of solid electrolyte/gaseous fuel, fluid electrolyte/gaseous fuel, solid electrolyte/fluid fuel, fluid electrolyte/fluid fuel, or any combination thereof.

In some embodiments, the metal ionic species in solution may have an oxidation state of (n), while the metal ionic species associated with the current collector may have an oxidation state of (n+x), wherein x is any whole number. The change in oxidation state may facilitate the association of the metal ionic species on the current collector. It may also facilitate the oxidation of water to form oxygen gas or other electrochemical reactions. The cyclically oxidized and reduced oxidation states for a single metal ionic species in dynamic equilibrium may be expressed according to Equation 3:

Mⁿ [symbol] M^{(n+x)}+x(e⁻) (3)

where M is a metal ionic species, n is the oxidation state of the metal ionic species, x is the change in the oxidation state, and x(e⁻) is the number of electrons, where x may be any whole number. In some cases, the metal ionic species may be further oxidized and/or reduced, (e.g., the metal ionic species may access oxidation states of M⁽ⁿ⁺¹⁾, M⁽ⁿ⁺²⁾, etc.)

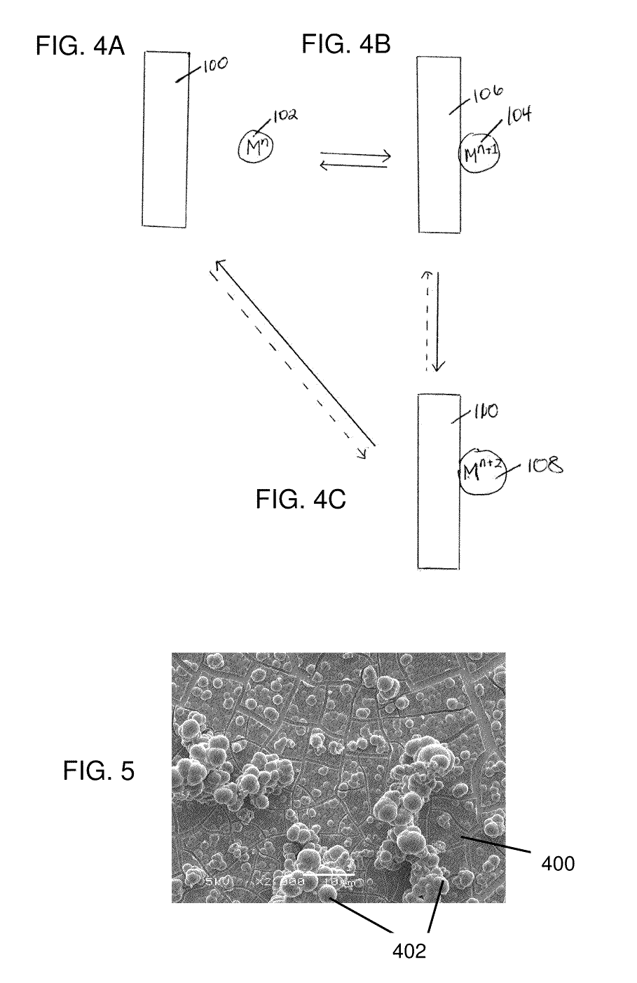

An illustrative example of changes in oxidation state that may occur for a single metal ionic species during a dynamic equilibrium is shown in FIG. 4. FIG. 4A depicts current collector 100 and a single metal ionic species 102 in oxidation state of (n), (e.g., Mⁿ). The metal ionic species 102 may be oxidized to a metal ionic species 104 with an oxidation state of (n+1) (e.g., M⁽ⁿ⁺¹⁾) and associate with current collector 106, as shown in FIG. 4B. At this point, the metal ionic species (e.g., M⁽ⁿ⁺¹⁾) may disassociate from current collector 106 and/or may undergo a further change in oxidation state. In some cases, as shown in FIG. 4C, the metal ionic species may be further oxidized to a single metal ionic species 108 with an oxidation state of (n+2) (e.g. M⁽ⁿ⁺²⁾) and may remain associated with the current collector (or may disassociate from the current collector). At this point, metal ionic species 108 (e.g., M⁽ⁿ⁺²⁾) may accept electrons (e.g., from water or another reaction component) and may be reduced to form metal ionic species with a reduced oxidation state of (n) or (n+1) (e.g., M⁽ⁿ⁺¹⁾, 106 or Mⁿ, 102). In other cases, the metal ionic species 106 (e.g., M⁽ⁿ⁺¹⁾) may be reduced and reform metal ionic species in oxidation state (n) (e.g., Mⁿ, 102). The metal ionic species in oxidation state (n) may remain associated with the current collector or may disassociate from the current collector (e.g., dissociate into solution).

Those of ordinary skill in the art will be able to use suitable screening tests to determine whether a metal ionic species and/or anionic species are in dynamic equilibrium and/or whether an electrode is regenerative. For example, in some cases, the dynamic equilibrium may be determined using radioisotopes of the metal ionic species and/or anionic species. In such cases, an electrode comprising a current collector and a catalytic material comprising radioisotopes may be prepared. The electrode may be placed in an electrolyte which comprises non-radioactive ionic species. The catalytic material may dissociate from the current collector and therefore, the solution may comprise radioactive isotopes of the anionic species and/or metal ionic species. This may be determined by analyzing an aliquot of the electrolyte for the radioisotopes. Upon application of the voltage to the current collector, in instances where the metal ionic species and anionic species are in dynamic equilibrium, the radioisotopes of the metal ionic species may re-associate with the current collector. Aliquots of the electrolyte may be analyzed to determine the amount of radioisotope present in the electrolyte at various time points after application of the voltage. If the metal ionic species and anionic species are in dynamic equilibrium, the percentage of radioisotopes in solution may decrease with time as the radioisotopes re-associate with the current collector. For a non-limiting working example, see Example 18. This screening technique may be used both to determine how a catalytic material may be functioning, and to select materials which can be used as catalytic materials suitable for the invention.

Further techniques useful for selecting suitable catalytic material follow. Without wishing to be bound by theory, the solubility of a material comprising anionic species and oxidized metal ionic species may influence the association of the metal ionic species and/or anionic species with the current collector. For example, if a material formed by (c) number of anionic species and (b) number of oxidized metal ionic species is substantially insoluble in the solution, the material may be influenced to associate with the current collector. This non-limiting example may be expressed according to Equation 4:

b(M^{(n+x)})+c(A^{-y}) [symbol] {[M]_{b}[A]_{c}}^{(b(n+x)-c(y))}(s) (4)

where M^{(n+x)} is the oxidized metal ionic species, A^{-y} is the anionic species, and {[M]_{b}[A]_{c}}^{(b(n+x)-c(y))} is at least a portion of catalytic material formed, where b and c are the number of metal ionic species and anionic species, respectively. Therefore, the equilibrium may be driven towards the formation of the catalytic material by the presence of an increased amount of anionic species. In some cases, the solution surrounding the current collector may comprise an excess of anionic species, as described herein, to drive the equilibrium towards the formation of the catalytic material associated with the current collector. It should be understood, however, that the catalytic material does not necessarily consist essentially of a material defined by the formula {[M]_{b}[A]_{c}}^{(n+x-y)}, as, in most cases, additional components can be present in the catalytic material (e.g., a second type of anionic species). However, the guidelines described herein (e.g., regarding Kₛₚ) provide information to select complimentary anionic species and metal ionic species that may aid in the formation and/or stabilization of the catalytic material. In some cases, the catalytic material may comprise at least one bond between a metal ionic species and an anionic species (e.g., a bond between a cobalt ion and an anionic species comprising phosphorus).

Selection of metal ionic species and anionic species for use in the invention will now be described in greater detail. It is to be understood that any of a wide variety of such species meeting the criteria described herein can be used and, so long as they to participate in catalytic reactions described herein, they need not necessarily behave, in terms of their oxidation/reduction reactions, cyclical association/disassociation from the current collector etc., in the manner described in the application. But in many cases, metal ionic and anionic species selected as described herein, do behave according to one or more of the oxidations/reduction and solubility theories described herein. In some embodiments, the metal ionic species (Mⁿ) and the anionic species (A^{-y}) may be selected such that they exhibit the following properties. In most cases, the metal ionic species and the anionic species will be soluble in an aqueous solution. In addition, the metal ionic species may be provided in an oxidized form, for example with an oxidation state of (n), where (n) is one, two, three, or greater, i.e., in some cases, the metal ionic species have access to at least one oxidation state greater than (n), for example, (n+1) and/or (n+2).

The solubility product constant, Kₛₚ, as will be known to those of ordinary skill in the art, is a simplified equilibrium constant defined for the equilibria between a composition comprising the species and their respective ions in solution and may be defined according to Equation 6, based on the equilibrium shown in Equation 5.

{M_{y}Aₙ}₍ₛ₎ [symbol] y(M)ⁿ_{(aq)}+n(A)^{-y}_{(aq)} (5)

Kₛₚ=[M]^{y}[A]ⁿ (6)

In Equations 5 and 6, M is the metal ionic species with a charge of (n), A is the anionic species with a charge of (−y). The solid complex M_{y}Aₙ may disassociate into solubilized metal ionic species and anionic species. Equation 6 shows the solubility product constant expression. As will be known to those of ordinary skill in the art, the solubility product constant value may change depending on the temperature of the aqueous solution. Therefore, when choosing metal ionic species and anionic species for the formation of an electrode the solubility product constant should be determined at the temperature at which the electrode is to be formed and/or operated in. In addition, the solubility of a solid complex may change depending on the pH. This effect should be taken into account when applying the solubility product constant to the selection of a metal ionic species and an anionic species.

In many cases, the metal ionic species and anionic species are selected together, for example, such that a composition comprising the metal ionic species with an to oxidation state of (n) and the anionic species is soluble in an aqueous solution, the composition having a solubility product constant which is greater than the solubility product constant of a composition comprising the metal ionic species with an oxidation state of (n+x) and the anionic species. That is, the composition comprising the metal ionic species with an oxidation state of (n) and the anionic species may have a Kₛₚ value substantially greater than the Kₛₚ for the composition comprising the metal ionic species with an oxidation state of (n+x) and the anionic species. For example, the metal ionic species and anionic species may be selected such that the Kₛₚ value of composition comprising the anionic species and the metal ionic species with an oxidation state of (n) (e.g., Mⁿ) is greater than the Kₛₚ value of the composition comprising the anionic species and the metal ionic species with an oxidation state of (n+x) (e.g., M^{(n+x)}) by a factor of at least about 10, at least about 10², at least about 10³, at least about 10⁴, at least about 10⁵, at least about 10⁶, at least about 10⁸, at least about 10¹⁰, at least about 10¹⁵, at least about 10²⁰, at least about 10³⁰, at least about 10⁴⁰, at least about 10⁵⁰, and the like. Where these Kₛₚ values are realized, a catalytic material may be more likely to serve as an electrode or current collector-associated material.

In some instances, a catalytic material, such as a composition comprising a metal ionic species with an oxidation state of (n+x) and an anionic species may have a Kₛₚ between about 10⁻³ and about 10⁻⁵⁰. In some cases, the solubility constant of this composition may be between about 10⁻⁴ and about 10⁻⁵⁰, between about 10⁻⁵ and about 10⁻⁴⁰, between about 10⁻⁶ and about 10⁻³⁰, between about 10⁻³ and about 10⁻³⁰, between about 10⁻³ and about 10⁻²⁰, and the like. In some cases, the solubility constant may be less than about 10⁻³, less than about 10⁴, less than about 10⁻⁶, less than about 10⁻⁸, less than about 10⁻¹⁰, less than about 10⁻¹⁵, less than about 10⁻²⁰, less than about 10⁻²⁵, less than about 10⁻³⁰, less than about 10⁻⁴⁰, less than about 10⁻⁵⁰, and the like. In some cases, the composition comprising metal ionic species with an oxidation state of (n) and the anionic species may have a solubility product constant greater than about 10⁻³, greater than about 10⁻⁴, greater than about 10⁻⁵, greater than about 10⁻⁶, greater than about 10⁻⁸, greater than about 10⁻¹², greater than about 10⁻¹⁵, greater than about 10⁻¹⁸, greater than about 10⁻²⁰, and the like. In a particular embodiment, the composition comprising metal ionic species and the anionic species may be selected such that the composition comprising the metal ionic species with an oxidation state of (n) and the anionic species have a Kₛₚ value between about 10⁻³ and about 10⁻¹⁰ and the composition comprising the to metal ionic species with an oxidation state of (n+x) and the anionic species have a Kₛₚ value less than about 10⁻¹⁰. Non-limiting examples of metal ionic species and anionic species that can be soluble in an aqueous solution and have a Kₛₚ value in a suitable range includes Co(II)/HPO₄⁻², Co(II)/H₂BO₃⁻, Co(II)/HAsO₄⁻², Fe(II)/CO₃⁻², Mn(II)/CO₃⁻², and Ni(II)/H₂BO₃⁻. In some cases, these combinations may additionally comprise at least a second type of anionic species, for example, oxide and/or hydroxide ions. The composition that forms on the current collector may comprise the metal ionic species and anionic species selected, as well as additional components (e.g., oxygen, water, hydroxide, counter cations, counter anions, etc.).

As noted, an electrode can be formed by deposition of a catalytic material from solution. Whether the electrode has been properly formed, with proper association of the catalytic material with the current collector, may be important to monitor, both for selecting proper metal ionic species and/or anionic species and, of course, determining whether an appropriate electrode has been formed. The electrode may be determined to have been formed using various procedures. In some instances, the formation of a catalytic material on the current collector may be observed. The formation of the material may be observed by a human eye, or with use of magnifying devices such as a microscope or via other instrumentation. In one case, application of a voltage to the electrode, in conjunction with an appropriate counter electrode and other components (e.g., circuitry, power source, electrolyte) may be carried out to determine whether the system produces oxygen gas at the electrode when the electrode is exposed to water. In some cases, the minimum voltage applied to the electrode which causes oxygen gas to form at the electrode may be different than the voltage required to form gas from the current collector alone. In some cases, the minimum voltage required for the electrode will be less than the voltage required for the current collector alone (i.e., the overpotential will be less for the electrode that includes both the current collector and catalytic material, than for the current collector alone).

The catalytic material (and/or the electrode comprising the catalytic material) may also be characterized in terms of performance. One way of doing this, among many, is to compare the current density of the electrode versus the current collector alone. Typical current collectors are described more fully below and can include indium tin oxide (ITO), and the like. The current collector may be able to function, itself, as a catalytic electrode in water electrolysis, and may have been used in the past to do so. So, to the current density during catalytic water electrolysis (where the electrode catalytically produces oxygen gas from water), using the current collector, as compared to essentially identical conditions (with the same counter electrode, same electrolyte, same external circuit, same water source, etc.), using the electrode including both current collector and catalytic material, can be compared. In most cases, the current density of the electrode will be greater than the current density of the current collector alone, where each is tested independently under essentially identical conditions. For example, the current density of the electrode may exceed the current density of the current collector by a factor of at least about 10, about 100, about 1000, about 10⁴, about 10⁵, about 10⁶, about 10⁸, about 10¹⁰, and the like. In a particular case, the difference in the current density is at least about 10⁵. In some embodiments, the current density of the electrode may exceed the current density of the current collector by a factor between about 10⁴ and about 10¹⁰, between about 10⁵ and about 10⁹, or between about 10⁴ and about 10⁸. The current density may either be the geometric current density or the total current density, as described herein.

This characteristic, namely, significantly increased catalytic activity of the electrode (comprising a current collector and catalytic material associated with the current collector) as compared to the current collector alone, may be used to monitor formation of a catalytic electrode. That is, the formation of the catalytic material on the current collector may also be observed by monitoring the current density over a period of time. The current density, in most cases, will increase during application of a voltage to the current collector. In some instances, the current density may reach a plateau after a period of time (e.g., about 2 hours, about 4 hours, about 6 hours, about 8 hours, about 10 hours, about 12 hours, about 24 hours, and the like).

Metal ionic species useful as one portion of a catalytic material of the invention may be any metal ion selected according to the guidelines described herein. In most embodiments, the metal ionic species have access to oxidation states of at least (n) and (n+x). In some cases, the metal ionic species have access to oxidation states of (n), (n+1) and (n+2). (n) may be any whole number, and includes, but is not limited to, 0, 1, 2, 3, 4, 5, 6, 7, 8, and the like. In some cases, (n) is not be zero. In particular embodiments, (n) is 1, 2, 3 or 4. (x) may be any whole number and includes, but is not limited to 0, 1, 2, 3, 4, and the like. In particular embodiments, (x) is 1, 2, or 3. Non-limiting examples of metal ionic species include Sc, Ti, V, Cr, Mn, Fe, Co, Ni, Cu, Y, Zr, Nb, Mo, Tc, Rh, Ru, Ag, Cd, Pt, Pd, Ir, Hf, Ta, W, Re, Os, Hg, and the like. In some cases, the metal ionic species may be a lanthanide or actinide (e.g., Ce, Pr, Nd, Sm, Eu, Gd, Tb, Dy, Ho, Er, Tm, Yb, Lu, Th, Pa, U, etc.). In a particular embodiment, the metal ionic species comprises cobalt ions, which may be provided as a catalytic material in the form of Co(II), Co(III) or the like. In some embodiments, the metal ionic species is not Mn. The metal ionic species may be provided (e.g., to the solution) as a metal compound, wherein the metal compound comprises metal ionic species and counter anions. For example, the metal compound may be an oxide, a nitrate, a hydroxide, a carbonate, a phosphite, a phosphate, a sulphite, a sulphate, a triflate, and the like.

An anionic species selected for use as a catalytic material of the invention may be any anionic species that is able to interact with the metal ionic species as described herein and to meet threshold catalytic requirements as described. In some cases, the anionic compound may be able to accept and/or donate hydrogen ions, for example, H₂PO₄⁻ or HPO₄⁻². Non-limiting examples of anionic species include forms of phosphate (H₃PO₄ or HPO₄⁻², H₂PO₄⁻² or PO₄ ⁻³), forms of sulphate (H₂SO₄ or HSO₄⁻, SO₄⁻²), forms of carbonate (H₂CO₃ or HCO₃⁻, CO₃⁻²), forms of arsenate (H₃AsO₄ or HAsO₄⁻², H₂AsO₄⁻² or AsO₄⁻³), forms of phosphite (H₃PO₃ or HPO₃⁻², H₂PO₃⁻² or PO₃⁻³), forms of sulphite (H₂SO₃ or HSO₃⁻, SO₃⁻²), forms of silicate, forms of borate (e.g., H₃BO₃, H₂BO₃⁻, HBO₃⁻², etc.), forms of nitrates, forms of nitrites, and the like.

In some cases, the anionic species may be a form of phosphonate. A phosphonate is a compound comprising the structure PO(OR¹)(OR²)(R³) wherein R¹, R², and R³ can be the same or different and are H, an alkyl, an alkenyl, an alkynyl, a heteroalkyl, a heteroalkenyl, a heteroalkynyl, an aryl, or a heteroaryl, all optionally substituted, or are optionally absent (e.g., such that the compound is an anion, dianion, etc.). In a particular embodiment, R¹, R², and R³ can be the same or different and are H, alkyl, or aryl, all optionally substituted. A non-limiting example of a phosphonate is a form of PO(OH)₂R¹ (e.g., PO₂(OH)(R¹)⁻, PO₃(R¹)⁻²), wherein R¹ is as defined above (e.g., alkyl such as methyl, ethyl, propyl, etc.; aryl such as phenol, etc.). In a particular embodiment, the phosphonate may be a form of methyl phosphonate (PO(OH)₂Me), or phenyl phosphonate (PO(OH)₂Ph). Other non-limiting examples of phosphorus-containing anionic species include forms of phosphinites (e.g., P(OR¹)R²R³) and phosphonites (e.g., P(OR¹)(OR²)R³) wherein R¹, R², and R³ are as described above. In other cases, the anionic species may comprise one any form of the following compounds: R¹SO₂(OR²)), SO(OR¹)(OR²), CO(OR¹)(OR²), PO(OR¹)(OR²), AsO(OR¹)(OR²)(R³), wherein R¹, R², and R³ are as described above. With respect to the anionic species discussed above, those of ordinary skill in the art will be able to determine appropriate substituents for the anionic species. The substituents may be chosen to tune the properties of the catalytic material and reactions associated with the catalytic material. For example, the substituent may be selected to alter the solubility constant of a composition comprising the anionic species and the metal ionic species.

In some embodiments, the anionic species may be good proton-accepting species. As used herein, a “good proton-accepting species” is a species which acts as a good base at a specified pH level. For example, a species may be a good proton-accepting species at a first pH and a poor proton-accepting species at a second pH. Those of ordinary skill in the art can identify a good base in this context. In some cases, a good base may be a compound in which the pKₐ of the conjugate acid is greater than the pKₐ of the proton donor in solution. As a specific example, SO₄⁻² may be a good proton-accepting species at about pH 2.0 and a poor proton-accepting species at about pH 7.0. A species may act as a good base around the pKₐ value of the conjugate acid. For example, the conjugate acid of HPO₄⁻² is H₂PO₄⁻, which has a pKₐ value of about 7.2. Therefore, HPO₄⁻² may act as a good base around pH 7.2. In some cases, a species may act as a good base in solutions with a pH level at least about 4 pH units, about 3 pH units, about 2 pH units, or about 1 pH unit, above and/or below the pKₐ value of the conjugate acid. Those of ordinary skill in the art will be able to determine at which pH levels an anionic species is a good proton-accepting species.

The anionic species may be provided as an anionic compound comprising the anionic species and a counter cation. The counter cation may be any cationic species, for example, a metal ion (e.g., K⁺, Na⁺, Li⁺, Mg⁺², Ca⁺², Sr⁺²), NR₄⁺ (e.g., NH₄⁺), H⁺, and the like. In a specific embodiment, the anionic compound employed may be K₂HPO₄.

The catalytic material may comprise the metal ionic species and anionic species in a variety of ratios (amounts relative to each other). In some cases, the catalytic material comprises the metal ionic species and the anionic species in a ratio of less than about 20:1, less than about 15:1, less than about 10:1, less than about 7:1, less than about 6:1, less than about 5:1, less than about 4:1, less than about 3:1, less than about 2:1, greater than about 1:1, greater than about 1:2, greater than about 1:3, greater than about 1:4, greater than about 1:5, greater than about 1:10, and the like. In some cases, the catalytic material may comprise additional components, such as counter cations and/or counter anions from the metallic compound and/or anionic compound provided to the solution. For example, in some instances, the catalytic material may comprise the metal ionic species, the anionic species, and a counter cation and/or anion in a ratio of about 2:1:1, about 3:1:1, about 3:2:1, about 2:2:1, about 2:1:2, about 1:1:1, and the like. The ratio of the species in the catalytic material will depend on the species selected. In some instances, a counter cation may be present in a very small amount and serve as a dopant to, for example, to improve the conductivity or other properties of the material. In these instances, the ratio may be about X:1:0.1, about X:1:0.005, about X:1:0.001, about X:1:0.0005, etc., where X is 1, 1.5, 2, 2.5, 3, and the like. In some instances, the catalytic material may additionally comprise at least one of water, oxygen gas, hydrogen gas, oxygen ions (e.g., O⁻²), peroxide, hydrogen ion (e.g., H⁺), and/or the like.

In some embodiments, a catalytic material of the invention may comprise more than one type of metal ionic species and/or anionic species (e.g., at least about 2 types, at least about 3 types, at least about 4 types, at least about 5 types, or more, of metal ionic species and/or anionic species). For example, more than one type of metal ionic species and/or anionic species may be provided to the solution in which the current collector is immersed. In such instances, the catalytic material may comprise more than one type of metal ionic species and/or anionic species. Without wishing to be bound by theory, the presence of more than one type of metal ionic species and/or anionic species may allow for the properties of the electrode to be tuned, such that the performance of the electrode may be altered by using combinations of species in different ratios. In a particular embodiment, a first type of metal ionic species (e.g., Co(II)) and second type of metal ionic species (e.g., Ni(II)) may be provided in the solution in which the current collector is immersed, such that the catalytic material comprises the first type of metal ionic species and the second type of metal ionic species (e.g., Co(II) and Ni(II)). Where a first and second type of metal ionic species are used together, each can be selected from among metal ionic species described as suitable for use herein.

Where both first type and a second type of metal ionic and/or anionic species are used, both the first and second species need not both be catalytically active, or if both are catalytically active they need not be active to the same level or degree. The ratio of the first type of metal ionic and/or anionic species to the second type of metal ionic and/or anionic species may be varied and may be about 1:1, about 1:2, about 1:3, about 1:4, to about 1:5, about 1:6, about 1:7, about 1:8, about 1:9, about 1:10, about 1:20, or greater. In some instances, the second type of species may be present in a very small amount and serve as a dopant to, for example, to improve the conductivity or other properties of the material. In these instances, the ratio of the first type of species to the second type of metal ionic species may be about 1:0.1, about 1:0.005, about 1:0.001, about 1:0.0005, etc. In some embodiments, a catalytic material comprising more than one metal ionic species and/or anionic species may be formed by first forming a catalytic material comprising a first type of metal ionic species and a first type of anionic species, followed by exposing the electrode comprising the catalytic material to a solution comprising a second type of metal ionic species and/or second type of anionic species and applying a voltage to the electrode. This may cause the second type of metal ionic species and/or second type of anionic species to be comprised in the catalytic material. In other embodiments, the catalytic material may be formed by exposing a current collector to a solution comprising the components (e.g., first and second type of metal ionic species, and anionic species) and applying a voltage to the current collector, thereby forming a catalytic material comprising the components.

In some cases, a first type of anionic species and a second type of anionic species (e.g., a form of borate and a form of phosphate) may be provided to the solution and/or otherwise used in combination in a catalytic material of the invention. Where both first and second catalytically active anionic species are used, they can be selected from among anionic species described as suitable for use herein.

In some cases, the catalytic material may comprise a metal ionic species, a first type of anionic species, and a second type of anionic species. In some instances, the first type of anionic species is hydroxide and/or oxide ions, and the second type of anionic species is not hydroxide and/or oxide ions. Therefore, at least the first type of anionic species or the second type of anionic species is not hydroxide or oxide ions. It should be understood, however, that when at least one type of anionic species is an oxide or hydroxide, the species might not be provided to the solution but instead, may be present in the water or solution the species is provided in and/or may be formed during a reaction (e.g., between the first type of anionic species and the metal ionic species).

In some embodiments, the catalytic metal ionic species/anionic species do not consist essentially of metal ionic species/O⁻² and/or metal ionic species/OH⁻. A material “consists essentially of” a species if it is made of that species and no other species that significantly alters the characteristics of the material, for purposes of the invention, as compared to the original species in pure form. Accordingly, where a catalytic material does not consist essentially of metal ionic species/O⁻² and/or metal ionic species/OH⁻, the catalytic material has characteristics significantly different than a pure metal ionic species/O⁻² and/or metal ionic species/OH⁻, or a mixture. In some cases, a composition that does not consist essentially of metal ionic species/O⁻² and/or metal ionic species/OH⁻ comprises less than about 90%, less than about 80%, less than about 70%, less than about 60%, less than about 50%, less than about 40%, less than about 30%, less than about 20%, less than about 10%, less than about 5%, less than about 1%, and the like, weight percent of O⁻² and/or OH⁻ ions/molecules. In some instances, the composition that does not consist essentially of metal ionic species/O⁻² and/or metal ionic species/OH⁻ comprises between about 1% and about 99%, between about 1% and about 90%, between about 1% and about 80%, between about 1% and about 70%, between about 1% and about 60%, between about 1% and about 50%, between about 1% and about 25%, etc., weight percent O⁻² and/or OH⁻ ions/molecules. The weight percent of O⁻² and/or OH⁻ ions/molecules may be determined using methods known to those of ordinary skill in the art. For example, the weight percent may be determined by determining the approximate structure of the material comprise in the composition. The weight percentage of the O⁻² and/or OH⁻ ions/molecules may be determined by dividing the weight of O⁻² and/or OH⁻ ions/molecules over the total weight of the composition multiplied by 100%. As another example, in some cases, the weight percentage may be approximately determined based upon the ratio of metal ionic species to anionic species in a composition and knowledge regarding the general coordination chemistry of the metal ionic species.

In a specific embodiment, the composition (e.g., catalytic material) associated with the current collector may comprise cobalt ions and anionic species comprising phosphorus (e.g., HPO₄⁻²). In some cases, the composition may additionally comprise cationic species (e.g., K⁺). In some cases, the current collector the composition is associated with does not consist essentially of platinum. An anionic species comprising phosphorus may be any molecule that comprises phosphorus and is associated with a negative charge. The ratio of cobalt ions/anionic species comprising phosphorus/cationic species may be about 2:1:1, about 3:1:1, about 4:1:1, about 2:2:1, about 2:1:2, about 2:3:1, about 2:1:3, and the like. Non-limiting examples of anionic species comprising phosphorus include H₃PO₄, H₂PO₄⁻, HPO₄⁻², PO₄⁻³, H₃PO₃, H₂PO₃⁻, HPO₃⁻², PO₃⁻³, R¹PO(OH)₂, R¹PO₂(OH)⁻, R¹PO₃⁻², or the like, wherein R¹ is H, an alkyl, an alkenyl, an alkynyl, a heteroalkyl, a heteroalkenyl, a heteroalkynyl, an aryl, or a heteroaryl, all optionally substituted.

In some embodiments, a catalytic material of the invention, especially when associated with the current collector, may be substantially non-crystalline. Without wishing to be bound by theory, a substantially non-crystalline material may aid in the transport of protons and/or electrons, which may improve the function of the electrode in certain electrochemical devices. For example, improved transport of protons (e.g., increase proton flux) during electrolysis may improve the overall efficacy of an electrolytic device comprising an electrode as described herein. An electrode comprising a substantially non-crystalline catalytic material may allow for a conductivity of protons of at least about 10⁻¹ S cm⁻¹, at least about 20⁻¹ S cm⁻¹, at least about 30⁻¹ S cm⁻¹, at least about 40⁻¹ S cm⁻¹, at least about 50⁻¹ S cm⁻¹, at least about 60⁻¹ S cm⁻¹, at least about 80⁻¹ S cm⁻¹, at least about 100⁻¹ S cm⁻¹, and the like. In other embodiments, the catalytic material may be amorphous, substantially crystalline, or crystalline. Where substantially non-crystalline material is used, this would be readily understood by those of ordinary skill in the art and easily determined using various spectroscopic techniques.

The above and other characteristics of the metal ionic species and anionic species may serve as selective screening tests for identification of particular metal ionic and anionic species useful for particular applications. Those of ordinary skill in the art can, through simple bench-top testing, reference to scientific literature, simple diffractive instrumentation, simple electrochemical testing, and the like, select metal ionic species and anionic species based upon the present disclosure, without undue experimentation.

The catalytic material may be porous, substantially porous, non-porous, and/or substantially non-porous. The pores may comprise a range of sizes and/or be substantially uniform in size. In some cases, the pores may or might not be visible using imaging techniques (e.g., scanning electron microscope). The pores may be open and/or closed pores. In some cases, the pores may provide pathways between the bulk electrolyte surface and the surface of the current collector.

In some instances, the catalytic material may be hydrated. That is, the catalytic material may comprise water and/or other liquid and/or gas components. Upon removal of the current collector comprising the catalytic material from solution, the catalytic material may be dehydrated (e.g., the water and/or other liquid and/or gas components may be removed from the catalytic material). In some cases, the catalytic material may be dehydrated by removing the material from solution and leaving the material to sit under ambient conditions (e.g., room temperature, air, etc.) for at least about 1 hour, at least about 2 hours, at least about 4 hours, at least about 8 hours, at least about 12 hours, at least about 24 hours, at least about 2 days, at least about 1 week, or more. In some cases, the catalytic material may be dehydrated under non-ambient conditions. For example, the catalytic material be dehydrated at elevated temperature and/or under vacuum. In some instances, the catalytic material may change composition and/or morphology upon dehydration. For example, in instances where the catalytic material forms a film, the film may comprise cracks upon dehydration.

Without wishing to be bound by theory, in some cases, the catalytic material may reach a maximum performance (e.g., rate of O₂ production, overpotential at a specific current density, Faradaic efficiency, etc.) based upon the thickness of the catalytic material. Where a porous current collector is used, the thickness of the deposited catalytic material and the pore size of current collector may advantageously be selected in combination so that pores are not substantially filled with the catalytic material. For example, the surface of the pores may comprise a layer of the catalytic material that is thinner than the average radius of the pores, thereby allowing for sufficient porosity to remain, even after catalytic material is deposited, so that the high surface area provided by the porous current collector is substantially maintained. In some cases, the average thickness of the catalytic material may be less than about 90%, less than about 80%, less than about 70%, less than about 60%, less than about 50%, less than about 40%, less than about 30%, less than about 20%, less than about 10%, or less, the average radius of the pores of the current collector. In some cases, the average thickness of the catalytic material may be between about 40% and about 60%, between about 30% and about 70%, between about 20% and about 80%, etc., the average radius of the pores of the current collector. In other embodiments, the performance of the catalytic material might not reach a maximum performance based upon the thickness of the catalytic material. In some cases, the performance (e.g., overpotential at a certain current density may decrease) of the catalytic material may increase with increasing thickness of the catalytic material. Without wishing to be bound by theory, this may indicate greater than just the outside layer of the catalytic material is catalytically active.

The physical structure of the catalytic material may vary. For example, the catalytic material may be a film and/or particles associated with at least a portion of the current collector (e.g., surface and/or pores) that is immersed in the solution. In some embodiments, the catalytic material might not form a film associated with the current collector. Alternatively or in addition, the catalytic material may be deposited on a current collector as patches, islands, or some other pattern (e.g., lines, spots, rectangles), or may take the form of dendrimers, nanospheres, nanorods, or the like. A pattern in some cases can form spontaneously upon deposition of catalytic material onto the current collector and/or can be patterned onto a current collector by a variety of techniques known to those of ordinary skill in the art (lithographically, via microcontact printing, etc.). Further, a current collector may be patterned itself such that certain areas facilitate association of the catalytic material while other areas do not, or do so to a lesser degree, thereby creating a patterned arrangement of catalytic material on the current collector as the electrode is formed. Where a catalytic material is patterned onto an electrode, the pattern might define areas of catalytic material and areas completely free of catalytic material, or areas with a particular amount of catalytic material and other areas with a different amount of catalytic material. The catalytic material may have an appearance of being smooth and/or bumpy. In some cases, the catalytic material may comprise cracks, as can be the case when the material dehydrated.

In some cases, the thickness of catalytic material may be of substantially the same throughout the material. In other cases, the thickness of the catalytic material may vary throughout the material (e.g., a film does not necessarily have uniform thickness). The thickness of the catalytic material may be determined by determining the thickness of the material at a plurality of areas (e.g., at least 2, at least 4, at least 6, at least 10, at least 20, at least 40, at least 50, at least 100, or more areas) and calculating the average thickness. Where thickness of a catalytic material is determined via probing at a plurality of areas, the areas may be selected so as not to specifically represent areas of more or less catalytic material present based upon a pattern. Those of ordinary skill in the art will easily be able to establish a thickness-determining protocol that accounts for any non-uniformity or patterning of catalytic material on the surface. For example, the technique might include a sufficiently large number of area determinations, randomly selected, to provide overall average thickness. The average thickness of the catalytic material may be at least about 10 nm, at least about 100 nm, at least about 300 nm, at to least about 500 nm, at least about 700 nm, at least about 1 um (micrometer), at least about 2 um, at least about 5 um, at least about 1 mm, at least about 1 cm, and the like. In some cases, the average thickness of the catalytic material may be less than about 1 mm, less than about 500 um, less than about 100 um, less than about 10 um, less than about 1 um, less than about 100 nm, less than about 10 nm, less than about 1 nm, less than about 0.1 nm, or the like. In some instances, the average thickness of the catalytic material may be between about 1 mm and about 0.1 nm, between about 500 um and about 1 nm, between about 100 um and about 1 nm, between about 100 um and about 0.1 nm, between about 0.2 um and about 2 um, between about 200 um and about 0.1 um, or the like. In particular embodiments, the catalytic material may have an average thickness of less than about 0.2 um. In another embodiment, the catalytic material may have an average thickness between about 0.2 um and about 2 um. The average thickness of the catalytic material may be varied by altering the amount and length of time a voltage is applied to the current collector, the concentration of the metal ionic species and the anionic species in solution, the surface area of the current collector, the surface area density of the current collector, and the like.

In some cases, the average thickness of the catalytic material may be determined according to the following method. An electrode comprising a current collector and a catalytic material may be removed from solution (e.g., the solution the electrode was formed in and/or the electrolyte). The electrode may be left to dry for about 1 hour, about 2 hours, about 4 hours, about 6 hours, about 8 hours, about 12 hours, about 24 hours, or more. In some cases, the electrode may be dried under ambient conditions (e.g., in air at room temperature). In some embodiments, during drying, the catalytic material may crack. The thickness of the catalytic material may be determined using techniques known to those of ordinary skill in the art (e.g., scanning electron microscope (SEM)) to determine the depth of the cracks (e.g., the thickness of the dehydrated catalytic material).

In other embodiments, the thickness of the catalytic material may be determined without dehydration (e.g., in situ) using techniques known to those of ordinary skill in the art, for example, SEM. In such embodiments, a mark (e.g., scratch, hole) may be made in the catalytic material to expose at least a portion of the underlying substrate (e.g., the current collector). The thickness of the catalytic material may be determined by measuring the depth of the mark.

In some embodiments, a film of the catalytic material may be formed by the coalescing of a plurality of particles formed on the current collector. In some cases, the material may be observed to have the physical appearance of a base layer of material comprising a plurality of groups of protruding particles. For example, as shown in FIG. 5, the base layer 400 comprises numerous regions comprising protruding particles 402. The thickness of the film may be determined by determining the thickness of the base layer (e.g., 400), although it should be understood that the thickness would be substantially greater if measured by determining the thickness of the areas comprising protruding particles (e.g., 402).

Without wishing to be bound by theory, the formation of groups of protruding particles on the surface of the film may aid in increasing the surface area and thus increase the production of oxygen gas. That is, the surface area of the catalytic material comprising a plurality of groups of protruding particles may be substantially greater than the surface area of a catalytic material which does not comprise a plurality of groups of protruding particles.

In some embodiments, the catalytic material may be described as a function of mass of catalytic material per unit area of the current collector. In some cases, the mass of catalytic material per area of the current collector may be about 0.01 mg/cm², about 0.05 mg/cm², about 0.1 mg/cm², about 0.5 mg/cm², about 1.0 mg/cm², about 1.5 mg/cm², about 2.5 mg/cm², about 3.0 mg/cm², about 4.0 mg/cm², about 5.0 mg/cm², or the like. In some cases, the mass of catalytic material per unit area of the current collector may be between about 0.1 mg/cm² and about 5.0 mg/cm², between about 0.5 mg/cm² and about 3.0 mg/cm², between about 1.0 mg/cm² and about 2.0 mg/cm², and the like. Where the amount of catalytic material associated with a current collector is defined or investigated in terms of mass per unit area, and the material is present non-uniformly relative to the current collector surface (whether through patterning or natural variations in amount over the surface), the mass per unit area may be averaged across the entire surface area within which catalytic material is found (e.g., the geometric surface area). In some cases, the mass of the catalytic material per unit area may be a function of the thickness of the catalytic material.

The formation of the catalytic material may proceed until the potential (e.g., voltage) applied to the current collector is turned off, until there is a limiting quantity of materials (e.g., metal ionic species and/or anionic species) and/or the catalytic material to has reached a critical thickness beyond which additional film formation does not occur or is very slow. Voltage may be applied to the current collector for minimums of about 1 minute, about 5 minutes, about 10 minutes, about 20 minutes, about 30 minutes, about 60 minutes, about 2 hours, about 4 hours, about 8 hours, about 12 hours, about 24 hours, and the like. In some cases, a potential may be applied to the current collector between 24 hours and about 30 seconds, between about 12 hours and about 1 minute, between about 8 hours and about 5 minutes, between about 4 hours and about 10 minutes, and the like. The voltages provided herein, in some cases, are supplied with reference to a normal hydrogen electrode (NHE). Those of ordinary skill in the art will be able to determine the corresponding voltages with respect to an alternative reference electrode by knowing the voltage difference between the specified reference electrode and NHE or by referring to an appropriate textbook or reference. The formation of the catalytic material may proceed until about 0.1%, about 1%, about 5%, about 10%, about 20%, about 30%, about 40%, about 50%, about 60%, about 70%, about 80%, about 90%, about 99%, or about 100% of the metal ionic species and/or anionic species initially added to the solution have associated with the current collector to form the catalytic material.

The voltage applied to the current collector may be held steady, may be linearly increased or decreased, and/or may be linearly increased and decreased (e.g., cyclic). In some cases, the voltage applied to the current collector may be substantially similar throughout the application of the voltage. That is, the voltage applied to the current collector might not be varied significantly during the time that the voltage in applied to the current collector. In such instances, the voltage applied to the current collect may be at least about 0.1 V, at least about 0.2 V, at least about 0.4 V, at least about 0.5 V, at least about 0.7 V, at least about 0.8 V, at least about 0.9 V, at least about 1.0 V, at least about 1.2 V, at least about 1.4 V, at least about 1.6 V, at least about 1.8 V, at least about 2.0 V, at least about 3 V, at least about 4 V, at least about 5 V, at least about 10 V, and the like. In some cases, the voltage applied is between about 1.0 V and about 1.5 V, about 1.1 V and about 1.4 V, or is about 1.1 V. In some instances, the voltage applied to the current collector may be a linear range of voltages, and/or cyclic range of voltages. Application of a linear voltage refers to instances where the voltage applied to the electrode (and/or current collector) is swept linearly in time between a first voltage and a second voltage. Application of a cyclic voltage refers to application of linear voltage, followed by a second application of linear voltage wherein the sweep direction has been reversed. For example, application of a cyclic voltage is commonly used in cyclic voltammetry studies. In some cases, the first voltage and the second voltage may differ by about 0.1 V, about 0.2 V, about 0.3 V, about 0.5 V, about 0.8 V, about 1.0 V, about 1.5 V, about 2.0 V, or the like. In some cases, the voltage may be swept between the first voltage and the second voltage at a rate of about 0.1 mV/sec, about 0.2 mV/sec, about 0.3 mV/sec, about 0.4 mV/sec, about 0.5 mV/sec, about 1.0 mV/sec, about 10 mV/sec, about 100 mV/sec, about 1 V/sec, or the like. The potential applied may or might not be such that oxygen gas is being formed during the formation of the electrode. In some cases, the morphology of the catalytic material may differ depending on the potential applied to the current collector during formation of the electrode.

In some embodiments, wherein the catalytic material is a regenerative material, between application of a voltage (e.g., during periods when the electrode is not in use), at least about 1%, at least about 2%, at least about 5%, at least about 10%, at least about 20%, or more, by weight of the catalytic material may dissociate from the current collector over a period of about 10 minutes, about 30 minutes, about 1 hour, about 2 hours, about 6 hours, about 12 hours, about 24 hours, or more. Upon reapplication of the voltage, at least about 50%, at least about 60%, at least about 70%, at least about 80%, at least about 90%, at least about 95%, at least about 99%, or more, by weight of the dissociate material may re-associate with the electrode. In some cases, substantially all of the metal ionic species may re-associate with the electrode and only a portion of the anionic species may re-associate with the electrode (e.g., in instances where the electrolyte comprises anionic species and there may be an exchange of the anionic specie which dissociate and those which re-associate).

In another embodiment, an electrode of system comprising a catalytic material may be prepared as follows. A catalytic material may be associated with a current collector as described above in any manner described herein. For example, at relatively low potentials at which oxygen gas is not evolved, and/or at a higher potentials in potential at which oxygen gas is evolved and a higher rate of deposition of material when on the electrode occurs, and/or at any other rate or under any conditions suitable for production of a catalytic material associated with the current collector. The catalytic material can be removed from the current collector (and, optionally, the process can be cyclically repeated with additional catalytic material associated with the electrode, to removed, etc.) and the catalytic material can be optionally dried, stored, and/or mixed with an additive (e.g., a binder) or the like. The catalytic material may be packaged for distribution and used as a catalytic material. In some cases, the catalytic material can later be applied to a current collector, can simply be added to a solution of water and associated with a different current collector as described above, e.g., in an end-use setting, or used otherwise as would be recognized by those of ordinary skill in the art.

Those of ordinary skill in the art can readily select binders that would be useful for addition to such catalytic material, for example, poly tetrafluoroethylene (Teflon™), Nafion™, or the like. For eventual use in an electrolyzer or other electrolysis system, non-conductive binders may be most suitable. Conductive binders may be used where they are stable to electrolyzer conditions.

In some embodiments, after application of the voltage and formation of an electrode comprising a current collector, metal ionic species, and anionic species, the electrode may be removed from the solution and stored. The electrode may be stored for any period of time or used immediately in one of the applications discussed herein. In some cases, the catalytic material associated with the current collector may dehydrate during storage. The electrode may be stored for at least about 1 day, at least about 2 days, at least about 5 days, at least about 10 days, at least about 1 month, at least about 3 months, at least about 6 months or at least about 1 year, with no more than 10% loss in electrode performance per month of storage, or no more than 5%, or even 2%, loss in performance per month of storage. Electrodes as described herein may be stored under varying conditions. In some instances, the electrode may be stored in ambient conditions and/or under an atmosphere of air. In other instances, the electrode may be stored under vacuum. In yet other instances, the electrode may be stored in solution. In this case, the catalytic material may disassociate from the current collector over a period of time (e.g., 1 day, 1 week, 1 month, and the like) to form metal ionic species and anionic species in solution. Application of a voltage to the current collector, in most cases, may cause the metal ionic species and anionic species to re-associate with the current collector to reform the catalytic material.

In some embodiments, an electrode comprising a current collector and a catalytic material may be used for an extended period of time as compared to the current collector alone, under essentially identical conditions. Without wishing to be bound by theory, the dynamic equilibrium of the catalytic material may cause the electrode to be robust and to provides a self-repair mechanism. In some cases, an electrode may be used to catalytically produce oxygen gas from water for at least about 1 month, at least about 2 months, at least about 3 months, at least about 6 months, at least about 1 year, at least about 18 months, at least about 2 years, at least about 3 years, at least about 5 years, at least about 10 years, or greater, with less than 50%, less than 40%, less than 30%, less than 20%, less than 10%, less than 5%, less than 3%, less than 2%, less than 1%, or less, change in a selected performance measure (e.g., overpotential at a specific current density, rate of production of oxygen, etc.).

In some cases, the catalytic material associated with the current collector after storage may be substantially similar to the catalytic material immediately after formation. In other cases, the catalytic material associated with the current collector after storage may be substantially different than the catalytic material immediately after formation. In some instances, the metal ionic species in the catalytic material may be oxidized as compared to the metal ionic species in solution. For example, the metal ionic species immediately after deposition may have an oxidation state of (n+x), and after storage, at least a portion of the metal ionic species may have an oxidation state of (n). The ratio of metal ionic species to anionic species in the catalytic material after storage may or might not be substantially similar to the ratio present immediately after formation.

The current collector may comprise a single material or may comprise a plurality of materials, provided that at least one of the materials is substantially electrically conductive. In some cases, the current collector may comprise a single material, for example, ITO, platinum, FTO, carbon mesh, or the like. In other cases, the current collector may comprise at least two materials. In some instances, the current collector may comprise a core material and at least one material substantially cover the core material. In other instances, the current collector may comprise two materials, wherein the second material may be associated with a portion of the first material (e.g., may be located between the first material and the catalytic materials). The materials may be substantially non-conductive (e.g., insulating) and/or substantially conductive. As a non-limiting example, the current collector may comprise a substantially non-conductive core material and an outer layer of substantially conductive material (e.g., a core material may comprise vicor glass and the vicor glass may be substantially covered (e.g., coated with a layer) of a substantially conductive material (e.g., ITO, FTO, etc.)). Non-limiting examples of non-conductive core materials include inorganic substrates, (e.g., quartz, glass, etc.) and polymeric substrates (e.g., polyethylene terephthalate, polyethylene naphthalate, polycarbonate, polystyrene, polypropylene, etc.). As another example, the current collector may comprise a substantially conductive core material and a substantially conductive or substantially non-conductive material. In some cases, at least one of the materials is a membrane material, as will be known to those of ordinary skill in the art. For example, a membrane material may allow for the conductivity of protons, in some cases.

Non-limiting examples of substantially conductive materials the current collector may comprise includes indium tin oxide (ITO), fluorine tin oxide (FTO), antimony-doped tin oxide (ATO), aluminum-doped zinc oxide (AZO), glassy carbon, carbon mesh, metals, metal alloys, lithium-containing compounds, metal oxides (e.g., platinum oxide, nickel oxide, zinc oxide, tin oxide, vanadium oxide, zinc-tin oxide, indium oxide, indium-zinc oxide), graphite, zeolites, and the like. Non-limiting examples of suitable metals the current collector may comprise (including metals comprised in metal alloys and metal oxides) include gold, copper, silver, platinum, ruthenium, rhodium, osmium, iridium, nickel, cadmium, tin, lithium, chromium, calcium, titanium, aluminum, cobalt, zinc, vanadium, nickel, palladium, or the like, and combinations thereof (e.g., alloys such as palladium silver).

The current collector may also comprise other metals and/or non-metals known to those of ordinary skill in the art as conductive (e.g., ceramics, conductive polymers). In some cases, the current collector may comprise an inorganic conductive material (e.g., copper iodide, copper sulfide, titanium nitride, etc.), an organic conductive material (e.g., conductive polymer such as polyaniline, polythiophene, polypyrrole, etc.), and laminates and/or combinations thereof. In some cases, the current collector may comprise a semiconductor material.

In some instances, the current collector may comprise nickel (e.g., nickel foam or nickel mesh). Nickel foam and nickel mesh materials will be known to those of ordinary skill in the art and may be purchase from commercial sources. Nickel mesh usually refers to woven nickel fibers. Nickel foam generally refers to a material of non-trivial thickness (e.g., about 2 mm) comprising a plurality of holes and/or pores. In some cases, nickel foam may be an open-cell, metallic structure based on the structure of an open-cell polymer foam, wherein nickel metal is coated onto the polymer foam.

The current collector may be transparent, semi-transparent, semi-opaque, and/or opaque. The current collector may be solid, semi-porous, and/or porous. The current collector may be substantially crystalline or substantially non-crystalline, and/or homogenous or heterogeneous.

In some embodiments, the current collector and/or electrode does not consist essentially of platinum. That is, the current collector and/or the electrode, in this embodiment, has an electrochemical characteristic significantly different from that of pure platinum. This by no means limits the current collector and/or electrode formed from containing some amount of platinum. The current collector and/or electrode (i.e., current collector and catalytic material) can have characteristics that differ as compared to a current collector and/or electrode that consists essentially of platinum. In some embodiments, the current collector and/or electrode comprises less than about 5 weight percent, less than about 10 weight percent, less than about 20 weight percent, less than about 25 weight percent platinum, less than about 50 weight percent, less than about 60 weight percent, less than about 70 weight percent, less than about 75 weight percent, less than about 80 weight percent, less than about 85 weight percent, less than about 90 weight percent, less than about 95 weight percent, less than about 96 weight percent, less than about 97 weight percent, less than about 98 weight percent, less than about 99 weight percent, less than about 99.5 weight percent, or less than about 99.9 weight percent platinum. In some cases, the current collector and/or electrode does not consist of platinum, another precious metal (e.g., rhodium, iridium, ruthenium, etc.), precious metal oxide (e.g., rhodium oxide, iridium oxide, etc.) and/or combination thereof.

In some embodiments, the current collector (prior to addition of any catalytic material) may have a high surface area. In some cases, the surface area of the current collector may be greater than about 0.01 m²/g, greater than about 0.05 m²/g, greater than about 0.1 m²/g, greater than about 0.5 m²/g, greater than about 1 m²/g, greater than about 5 m²/g, greater than about 10 m²/g, greater than about 20 m²/g, greater than about 30 m²/g, greater than about 50 m²/g, greater than about 100 m²/g, greater than about 150 m²/g, greater than about 200 m²/g, greater than about 250 m²/g, greater than about 300 m²/g, or the like. In other cases, the surface area of the current collector may be between about 0.01 m²/g and about 300 m²/g, between about 0.1 m²/g and about 300 m²/g, between about 1 m²/g and about 300 m²/g, between about 10 m²/g and about 300 m²/g between about 0.1 m²/g and about 250 m²/g, between about 50 m²/g and about 250 m²/g, to or the like. In some cases, the surface area of the current collector may be due to the current collector comprising a highly porous material. The surface area of a current collector may be measured using various techniques, for example, optical techniques (e.g., optical profiling, light scattering, etc.), electron beam techniques, mechanical techniques (e.g., atomic force microscopy, surface profiling, etc.), electrochemical techniques (e.g., cyclic voltammetry, etc.), etc., as will be known to those of ordinary skill in the art.

The porosity of a current collector (or other component, for example, an electrode) may be measured as a percentage or fraction of the void spaces in the current collector. The percent porosity of a current collector may be measure using techniques known to those of ordinary skill in the art, for example, using volume/density methods, water saturation methods, water evaporation methods, mercury intrusion porosimetry methods, and nitrogen gas adsorption methods. In some embodiments, the current collector may be at least about 10% porous, at least about 20% porous, at least about 30% porous, at least about 40% porous, at least about 50% porous, at least about 60% porous, or greater. The pores may be open pores (e.g., have at least one part of the pore open to an outer surface of the electrode and/or another pore) and/or closed pores (e.g., the pore does not comprise an opening to an outer surface of the electrode or another pore). In some cases, the pores of a current collector may consist essentially of open pores (e.g., the pores of the current collector are greater than at least 70%, greater than at least 80%, greater than at least 90%, greater than at least 95%, or greater, of the pores are open pores). In some cases, only a portion of the current collector may be substantially porous. For example, in some cases, only a single surface of the current collector may be substantially porous. As another example, in some cases, the outer surface of the current collector may be substantially porous and the inner core of the current collector may be substantially non-porous. In a particular embodiment, the entire current collector is substantially porous.

The current collector may be made highly porous and/or comprise a high surface area using techniques known to those of ordinary skill in the art. For example, an ITO current collector may be made highly porous using etching techniques. As another example, the vicor glass may be made highly porous using etching technique followed by substantially all the surfaces of the vicor glass being substantially coated with a substantially conductive material (e.g., ITO, FTO, etc.). In some cases, the material that substantially coats a non-conductive core may comprise a film or a plurality of particles (e.g., such that they form a layer substantially covering the core material).

In some cases, the current collector may comprise a core material, wherein at least a portion of the core material is associated with at least one different material. The core material may be substantially or partially coated with at least one different material. As a non-limiting example, in some cases, an outer material may substantially cover a core material, and a catalytic material may be associated with the outer material. The outer material may allow for electrons to flow between the core material and the catalytic material, the electrons being used by the catalytic material, for example, for the production of oxygen gas from water. Without wishing to be bound by theory, the outer material may act as a membrane and allow electrons generated at the core material to be transmitted to the catalytic material. The membrane may also function by reducing and/or preventing oxygen gas formed at the catalytic material from being transversed through the material. This arrangement may be advantageous in devices where the separation of oxygen gas and hydrogen gas formed from the oxidation of water is important. In some cases, the membrane may be selected such that the production of oxygen gas in/at the membrane is limited.

In some embodiments, a current collector may comprise at least one material which is classified as a class 0, a class 1, a class 2, or a class 3 electrodes. Class 0 current collectors may comprise inert metals that exchange electrons reversibly with the electrolyte components and are essentially not subject to oxidation (e.g., formation of an oxide) or corrosion themselves. Class 1 current collectors may comprise reversible metal/metal ions, that is, ion exchanging metals bathed in electrolytes containing their own ions such as Ag/Ag+. Class 2 current collectors may comprise a reversible metal/metal ion with a saturated salt of the metal ion and excess anion X⁻, for example Ag/AgX/X⁻. Class 3 current collectors may comprise a reversible metal/metal salt or soluble complex/second metal salt or complex and excess second cation, for example Pb/Pb-oxalate/Ca-oxalate/Ca²⁺ or Hg/Hg-EDTA²⁻/Ca-EDTA²⁻/Ca²⁺.

The current collector may be of any size or shape. Non-limiting examples of shapes include sheets, cubes, cylinders, hollow tubes, spheres, and the like. The current collector may be of any size, provided that at least a portion of the current collector may be immersed in the solution comprising the metal ionic species and the anionic species. The methods described herein are particularly amenable to forming the catalytic material to on any shape and/or size of current collector. In some cases, the maximum dimension of the current collector in one dimension may be at least about 1 mm, at least about 1 cm, at least about 5 cm, at least abut 10 cm, at least about 1 m, at least about 2 m, or greater. In some cases, the minimum dimension of the current collector in one dimension may be less than about 50 cm, less than about 10 cm, less than about 5 cm, less than about 1 cm, less than about 10 mm, less than about 1 mm, less than about 1 um, less than about 100 nm, less than about 10 nm, less than about 1 nm, or less. Additionally, the current collector may comprise a means to connect the current collector to power source and/or other electrical devices. In some cases, the current collector may be at least about 10%, at least about 30%, at least about 50%, at least about 60%, at least about 70%, at least about 80%, at least about 90%, at least about 95%, at least about 100% immersed in the solution.

The current collector may or may not be substantially planar. For example, the current collector may comprise ripples, waves, dendrimers, spheres (e.g., nanospheres), rods (e.g., nanorods), a powder, a precipitate, a plurality of particles, and the like. In some embodiments, the surface of the current collector may be undulating, wherein the distance between the undulations and/or the height of the undulations are on a scale of nanometers, micrometers, millimeters, centimeters, or the like. In some instances, the planarity of the current collector may be determined by determining the roughness of the current collector. As used herein, the term “roughness” refers to a measure of the texture of a surface (e.g., current collector), as will be known to those of ordinary skill in the art. The roughness of the current collector may be quantified, for example, by determining the vertical deviations of the surface of the current collector from planar. Roughness may be measured using contact (e.g., dragging a measurement stylus across the surface such as a profilometers) or non-contact methods (e.g., interferometry, confocal microscopy, electrical capacitance, electron microscopy, etc.). In some cases, the surface roughness, Rₐ, may be determined, wherein Rₐ is the arithmetic average deviations of the surface valleys and peaks, expressed in micrometers. The Rₐ of a non-planar surface may be greater than about 0.1 um, greater than about 1 um, greater than about 5 um, greater than about 10 um, greater than about 50 um, greater than about 100 um, greater than about 500 um, greater than about 1000 um, or the like.

The solution may be formed from any suitable material. In most cases, the solution may be a liquid and may comprise water. In some embodiments the solution consists of or consists essentially of water, i.e. be essentially pure water or an aqueous solution that behaves essentially identically to pure water, in each case, with the minimum electrical conductivity necessary for an electrochemical device to function. In some embodiments, the solution is selected such that the metal ionic species and the anionic species are substantially soluble. In some cases, when the electrode is to be used in a device immediately after formation, the solution may be selected such that it comprises water (or other fuel) to be oxidized by a device and/or method as described herein. For example, in instances where oxygen gas is to be catalytically produced from water, the solution may comprise water (e.g., provided from a water source).

The metal ionic species and the anionic species may be provided to the solution by substantially dissolving compounds comprising the metal ionic species and the anionic species. In some instances, this may comprise substantially dissolving a metal compound comprising the metal ionic species and anionic compound comprising the anionic species. In other instance, a single compound may be dissolved that comprises both the metal ionic species and the anionic species. The metal compound and/or the anionic compound may be of any composition, such as a solid, a liquid, a gas, a gel, a crystalline material, and the like. The dissolution of the metal compound and anionic compound may be facilitated by agitation of the solution (e.g., stirring) and/or heating of the solution. In some cases, the solution may be sonicated. The metal species and/or anionic species may be provided in an amount such that the concentration of the metal ionic species and/or anionic species is at least about 0.1 mM, at least about 0.5 mM, at least about 1 mM, at least about 10 mM, at least about 0.1 M, at least about 0.5 M, at least about 1 M, at least about 2 M, at least about 5M, and the like. In some cases, the concentration of the anionic species may be greater than the concentration of the metal ionic species, so as to facilitate the formation of the catalytic material, as described herein. As non-limiting examples, the concentration of the anionic species may be about 2 times greater, about 5 times greater, about 10 times greater, about 25 times greater, about 50 times greater, about 100 times greater, about 500 times greater, about 1000 times greater, and the like, of the concentration of the metal ionic species. In some instances, the concentration of the metal ionic species is greater than the concentration of the anionic species.

In some cases, the pH of the solution may be about neutral. That is, the pH of the solution may be between about 6.0 and about 8.0, between about 6.5 and about 7.5, and/or the pH is about 7.0. In other cases, the pH of the solution is about neutral or acidic. In these cases, the pH may be between about 0 and about 8, between about 1 and about 8, between about 2 and about 8, between about 3 and about 8, between about 4 and about 8, between about 5 and about 8, between about 0 and about 7.5, between about 1 and about 7.5, between about 2 and about 7.5, between about 3 and about 7.5, between about 4 and about 7.5, or between about 5 and about 7.5. In yet other cases, the pH may be between about 6 and about 10, between about 6 and about 11, between about 7 and about 14, between about 2 and about 12, and the like. In some embodiments, the pH of the solution may be about neutral and/or basic, for example, between about 7 and about 14, between about 8 and about 14, between about 8 and about 13, between about 10 and about 14, greater than 14, or the like. The pH of the solution may be selected such that the anionic species and the metal ionic species are in the desired state. For example, some anionic species may be affected by a change in pH level, for example, phosphate. If the solution is basic (greater than about pH 12), the majority of the phosphate is in the form PO₄⁻³. If the solution is approximately neutral, the phosphate is in approximately equal amounts of the form HPO₄⁻² and the form H₂PO₄⁻¹. If the solution is slightly acidic (less than about pH 6), the phosphate is mostly in the form H₂PO₄⁻. The pH level may also affect the solubility constant for the anionic species and the metal ionic species.

In one embodiment, an electrode as described herein may comprise a current collector and a composition comprising metal ionic species and anionic species in electrical communication with the current collector. The composition, in some cases, may be formed by self-assembly of the metal ionic species and anionic species on the current collector and may be sufficient non-crystalline such that the composition allows for the conduction of protons. In some embodiments, an electrode may allow for a conductivity of protons of at least 10⁻¹ S cm⁻¹, at least about 20⁻¹ S cm⁻¹, at least about 30⁻¹ S cm⁻¹, at least about 40⁻¹ S cm⁻¹, at least about 50⁻¹ S⁻¹ cm⁻¹, at least about 60⁻¹ S cm⁻¹, at least about 80⁻¹ S cm⁻¹, at least about 100⁻¹ S cm⁻¹, and the like.

In some embodiments, an electrode as described herein may be capable of producing oxygen gas from water at a low overpotential. Voltage in addition to a thermodynamically determined reduction or oxidation potential that is required to attain a given catalytic activity is herein referred to as “overpotential,” and may limit the efficiency of the electrolytic device. Overpotential is therefore given its ordinary meaning in the art, that is, it is the potential that must be applied to a system, or a component of a system such as an electrode to bring about an electrochemical reaction (e.g., formation of oxygen gas from water) minus the thermodynamic potential required for the reaction. Those of ordinary skill in the art understand that the total potential that must be applied to a particular system in order to drive a reaction can typically be the total of the potentials that must be applied to the various components of the system. For example, the potential for an entire system can typically be higher than the potential as measured at, e.g., an electrode at which oxygen gas is produced from the electrolysis of water. Those of ordinary skill in the art will recognize that where overpotential for oxygen production from water electrolysis is discussed herein, this applies to the voltage required for the conversion of water to oxygen itself, and does not include voltage drop at the counter electrode.

The thermodynamic potential for the production of oxygen gas from water varies depending on the conditions of the reaction (e.g., pH, temperature, pressure, etc.). Those of ordinary skill in the art will be able to determine the required thermodynamic potential for the production of oxygen gas from water depending on the experimental conditions. For example, the pH dependence of water oxidation may be determined from a simplified form of the Nernst equation to give Equation 7:

E_{pH}=E°−0.059V×(pH) (7)

where E_{pH} is the potential at a given pH, E° is the potential under standard conditions (e.g., 1 atm, about 25° C.) and pH is the pH of the solution. For example, at pH 0, E=1.229 V, at pH 7, E=0.816 V, and at pH 14, E=0.403 V.

The thermodynamic potential for the production of oxygen gas from water at a specific temperature (E_{T}) may be determined using Equation 8:

E_{T}=[1.5184−(1.5421×10⁻³)(T)]+[(9.523×10⁻⁵)(T)(ln(T))]+[(9.84×10⁻⁸)T²] (8)

where T is given in Kelvin. For example, at 25° C., E_{T}=1.229 V, and at 80° C., E_{T}=1.18 V.

The thermodynamic potential for the production of oxygen gas from water at a given pressure (Eₚ) may be determined using Equation 9:

$${E}_{P} = {E}_{T} + ( \frac{RT}{2 F} ) ln \{ [ {( P - {P}_{w} )}^{1.5} ] \div ( \frac{{P}_{w}}{{P}_{wo}} ) \} \qquad ( 9 )$$

where T is in Kelvin, F is Faraday's constant, R is the universal gas constant, P is the operating pressure of the electrolyzer, P_{w} is the partial pressure of water vapor over the chosen electrolyte, and P_{wo} is the partial pressure of water vapor over pure water. By this equation, at a 25° C., the Eₚ increases by 43 mV for a tenfold increase in pressure.

In some instances, an electrode as described herein may be capable of catalytically producing oxygen gas from water (e.g., gaseous and/or liquid water) with an overpotential of less than about 1 volt, less than about 0.75 volts, less than about 0.5 volts, less than about 0.4 volts, less than about 0.35 volts, less than about 0.325 volts, less than about 0.3 volts, less than about 0.25 volts, less than about 0.2 volts, less than about 0.1 volts, or the like. In some embodiments, the overpotential is between about 0.1 volts and about 0.4 volts, between about 0.2 volts and about 0.4 volts, between about 0.25 volts and about 0.4 volts, between about 0.3 volts and about 0.4 volts, between about 0.25 volts and about 0.35 volts, or the like. In another embodiment, the overpotential is about 0.325 volts. In some cases, the overpotential of an electrode is determined under standardized conditions of an electrolyte with a neutral pH (e.g., about pH 7.0), ambient temperature (e.g., about 25° C.), ambient pressure (e.g., about 1 atm), a current collector that is non-porous and planar (e.g., an ITO plate), and at a geometric current density (as described herein) of about 1 mA/cm². It is to be understood that systems of the invention can be used under conditions other than those described immediately above and in fact those of ordinary skill in the art will recognize that a very wide variety of conditions can exist in use of the invention. But the conditions noted above are provided only for the purpose of specifying how features such as overpotential, amount of oxygen and/or hydrogen produced, and other performance characteristics defined herein are measured for purposes of clarity of the present invention. In a specific embodiment, a catalytic material may produce oxygen gas from water at an overpotential of less than 0.4 volt at an electrode current density of at least 1 mA/cm². As described herein, the water which is oxidized may contain at least one impurity (e.g., NaCl), or be provided from an impure water source.

In some embodiments, an electrode may be capable of catalytically producing oxygen gas from water (e.g., gaseous and/or liquid water) with a Faradaic efficiency of about 100%, greater than about 99.8%, greater than about 99.5%, greater than about 99%, greater than about 98%, greater than about 97%, greater than about 96%, greater than about 95%, greater than about 90%, greater than about 85%, greater than about 80%, greater than about 70%, greater than about 60%, greater than about 50%, etc. The term, “Faradaic efficiency,” as used herein, is given its ordinary meaning in the art and to refers to the efficacy with which charge (e.g., electrons) are transferred in a system facilitating an electrochemical reaction. Loss in Faradaic efficiency of a system may be caused, for example, by the misdirection of electrons which may participate in unproductive reactions, product recombination, short circuit the system, and other diversions of electrons and may result in the production of heat and/or chemical byproducts.

Faradaic efficiency may determined, in some cases, through bulk electrolysis where a known quantity of reagent is stoichiometrically converted to product as measured by the current passed and this quantity may be compared to the observed quantity of product measured through another analytical method. For example, a device or electrode may be used to catalytically produce oxygen gas from water. The total amount of oxygen produced may be measured using techniques know to those of ordinary skill in the art (e.g., using an oxygen sensor, a zirconia sensor, electrochemical methods, etc.). The total amount of oxygen that is expected to be produced may be determined using simple calculations. The Faradaic efficiency may be determined by determining the percentage of oxygen gas produced vs. the expected amount of oxygen gas produced. For non-limiting working examples, see Examples 3, 10, and 11. In some cases, the Faradaic efficiency of an electrode changes by less than about 0.1%, less than about 0.2%, less than about 0.3%, less than about 0.4%, less than about 0.5%, less than about 1.0%, less than about 2.0%, less than about 3.0%, less than about 4.0%, less than about 5.0%, etc., over a period of operation of the electrode of about 1 day, about 2 days, about 3 days, about 5 days, about 15 days, about 1 month, about 2 months, about 3 months, about 6 months, about 12 months, about 18 months, about 2 years, etc.

As will be known to those of ordinary skill in the art, an example of a side reaction that may occur during the catalytic formation of oxygen gas from water is the production of hydrogen peroxide. The production of hydrogen peroxide may decrease the Faradaic efficiency of an electrode. In some cases, an electrode, in use, may produce oxygen that is in the form of hydrogen peroxide of less than about 0.01%, less than about 0.05%, less than about 0.1%, less than about 0.2%, less than about 0.3%, less than about 0.4%, less than about 0.5%, less than about 0.6%, less than about 0.7%, less than about 0.8%, less than about 0.9%, less than about 1%, less than about 1.5%, less than about 2%, less than about 3%, less than about 4%, less than about 5%, less than about 10%, to etc. That is, less than this percentage of the molecules of oxygen produced is in the form of hydrogen peroxide. Those of ordinary skill in the art will be aware of methods for determining the production of hydrogen peroxide at an electrode and/or methods to determine the percentage of hydrogen peroxide produced. For example, hydrogen peroxide may be determined using a rotating ring-disc electrode. Any products generated at the disk electrode are swept past the ring electrode. The potential of the ring electrode may be poised to detect hydrogen peroxide that may have been generated at the ring.

In some cases, the performance of an electrode may also be expressed, in some embodiments, as a turnover frequency. The turnover frequency refers to the number of oxygen molecules produced per second per catalytic site. In some cases, a catalytic site may be a metal ionic species (e.g., a cobalt ion). The turnover frequency of an electrode (e.g., comprising a current collector and a catalytic material) may be less than about 0.01, less than about 0.005, less than about 0.001, less than about 0.0007, less than about 0.0005, less than about 0.00001, less than about 0.000005, or less, moles of oxygen gas per second per catalytic site. In some cases, the turnover frequency may be determined under standardized conditions (e.g., ambient temperature and pressure, 1 mA/cm², planar current collector, etc.). Those of ordinary skill in the art will be aware of methods to determine the turnover frequency.

In one set of embodiments, the invention provides a catalytic electrode and/or catalytic system which can facilitate electrolysis (or other electrochemical reactions) wherein a significant portion, or essentially all of electrons provided to or withdrawn from a solution or material undergoing electrolysis are provided through reaction of catalytic material. For example, where essentially all the electrons provided to or withdrawn from a system undergoing electrolysis are involved in a catalytic reaction, essentially each electron added or withdrawn participates in a reaction involving change of a chemical state of at least one element of a catalytic material. In other embodiments, the invention provides a system where at least about 98%, at least about 95%, at least about 90%, at least about 80%, at least about 70%, at least about 60%, at least about 50%, at least about 40%, or at least about 30% of all electrons added to or withdrawn from a system undergoing electrolysis (e.g., water being split) are involved in a catalytic reaction. Where less than essentially all electrons added or withdrawn are involved in a catalytic reaction some electrons can simply be provided to and withdrawn from the electrolysis solution or material (e.g., water) directly to and from a current collector which does participate in a catalytic reaction.

In some embodiments, systems and/or devices may be provided that comprise an electrode described above and/or an electrode prepared using the above described methods. In particular, a device may be an electrochemical device (e.g., an energy conversion device). Non-limiting examples of electrochemical devices includes electrolytic devices, fuel cells, and regenerative fuel cells, as described herein. In some embodiments, the device is an electrolytic device. An electrolytic device may function as an oxygen gas and/or hydrogen gas generator by electrolytically decomposing water (e.g., liquid and/or gaseous water) to produce oxygen and/or hydrogen gases. A fuel cell may function by electrochemically reacting hydrogen gas (or another fuel) with oxygen gas to generate water (or another product) and electricity. In certain arrangements, electrochemical devices may be employed to both convert electricity and water into hydrogen and oxygen gases, and hydrogen and oxygen gases back into electricity and water as needed. Such systems are commonly referred to as regenerative fuel cell systems. The fuel may be provided to a device in a solid, liquid, gel, and/or gaseous state. Electrolytic devices and fuel cells are structurally similar, but are utilized to effect different half-cell reactions. An energy conversion device, in some embodiments, may be used to provide at least a portion of the energy required to operate an automobile, a house, a village, a cooling device (e.g., a refrigerator), etc. In some cases, more than one device may be employed to provide the energy. Other non-limiting examples of device uses include O₂ production (e.g., gaseous oxygen), H₂ production (e.g., gaseous hydrogen), H₂O₂ production, ammonia oxidation, hydrocarbon (e.g., methanol, methane, ethanol, and the like) oxidation, exhaust treatment, etc.

In some embodiments, a device may be used to produce O₂ and/or H₂. The O₂ and/or H₂ may be converted back into electricity and water, for example, using a device such as a fuel cell. In some cases, however, the O₂ and/or H₂ may be used for other purposes. For example, the O₂ and/or H₂ may be burned to provide a source of heat. In some cases, O₂ may be used in combustion processes (e.g., burning of the hydrocarbon fuels such as oil, coal, petrol, natural gas) which may be used to heat homes, power cars, as rocket fuel, etc. In some instances, O₂ may be used in a chemical plant for the production and/or purification of a chemical (e.g., production of ethylene oxide, production of polymers, purification of molten ore). In some cases, the H₂ may be used to power a device (e.g., in a hydrogen fuel cell), wherein the O₂ may be released into the atmosphere and/or used for another purpose. In other cases, H₂ may be used for the production of a chemical or in a chemical plant (e.g., for hydrocracking, hydrodealkylation, hydrodesulfurization, hydrogenation (e.g., of fats, oils, etc.), etc.; for the production of methanol, acids (e.g., hydrochloric acid), ammonia, etc.). H₂ and O₂ may also be used for medical, industrial, and/or other scientific processes (e.g., as medical grade oxygen, combustion with acetylene in an oxy-acetylene torch for welding and cutting metals, etc.). Those of ordinary skill in the art will be aware of uses for O₂ and/or H₂.

In some embodiments, an electrolytic device for electrochemically producing oxygen and hydrogen gas from water and systems and methods associated with the same, may be provided. In one configuration, the device comprises a chamber, a first electrode, a second electrode, wherein the first electrode is biased positively with respect to the second electrode, an electrolyte, wherein each electrode is in fluid contact with the electrolyte, and a power source in electrical communication with the first and the second electrode. In some cases, the electrolyte may comprise anionic species (e.g., as comprised in the catalytic material of an electrode). A first electrode may be considered biased negatively or positively towards a second electrode means that the first voltage potential of the first electrode is negative or positive, respectfully, with respect to the second voltage potential of the second electrode. The second electrode may be biased negatively or positively with respect to the second electrode by less than about less than about 1.23 V (e.g., the minimum defined by the thermodynamics of transforming water into oxygen and hydrogen gas), less than about 1.3 V, less than about 1.4 V, less than about 1.5 V, less than about 1.6 V, less than about 1.7 V, less than about 1.8 V, less than about 2 V, less than about 2.5 V, and the like. In some cases, the bias may be between about 1.5 V and about 2.0 V, between about 1.6 V and about 1.9 V, or is about 1.6 V.

Protons may be provided to the devices described herein using any suitable proton source, as will be known to those of ordinary skill in the art. The proton source may be any molecule or chemical which is capable of supplying a proton, for example, H⁺, H₃O⁺, NH₄⁺, etc. A hydrogen source (e.g., for use as a fuel in a fuel cell) may be any substance, compound, or solution including hydrogen such as, for example, hydrogen gas, a hydrogen rich gas, natural gas, etc. The oxygen gas provided to a device may or may not be substantially pure. For example, in some cases, any substance, compound or solution including oxygen may be provided, such as, an oxygen rich gas, air, etc.

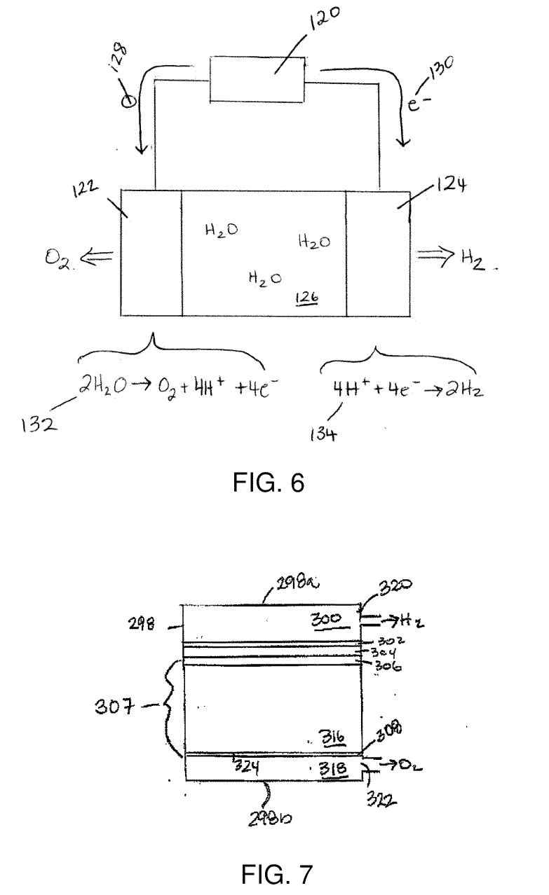

An example of an electrolytic device is depicted in FIG. 6. Power source 120 is electrically connected to first electrode 122 and second electrode 124, wherein the first and/or second electrodes are electrodes as described herein. First electrode 122 and second electrode 124 are in contact with an electrolyte 162. In this example, electrolyte 126 comprises water. However, in some cases, a physical barrier (e.g., porous diaphragm comprised of asbestos, microporous separator of polytetrafluoroethylene (PTFE)), and the like may separate the electrolyte solution in contact with the first electrode from the electrolyte solution in contact with the second electrode, while still allowing ions to flow from one side to another. In other embodiments, the electrolyte might not be a solution and may be a solid polymer that conducts ions. In such cases, water may be provided to the device using any suitable water source.

In this non-limiting embodiment, the electrolytic device may be operated as follows. The power source may be turned on and electron-holes pairs may be generated. Holes 128 are injected into first electrode 122 and electrons 130 are injected into second electrode 124. At the first electrode, water is oxidized to form oxygen gas, four protons, and four electrons, as shown in the half reaction 132. At the second electrode, the electrons are combined with protons (e.g., from a proton source) to produce hydrogen, as shown in the half reaction 134. There is a net flow of electrons from the first electrode to the second electrode. The oxygen and hydrogen gases produced may be stored and/or used in other devices, including fuel cells, or used in commercial or other applications.

In some embodiments, an electrolytic device may comprise a first electrochemical cell in electrical communication with a second electrochemical cell. The first electrochemical cell may comprise an electrode as described herein and may produce oxygen gas from water. The electrons formed at the electrode during the formation of oxygen gas may be transferred (e.g., through circuitry) to the second electrochemical cell. The electrons may be used in the second electrochemical cell in a second reaction (e.g., for the production of hydrogen gas from hydrogen ions). In some embodiments, materials may be provided which allow for the transport of hydrogen ions produced in the first electrochemical cell to the second electrochemical cell. Those of ordinary skill in the art will be aware of configurations and materials suitable for such a device.

In some case, a device may comprise an electrode comprising a catalytic material associated with a current collector comprising a first material and a second material. For example, as shown in FIG. 7, a device may comprise housing 298, first outlet 320 and second outlet 322 for the collection of O₂ and H₂ gases produced during water oxidation, first electrode 302 and second electrode 307 (comprising first material 306, second material 316, and catalytic material 308). In some cases, material 304 may be present between first electrode 302 and second electrode 306 (e.g., a non-doped semiconductor). The device comprises an electrolyte (e.g., 300, 318). Second material 316 may be a porous electrically conductive material (e.g., valve metal, metallic compound) wherein the electrolyte (e.g., 318) fills the pores of the material. Without wishing to be bound by theory, material 316 may act as a membrane and allow for the transmission of electrons generated at first material 306 to outer surface 324 of second material 316. Second material 316 may also be selected such that no oxygen gas is produced in the pores of second material 316, for example, if the overpotential for production of oxygen gas is high. Oxygen gas may form on or near surface 324 of second material 316 (e.g., or via the catalytic material associated with outer surface 324 of second material 316). Non-limiting examples of materials which may be suitable for use as second material 316 includes titanium zirconium, vanadium, hafnium, niobium, tantalum, tungsten, or alloys thereof. In some cases, the material may be a valve metal nitride, carbide, borides, etc., for example, titanium nitride, titanium carbide, or titanium boride. In some cases, the material may be titanium oxide, or doped titanium oxide (e.g., with niobium tantalum, tungsten, fluorine, etc.).

Electrolytic devices may operate at a low overpotential when catalytically forming oxygen gas from water (e.g., gaseous and/or liquid water). In some cases, an electrolytic device may catalytically produce oxygen gas from water at an overpotential as described herein. The overpotential may be determined under standardized conditions (e.g., neutral pH (e.g., about pH 7.0), ambient temperature (e.g., about 25° C.), ambient pressure (e.g., about 1 atm), a current collector that is non-porous and planar (e.g., an ITO plate), and at a geometric current density of about 1 mA/cm²).

In some cases, a fuel cell (or fuel-to-energy conversion device) and systems and methods associated with the same may be provided. A fuel-to-energy conversion device is a device that converts fuel to electrical energy electrochemically. A typical, conventional fuel cell comprises two electrodes, a first electrode and a second electrode, an electrolyte in contact with both the first and the second electrodes, and an electrical circuit connecting the first and the second electrodes from which power created by the device is drawn. In typical operation, fuel (e.g., hydrogen gas, hydrocarbons, ammonia, etc.), is oxidized at the first electrode to produce electrons, which travel through a circuit and reduce an oxidant (e.g., oxygen gas, or oxygen from air) at the second electrode. The catalytic materials and electrodes described herein, in one set of embodiments, can be used to define the second electrode. The electrons may be removed from the first electrode by a device capable of collecting the current, or other component of an electrical circuit. The overall reaction is energetically favorable, i.e., the reaction releases energy in the form of excited electrons and/or heat. Electrons traveling through the electrical circuit connecting the first and the second electrodes provide electrical power, which may be extracted from the device.

The construction and operation of a fuel cell will be known to those of ordinary skill in the art. Non-limiting examples of fuel cell devices which may comprise an electrode and/or catalytic material of the present invention include proton exchange membrane (PEM) fuel cells, phosphoric acid fuel cells, molten carbonate fuel cells, solid oxide fuel cells, alkaline fuel cells, direct methanol fuel cells, zinc air fuel cells, protonic ceramic fuel cells, and microbial fuel cells. In some cases, the fuel cell is a PEM fuel cell and comprises a polymer exchange membrane. As will be known to those of ordinary skill in the art, a polymer exchange membrane conducts hydrogen ions (protons) but not electrons, the membrane does not allow either gas (e.g., hydrogen gas or oxygen gas) to pass to the other side of the cell, and the membrane is usually chemically inert to the reducing environment at the cathode as well as the harsh oxidative environment at the anode.

Those of ordinary skill in the art will be aware of methods to measure and determine the performance of a fuel cell. In some embodiments, the efficiency of a fuel cell is dependent on the amount of power drawn from it. In some cases, the fuel cell efficiency may be defined as a ratio between energy produced and hydrogen consumed. In some cases, a loss in efficiency may be due to a voltage drop in the fuel cell. Another non-limiting example of a measure of the performance of a fuel cell is a graph of the voltage versus current, also referred to a polarization curves. In some cases, a fuel cell may operate at greater than about 30%, 40%, 50%, 60%, 70%, 80%, 90%, or more, efficiency. In some instances, the maximum voltage the fuel call is capable of producing may be determined as a performance characteristic.

In some embodiments, a device may be a regenerative fuel cell, using catalytic materials, electrodes, or devices as described herein. A regenerative fuel cell is a device that comprises a fuel cell and an electrolytic device. The electrolytic device and the fuel cell may be defined primarily by the same components, which are operable either as an electrolytic or fuel cell, or one or both of the electrolytic device and the fuel cell can include components used only for that device but not the other. For example, the regenerative fuel cell may include a first electrode and a second electrode, where both the first and second electrode are used for both the electrolytic device and the fuel cell, depending upon the availability and setting of electrical potential, fuel, etc. As another example, the regenerative fuel cell may include an electrolytic cell defined by its own set of electrodes, electrolyte, compartment(s), and various connections, and a separate fuel cell defined by its own electrodes, etc., different from some or all of the components of the electrolytic cell). As an example of use, if the electrolytic device and the fuel cell are defined primarily by the same components, then when the device is functioning as an electrolytic device, oxygen and hydrogen gases can be catalytically produced from water using a set of at least two electrodes. The oxygen and hydrogen gases may be stored and then used as fuel when the device is functioning as a fuel cell, using those same electrodes, or using a least one of the same electrodes. In this arrangement, the system is substantially contained and may be used repeatedly.

In a particular embodiment, the regenerative fuel cell (e.g., an electrolytic device and a fuel cell) is electrically connected to a power source which provides electrical energy to the electrolytic device that generates fuel, which is in turn stored. In some cases, the power source may be a photovoltaic cell which may provide electrical energy to the electrolytic device during the day. The photovoltaic device may also provide electrical energy to consumer devices in instances when the voltage generated by the photovoltaic cell is greater than that needed to produce a selected amount of fuel. In a regenerative fuel cell system comprising a photovoltaic device, the fuel cell may generate electrical energy during night time from the stored fuel produced by the electrolytic device, and may supply this electrical energy to consumer devices during night time. The regenerative fuel cell may operate for a longer duration in the electrolysis mode than in the fuel cell mode over the predetermined number of cycles. This difference in operating time may be used to produce an excess in fuel. For to example, the regenerative fuel cell may operate during one portion of the electrolysis mode to regenerate sufficient fuel for the entire next fuel cell mode period, and then operate for the remainder of the electrolysis mode period to produce the excess fuel. In some cases, the operation of the regenerative fuel cell may follow a day/night cycle. Such a system often operates with a photovoltaic power supply during the day to power the electrolytic device and/or consumer devices, and at night time discharges the fuel produced by the electrolytic device by operating the fuel cell to power consumer devices.

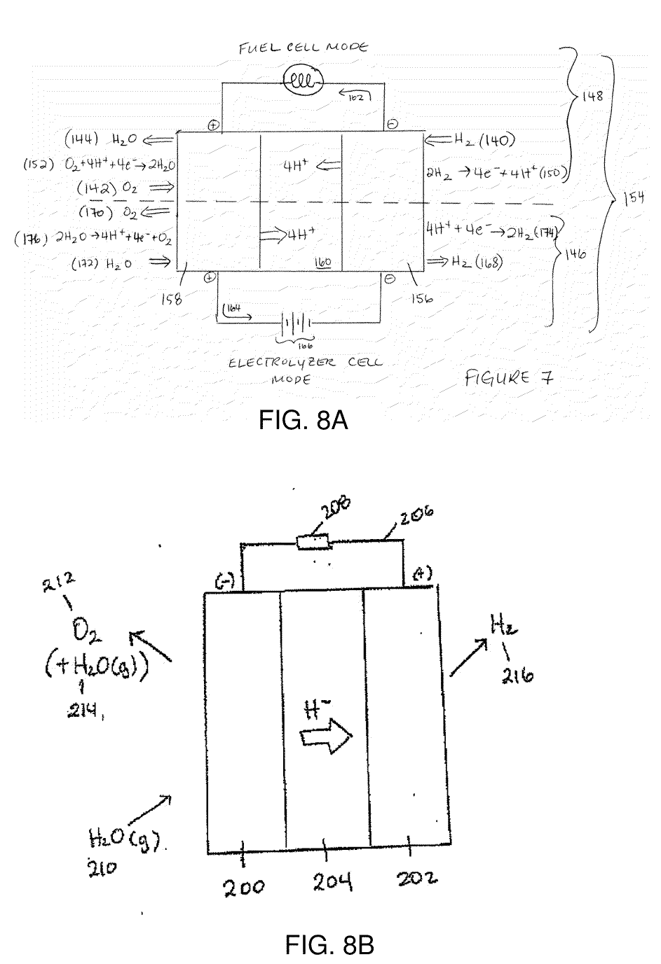

FIG. 8A illustrates a non-limiting example of a regenerative fuel cell combining a fuel cell and an electrolytic device. As shown in the figure, hydrogen gas 140 and oxygen gas 142 are combined to create water 144 and electricity when the device is operated as a fuel cell (148). Also shown in FIG. 8A are the fuel cell half-cell reactions 150 and 152. Hydrogen gas 140 and oxygen gas 142 gases may be introduced in the device 154 to a first electrode 156 and a second electrode 158, respectively. The electrodes, for example, can be an electrode as described herein. In the fuel cell mode of operation, electrical current 162 is produced by the electrochemical half-cell reactions 150 and 152, and can power electrical device 162.

When properly catalyzed, for example, using a catalytic material as described herein, the electrochemical half-cell reactions are reversible, and the device may function in an electrolyzer mode 146. Thus, application of electrical current 164 by power source 166 to electrodes 156 and 158 can reverse the fuel cell reactions. This results in the electrolytic production of hydrogen gas 168 and oxygen gas 170 from supplied water 172, according to the half reactions 174 and 176, respectfully.

In some embodiments, an electrochemical system and/or device as described herein (e.g., for electrolysis of water) may be operated at a voltage where the voltage of the system is primarily maintained at any one of the overpotentials described herein. That is, in such a system, the overpotential may be maintained at a constant level at one of the levels or within one of the ranges described herein, but need not be. The potential of the system can be adjusted during use, linearly, nonlinearly, in a stepwise fashion, or the like. But in some cases, the system is run at an overpotential or within an overpotential range described herein for at least about 25%, at least about 45%, at least about 60%, at least about 80%, at least about 90%, at least about 95%, or at least 98%, of the time the system is operative. In one embodiment, the voltage is held at such overpotential for essentially 100% of the time the system and/or device is operative. This means that the system can be held at the stated overpotential but moved outside of that level or range for periods of time during use but, in accordance with this aspect of the invention, not more than one of the stated time percentages above.

The performance of an electrode of a device may be measured by current density (e.g., geometric and/or total current density), wherein the current density is a measure of the density of flow of a conserved charge. For example, the current density is the electric current per unit area of cross section. In some cases, the current density (e.g., geometric current density and/or total current density, as described herein) of an electrode as described herein is greater than about 0.1 mA/cm², greater than about 1 mA/cm², greater than about 5 mA/cm², greater than about 10 mA/cm², greater than about 20 mA/cm², greater than about 25 mA/cm², greater than about 30 mA/cm², greater than about 50 mA/cm², greater than about 100 mA/cm², greater than about 200 mA/cm², and the like.

In some embodiments, the current density can be described as the geometric current density. The geometric current density, as used herein, is current divided by the geometric surface area of the electrode. The geometric surface area of an electrode will be understood by those of ordinary skill in the art and refers to the surface defining the outer boundaries of the electrode (or current collector), for example, the area that may be measured by a macroscopic measuring tool (e.g., a ruler) and does not include the internal surface area (e.g., area within pores of a porous material such as a foam, or surface area of those fibers of a mesh that are contained within the mesh and do not define the outer boundary, etc.).

In some cases, the current density can be described as the total current density. Total current density, as used herein, is the current density divided by essentially the total surface area (e.g., the total surface area including all pores, fibers, etc.) of the electrode. In some cases, the total current density may be approximately equal to the geometric current density (e.g., in cases where the electrode is not porous and the total surface area is approximately equal to the geometric surface area).

In some embodiments, a device and/or electrode as described herein is capable of producing at least about 1 umol (micromole), at least about 5 umol, at least about 10 umol, at least about 20 umol, at least about 50 umol, at least about 100 umol, at least about 200 umol, at least about 500 umol, at least about 1000 umol oxygen and/or hydrogen, or more, per cm² at the electrode at which oxygen production or hydrogen production occurs, respectively, per hour. The area of the electrode may be the to geometric surface area or the total surface area, as described herein.

In some cases, an electrolytic device may be constructed and arranged to be electrically connectable to and able to be driven by the photovoltaic cell (e.g., the photovoltaic cell may be the power source for the device for the electrolysis of water). Photovoltaic cells comprise a photoactive material which absorbs and converts light to electrical energy. Those of ordinary skill in the art will understand the meaning of a device “constructed and arranged to be electrically connectable to and able to be driven by” a photovoltaic cell. This arrangement involves a photovoltaic cell, and electrolysis device, which are clearly indicated for connection to each other through packaging, written instructions, unique connective features (mechanical and/or electrical), or the like. In this or other embodiments, the two (photovoltaic cell and electrolysis device) can be packaged together as a kit. The electrolytic device may include any of the catalytic materials and/or electrodes or devices as described herein. Photovoltaic cells, and methods and systems providing the same, will be known to those of ordinary skill in the art. In some cases, with use of a catalytic material as described herein, electrolysis of water may proceed at a rate of production of at least about 1 umol (micromole), at least about 5 umol, at least about 10 umol, at least about 20 umol, at least about 50 umol, at least about 100 umol, at least about 200 umol, at least about 500 umol, at least about 1000 umol oxygen per cm² of photovoltaic cell per hour. In a particular embodiment, a device comprising a photovoltaic device and an electrolytic device as described herein may be able to produce at least about 10 umol oxygen per cm² of photovoltaic cell per hour.

The devices and methods as described herein, in some cases, may proceed at about ambient conditions. Ambient conditions define the temperature and pressure relating to the device and/or method. For example, ambient conditions may be defined by a temperature of about 25° C. and a pressure of about 1.0 atmosphere (e.g., 1 atm, 14 psi). In some cases, the conditions may be essentially ambient. Non-limiting examples of essentially ambient temperature ranges include between about 0° C. and about 40° C., between about 5° C. and about 35° C., between about 10° C. and about 30° C., between about 15° C. and about 25° C., at about 20° C., at about 25° C., and the like. Non-limiting examples of essentially ambient pressure ranges include between about 0.5 atm and about 1.5 atm, between about 0.7 atm and about 1.3 atm, between about 0.8 and about 1.2 atm, between about 0.9 atm and about 1.1 atm, and the like. In a particular case, the to pressure may be about 1.0 atm. Ambient or essentially ambient conditions can be used in conjunction with any of the devices, compositions, catalytic materials, and/or methods described herein, in conjunction with any conditions (for example, conditions of pH, etc.).

In some cases, the devices and/or methods as described herein may proceed at temperatures above ambient temperature. For example, a device and/or method may be operated at temperatures greater than about 30° C., greater than about 40° C., greater than about 50° C., greater than about 60° C., greater than about 70° C., greater than about 80° C., greater than about 90° C., greater than about 100° C., greater than about 120° C., greater than about 150° C., greater than about 200° C., or greater. Efficiencies can be increased, in some instances, at temperatures higher than ambient. The temperature of the device may be selected such that the water provided and/or formed is in a gaseous state (e.g., at temperatures greater than about 100° C.). In other cases, the devices and/or methods as described herein may proceed at temperatures below ambient temperature. For example, a device and/or method may be operated at temperatures less than about 20° C., less than about 10° C., less than about 0° C., less than about −10° C., less than about −20° C., less than about −30° C., less than about −40° C., less than about −50° C., less than about −60° C., less than about −70° C., or the like. In some instances, the temperature of the device and/or method may be affected by an external temperature source (e.g., a heating and/or cooling coil, infrared light, refrigeration, etc.). In other instances, however, the temperature of the device and/or method may be affected by internal processes, for example, exothermic and/or endothermic reactions, etc. In some cases, the device and/or method may be operated at approximately the same temperature throughout the use of the device and/or method. In other cases, the temperature may be changed at least once or gradually during the use of the device and/or method. In a particular embodiment, the temperature of the device may be elevated during times when the device is used in conjugation with sunlight or other radiative power sources.

In some embodiments, the water provided and/or formed during use of a method and/or device as described herein may be in a gaseous state. Those of ordinary skill in the art can apply known electrochemical techniques carried out with steam, in some cases, without undue experimentation. As an exemplary embodiment, water may be provided in a gaseous state to an electrolytic device (e.g., high-temperature electrolysis or steam electrolysis) comprising an electrode in some cases. In some cases, the gaseous water to be provided to a device may be produced by a device or system which inherently produces steam (e.g., a nuclear power plant). The electrolytic device, in some cases, may comprise a first and a second porous electrodes (e.g., electrode as described herein, nickel-cermet steam/hydrogen electrode, mixed oxide electrode (e.g., comprising lanthanum, strontium, etc.), cobalt oxygen electrodes, etc.) and an electrolyte. The electrolyte may be non-permeable to selected gases (e.g., oxygen, oxides, molecular gases (e.g., hydrogen, nitrogen, etc.)). Non-limiting examples of electrolytes include yttria-stabilized zirconia, barium-stabilized zirconia, etc. A non-limiting example of one electrolytic device that may use water in a gaseous state is shown in FIG. 8B. An electrolytic device is provided which comprises first electrode 200, second electrode 202, non-permeable electrolyte 204, power source 208, and circuit 206 connecting first electrode and second electrode, wherein second electrode 202 is biased positively with respect to first electrode 200. Gaseous water 210 is provided to first electrode 200. Oxygen gas 212 is produced at the first electrode 200, and may sometimes comprise gaseous water 214. Hydrogen gas 216 is produced at second electrode 202. In some embodiments, steam electrolysis may be conducted at temperatures between about 100° C. and about 1000° C., between about 100° C. and about 500° C., between about 100° C. and about 300° C., between about 100° C. and about 200° C., or the like. Without wishing to be bound by theory, in some cases, providing water in a gaseous state may allow for the electrolysis to proceed more efficiently as compared to a similar device when provided water in a liquid state. This may be due to the higher input energy of the water vapor. In some instances, the gaseous water provided may comprise other gases (e.g., hydrogen gas, nitrogen gas, etc.).

Yet another embodiment for an electrochemical cell for the electrolysis of water, may comprise a container, an aqueous electrolyte in the container, wherein the pH of the electrolyte is neutral or below, a first electrode mounted in the container and in contact with the electrolyte, wherein the first electrode comprises metal ionic species and anionic species, the metal ionic species and the anionic species defining a substantially non-crystalline composition and have an equilibrium constant, Kₛₚ, between about 10⁻³ and 10⁻¹⁰ when the metal ionic species is in an oxidation state of (n) and have a Kₛₚ less than about 10⁻¹⁰ when the metal ionic species is in an oxidation state of (n+x), a second electrode mounted in the container and in contact with the electrolyte, wherein the second electrode is biased negatively with respect to the first electrode, and means for connecting the first electrode and the second electrode. In this embodiment, when a voltage is applied between the first electrode and the second electrode, gaseous hydrogen may be evolved at the second electrode and gaseous oxygen may be produced at the first electrode.

Individual aspects of the overall electrochemistry and/or chemistry involved in electrochemical devices such as those described herein are generally known, and not all will be described in detail herein. It is to be understood that the specific electrochemical devices described herein are exemplary only, and the components, connections, and techniques as described herein can be applied to virtually any suitable electrochemical device including those with a variety of solid, liquid, and/or gaseous fuels, and a variety of electrodes, and electrolytes, which may be liquid or solid under operating conditions (where feasible; generally, for adjacent components one will be solid and one will be liquid if any are liquids). It is also to be understood that the electrochemical device unit arrangements discussed are merely examples of electrochemical devices that can make use of electrodes as recited herein. Many structural arrangements other than those disclosed herein, which make use of and are enabled as described herein, will be apparent to those of ordinary skill in the art.

An electrochemical device accordingly may be combined with additional electrochemical devices to form a larger device or system. In some embodiments, this may take the form of a stack of units or devices (e.g., fuel cell and/or electrolytic device). Where more than one electrochemical device is combined, the devices may all be devices as described herein, or one or more devices as described herein may be combined with other electrochemical devices, such as conventional solid oxide fuel cells. It is to be understood that where this terminology is used, any suitable electrochemical device, which those of ordinary skill in the art would recognize could function in accordance with the systems and techniques of the present invention, can be substituted.

Water may be provided to the systems, devices, electrodes, and/or for the methods described herein using any suitable source. In some cases, the water provided is from a a substantially pure water source (e.g., distilled water, deionized water, chemical grade water, etc.). In some cases, the water may be bottled water. In some cases, the water provided is from a by a natural and/or impure water source (e.g., tap water, lake water, ocean water, rain water, lake water, pond water, sea water, potable to water, brackish water, industrial process water, etc.). In some cases, although it need not be, the water is not purified prior to use (e.g., before being provided to the system/electrode for electrolysis). In some instances, the water may be filtered to remove particulates and/or other impurities prior to use. In some embodiments, the water that is electrolyzed to produce oxygen gas (e.g., using an electrode and/or device as described here) may be substantially pure. The purity of the water may be determined using one or more methods known to those of ordinary skill in the art, for example, resistivity, carbon content (e.g., through use of a total organic carbon analyzer), UV absorbance, oxygen-absorbance test, limulus ameobocyte lysate test, etc. In some embodiments, the at least one impurity may be substantially non-participative in the catalytic reaction. That is, the at least one impurity does not participate in aspects of the catalytic cycle and/or regeneration mechanism.

In some embodiments, the water may contain at least one impurity. The at least one impurity may be solid (e.g., particulate matter), a liquid, and/or a gas. In some cases, the impurity may be solubilized and/or dissolved. For example, an impurity may comprise ionic species. In some cases, an impurity may be an impurity which may generally be present in a water source (e.g., tap water, non-potable water, potable water, sea water, etc.). In a particular embodiment, the water source may be sea water and one of the impurities may be chloride ions, as discussed more herein. In some cases, an impurity may comprise a metal such as a metal element (including heavy metals), a metal ion, a compound comprising at least one metal, an ionic species comprising a metal, etc. For example, an impurity comprising metal may comprise an alkaline earth metal, an alkali metal, a transition metal, or the like. Specific non-limiting examples of metals include lithium, sodium, magnesium, titanium, vanadium, chromium, manganese, iron, cobalt, nickel, copper, zinc, potassium, mercury, lead, barium, etc. In some instances, an impurity comprising a metal may be the same or different than the metal comprised in the metal ionic species of an electrode and/or catalytic material as described herein. In some cases, the impurity may comprise organic materials, for example, small organic molecules (e.g., bisphenol A, trimethylbenzene, dioxane, nitrophenol, etc.), microorganisms (such as bacteria (e.g., e. coli, coliform, etc.), microbes, fungi, algae, etc.), other biological materials, pharmaceutical compounds (e.g., drugs, decomposition products from drugs), herbicides, pyrogens, pesticides, proteins, radioactive compounds, inorganic compounds (e.g., compounds comprising boron, silicon, sulfur, nitrogen, cyanide, phosphorus, arsenic, sodium, etc.; carbon dioxide, silicates (e.g., H₄SiO₄), ferrous and ferric iron compounds, chlorides, aluminum, phosphates, nitrates, etc.), dissolved gases, suspended particles (e.g., colloids), or the like. In some cases, an impurity may be a gas, for example, carbon monoxide, ammonia, carbon dioxide, oxygen gas, and/or hydrogen gas. In some cases, the gas impurity may be dissolved in the water. In some cases, an electrode may be capable of operating at approximately the same, at greater than about 95%, at greater than about 90%, at greater than about 80%, at greater than about 70%, at greater than about 60%, at greater than about 50%, or the like, of the activity level using water containing at least one impurity versus the activity using water that does not substantially contain the impurity under essentially identical conditions. In some cases, an electrode may catalytically produce oxygen from water containing at least one impurity such that less than about 5 mol %, less than about 3 mol %, less than about 2 mol %, less than about 1 mol %, less than about 0.5 mol %, less than about 0.1 mol %, less than about 0.01 mol % of the products produced comprise any portion of the at least one impurity.

In some cases, an impurity may be present in the water in an amount greater than about 1 ppt, greater than about 10 ppt, greater than about 100 ppt, greater than about 1 ppb, greater than about 10 ppb, greater than about 100 ppb, greater than about 1 ppm, greater than about 10 ppm, greater than about 100 ppm, greater than about 1000 ppm, or greater. In other cases, an impurity may be present in the water in an amount less than about 1000 ppm, less than about 100 ppm, less than about 10 ppm, less than about 1 ppm, less than about 100 ppb, less than about 10 ppb, less than about 1 ppb, less than about 100 ppt, less than about 10 ppt, less than about 1 ppt, or the like. In some cases, the water may contain at least one impurity, at least two impurities, at least three impurities, at least five impurities, at least ten impurities, at least fifteen impurities, at least twenty impurities, or greater. In some cases, the amount of impurity may increase or decrease during operation of the electrode and/or device. That is, an impurity may be formed during use of the electrode and/or device. For example, in some cases, the impurity may be a gas (e.g., oxygen gas and/or hydrogen gas) formed during the electrolysis of water. Thus, in some cases, the water may contain less than about 1000 ppm, less than about 100 ppm, less than about 10 ppm, less than about 1 ppm, less than about 100 ppb, less than about 10 ppb, less than about 1 ppb, less than about 100 ppt, less than about 10 ppt, less than about 1 ppt, or the like, prior to operation of the to electrode and/or device.

In some embodiments, the at least one impurity may be an ionic species. In some cases, when the water contains at least one ionic species, the water purity may be determined, at least in part, by measuring the resistivity of the water. The theoretical resistivity of water at 25° C. is about 18.2 MΩ·cm. The resistivity of water that is not substantially pure may be less than about 18 MΩ·cm, less than about 17 MΩ·cm, less than about 16 MΩ·cm, less than about 15 MΩ·cm, less than about 12 MΩ·cm, less than about 10 MΩ·cm, less than about 5 MΩ·cm, less than about 3 MΩ·cm, less than about 2 MΩ·cm, less than about 1 MΩ·cm, less than about 0.5 MΩ·cm, less than about 0.1 MΩ·cm, less than about 0.01 MΩ·cm, less than about 1000 Ω·cm, less than about 500 Ω·cm, less than about 100 Ω·cm, less than about 10 Ω·cm, or less. In some cases, the resistivity of the water may be between about 10 MΩ·cm and about 1 Ω·cm, between about 1 MΩ·cm and about 10 Ω·cm, between about 0.1 MΩ·cm and about 100 Ω·cm, between about 0.01 MΩ·cm and about 1000 Ω·cm, between about 10,000 Ω·cm and about 1,000 Ω·cm, between about 10,000 Ω·cm and about 100 Ω·cm, between about 1,000 and about 1 Ω·cm, between about 1,000 and about 10 Ω·cm, and the like. In some cases, when the water source is tap water, the resistivity of the water may be between about 10,000 Ω·cm and about 1,000 Ω·cm. In some cases, when the water source is sea water, the resistivity of the water may be between about 1,000 Ω·cm and about 10 Ω·cm. In some instances, where the water may be taken from an impure source and purified prior to use, the water may be purified in a manner which does not resistivity of the water by a factor of more than about 5%, about 10%, about 20%, about 25%, about 30%, about 50%, or the like. Those of ordinary skill in the art will be aware of methods to determine the resistivity of water. For example, the electrical resistance between parallel electrodes immersed in the water may be measured.

In some cases, where the water is obtained from an impure water source and/or has a resistivity of less than about 16 MΩ·cm the water may be purified (e.g., filtered) in a manner that changes its resistivity by a factor of less than about 50%, less than about 30%, less than about 25%, less than about 20%, less than about 15%, less than about 10%, less than about 5%, or less, after being drawn from the source prior to use in the electrolysis.

In some embodiments, the water may contain halide ions (e.g., fluoride, chloride, to bromide, iodide), for example, such that an electrode may be used for the desalination of sea water. In some cases, the halide ions might not be oxidized (e.g., to form halogen gas such as Cl₂) during the catalytic production of oxygen from water. Without wishing to be bound by theory, halide ions (or other anionic species) that might not be incorporated in the catalytic material (e.g., within the lattice of the catalytic material) might not be oxidized during the catalytic formation of oxygen from water. This may be because the halide ions might not readily form bonds with the metal ionic species, and therefore, may only have access to outer sphere mechanism for oxidation. In some instances, oxidation of halide ions by an outer sphere mechanism may be not kinetically favorable. In some cases, an electrode may catalytically produce oxygen from water comprising halide ions such that less than about 5 mol %, less than about 3 mol %, less than about 2 mol %, less than about 1 mol %, less than about 0.5 mol %, less than about 0.1 mol %, less than about 0.01 mol % of the gases evolved comprise oxidized halide species. In some embodiments, the impurity is sodium chloride.

In some cases, under catalytic condition, halide ions (or other impurities) might not associate with a catalytic material and/or with metal ionic species. In some instances, a complex comprising a halide ion and a metal ionic species may be substantially soluble such that the complex does not form a catalytic material and/or associate with the current collector and/or electrode. In some cases, the catalytic material may comprise less than about 5 mol %, less than about 3 mol %, less than about 2 mol %, less than about 1 mol %, less than about 0.5 mol %, less than about 0.1 mol %, less than about 0.01 mol % of the halide ion impurities.

In some cases, the oxidation of water may dominate over the oxidation of halide ions (or other impurities) due to various factors include kinetics, solubility, and the like. For example, the binding affinity of an metal ionic species for an anionic species may be substantially greater than the binding affinity of the metal ionic species for a halide ion, such that the coordination sphere of the metal ionic species may be substantially occupied by the anionic species. In other cases, the halide ions might not be incorporated into the lattice of a catalytic material (e.g., as part of the lattice or within the interstitial holes of the lattice) due to the size of the halide ion (e.g., the halide is too large or too small to be incorporated into the lattice of the catalytic material). Those of ordinary skill in the art will be able to determine if an electrode as described herein is able to catalytically produce oxygen using water containing halide ions, for to example, by monitoring the production of halogen gas (or species comprising oxidized halide ions) using suitable techniques, for example, mass spectrometry.

Various components of a device, such as the electrode, power source, electrolyte, separator, container, circuitry, insulating material, gate electrode, etc. can be fabricated by those of ordinary skill in the art from any of a variety of components, as well as those described in any of those patent applications described herein. Components may be molded, machined, extruded, pressed, isopressed, infiltrated, coated, in green or fired states, or formed by any other suitable technique. Those of ordinary skill in the art are readily aware of techniques for forming components of devices herein.

In some cases, a device may be portable. That is, the device may be of such size that it is small enough that it is movable. In some embodiments, a device of the present invention is portable and can be employed at or near a desired location (e.g., water supply location, field location, etc.). For example, the device may be transported and/or stored at a specific location. In some case, the device may be equipped with straps or other components (e.g., wheels) such that the device may be carried or transported from a first location to a second location. Those of ordinary skill in the art will be able to identify a portable device. For instance, the portable device may have a weight less than about 25 kg, less than about 20 kg, less than about 15 kg, less than about 1 kg, less than about 8 kg, less than about 7 kg, less than about 6 kg, less than about 5 kg, less than about 4 kg, less than about 3 kg, less than about 2 kg, less than about 1 kg, and the like, and/or have a largest dimension that is no more than 50 cm, less than about 40 cm, less than about 30 cm, less than about 20 cm, less than about 10 cm, and the like. The weight and/or dimensions of the device typically may or might not include components associated with the device (e.g., water source, water source reservoir, oxygen and/or hydrogen storage containers, etc.).

An electrolyte, as known to those of ordinary skill in the art is any substance containing free ions that is capable of functioning as an ionically conductive medium. In some cases, an electrolyte may comprise water, which may act as the water source. The electrolyte may be a liquid, a gel, and/or a solid. The electrolyte may also comprise methanol, ethanol, sulfuric acid, methanesulfonic acid, nitric acid, mixtures of HCl, organic acids like acetic acid, etc. In some cases, the electrolyte may comprise mixtures of solvents, such as water, organic solvents, amines and the like. In some cases, the pH to of the electrolyte may be about neutral. That is, the pH of the electrolyte may be between about 5.5 and about 8.5, between about 6.0 and about 8.0, about 6.5 about 7.5, and/or the pH is about 7.0. In a particular case, the pH is about 7.0. In other cases, the pH of the electrolyte is about neutral or acidic. In these cases, the pH may range from about 0 to about 8, about 1 to about 8, about 2 to about 8, about 3 to about 8, about 4 to about 8, about 5 to about 8, about 0 to about 7.5, about 1 to about 7.5, about 2 to about 7.5, about 3 to about 7.5, about 4 to about 7.5, about 5 to about 7.5. In yet other cases, the pH may be between about 6 and about 10, about 6 and about 11, about 7 and about 14, about 2 and about 12, and the like. In a specific embodiment, the pH is between about 6 and about 8, between about 5.5 and about 8.5, between about 5.5 and about 9.5, between about 5 and about 9, between about 3 and about 11, between about 4 and about 10, or any other combination thereof. In some cases, when the electrolyte is a solid, the electrolyte may comprise a solid polymer electrolyte. The solid polymer electrolyte may serve as a solid electrolyte that conducts protons and separate the gases produces and or utilized in the electrochemical cell. Non-limiting examples of a solid polymer electrolyte are polyethylene oxide, polyacrylonitrile and commercially available NAFION.

In some cases, the electrolyte may be used to selectively transport one or more ionic species. In some embodiments, the electrolyte(s) are at least one of oxygen ion conducting membranes, proton conductors, carbonate (CO₃⁻²) conductors, OH⁻ conductors, and/or mixtures thereof. In some cases, the electrolyte(s) are at least one of cubic fluorite structures, doped cubic fluorites, proton-exchange polymers, proton-exchange ceramics, and mixtures thereof. Further, oxygen-ion conducting oxides that may be used as the electrolyte(s) include doped ceria compounds such as gadolinium-doped ceria (Gd₁₋ₓCeₓO_{2-d}) or samarium-doped ceria (Sm₁₋ₓCeₓO_{2-d}), doped zirconia compounds such as yttrium-doped zirconia (Y₁₋ₓZrₓO_{2-d}) or scandium-doped zirconia (Sc₁₋ₓZrₓO_{2-d}), perovskite materials such as La₁₋ₓSrₓGa_{1-y}Mg_{y}O_{3-d}, yttria-stabilized bismuth oxide, and/or mixtures thereof. Examples of proton conducting oxides that may be used as electrolyte(s) include, but are not limited to, undoped and yttrium-doped BaZrO_{3-d}, BaCeO_{3-d}, and SrCeO_{3-d} as well as La₁₋ₓSrₓNbO_{3-d}.

In some embodiments, the electrolyte may comprise an ionically conductive material. In some embodiments, the ionically conductive material may comprise the anionic species comprised in the catalytic material on at least one electrode. The presence of the anionic species in the electrolyte, during use of the electrode comprising a catalytic material, may shift the dynamic equilibrium towards the association of the anionic species and/or metal ionic species with the current collector, as described herein. Non-limiting examples of other ionically conductive materials include metal oxy-compounds, soluble inorganic and/or organic salts (e.g., sodium or potassium chloride, sodium sulfate, quaternary ammonium hydroxides, etc.).

In some cases, the electrolyte may comprise additives. For example, the additive may be an anionic species (e.g., as comprised in the catalytic material associated with a current collector). For example, an electrode used in a device may comprise a current collector and a catalytic material comprising at least one anionic species and at least one metal ionic species. The electrolyte may comprise the at least one anionic species. In some cases, the electrolyte can comprise an anionic species which is different from the at least one anionic species comprised in the catalytic material. For example, the catalytic material may comprise phosphate anions and the electrolyte may comprise borate anions. In some cases, when the additive is an anionic species, the electrolyte may comprise counter cations (e.g., when the anionic species is added as a complex, a salt, etc.). The anionic species may be good proton-accepting species. In some cases, the additive may be a good proton-accepting species which is not anionic (e.g., is a neutral base). Non-limiting example of good proton-accepting species which are neutral include pyridine, imidazole, and the like.

In some cases, the electrolyte may be recirculated in the electrochemical device. That is, a device may be provided which is able to move the electrolyte in the electrochemical device. Movement of the electrolyte in the electrochemical device may help decrease the boundary layer of the electrolyte. The boundary layer is the layer of fluid in the immediate vicinity of an electrode. In general, the extent to which a boundary layer exists is a function of the flow velocity of the liquid in a solution. Therefore, if the fluid is stagnant, the boundary layer may be much larger than if the fluid was flowing. Therefore, movement of the electrolyte in the electrochemical device may decrease the boundary layer and improve the efficiency of the device.

In most embodiments, a device may comprise at least one electrode as described herein. In some instances, the device can comprise electrodes besides those as described herein. For example, an electrode may comprise any material that is substantially electrically conductive. The electrode may be transparent, semi-transparent, semi-opaque, and/or opaque. The electrode may be a solid, semi-porous or porous. Non-limiting examples of electrodes include indium tin oxide (ITO), fluorine tin oxide (FTO), glassy carbon, metals, lithium-containing compounds, metal oxides (e.g., platinum oxide, nickel oxide), graphite, nickel mesh, carbon mesh, and the like. Non-limiting examples of suitable metals include gold, copper, silver, platinum, nickel, cadmium, tin, and the like. In some instances, the electrode may comprise nickel (e.g., nickel foam or nickel mesh). The electrodes may also be any other metals and/or non-metals known to those of ordinary skill in the art as conductive (e.g., ceramics). The electrodes may also be photoactive electrodes used in photoelectrochemical cells. The electrode may be of any size or shape. Non-limiting examples of shapes include sheets, cubes, cylinders, hollow tubes, spheres, and the like. The electrode may be of any size. Additionally, the electrode may comprise a means to connect the electrode and to another electrode, a power source and/or another electrical device.

Various electrical components of device may be in electrical communication with at least one other electrical component by a means for connecting. A means for connecting may be any material that allows the flow of electricity to occur between a first component and a second component. A non-limiting example of a means for connecting two electrical components is a wire comprising a conductive material (e.g., copper, silver, etc.). In some cases, the device may also comprise electrical connectors between two or more components (e.g., a wire and an electrode). In some cases, a wire, electrical connector, or other means for connecting may be selected such that the resistance of the material is low. In some cases, the resistances may be substantially less than the resistance of the electrodes, electrolyte, and/or other components of the device.

In some embodiments, a power source may supply DC or AC voltage to an electrochemical device. Non-limiting examples include batteries, power grids, regenerative power supplies (e.g., wind power generators, photovoltaic cells, tidal energy generators), generators, and the like. The power source may comprise one or more such power supplies (e.g., batteries and a photovoltaic cell). In a particular embodiment, the power supply is a photovoltaic cell.

In some embodiments, a device may comprise a power management system, which may be any suitable controller device, such as a computer or microprocessor, and may contain logic circuitry which decides how to route the power streams. The power management system may be able to direct the energy provided from a power source or the energy produced by the electrochemical device to the end point, for example, to an to electrolytic device. It is also possible to feed electrical energy to a power source and/or to consumer devices (e.g., cellular phone, television).

In some cases, electrochemical devices may comprise a separating membrane. The separating membranes or separators for the electrochemical device may be made of suitable material, for example, a plastic film. Non-limiting examples of plastic films included include polyamide, polyolefin resins, polyester resins, polyurethane resin, or acrylic resin and containing lithium carbonate, or potassium hydroxide, or sodium-potassium peroxide dispersed therein.

A container may be any receptacle, such as a carton, can, or jar, in which components of an electrochemical device may be held or carried. A container may be fabricated using any known techniques or materials, as will be known to those of ordinary skill in the art. For example, in some instances, the container may be fabricated from gas, polymer, metal, and the like. The container may have any shape or size, providing it can contain the components of the electrochemical device. Components of the electrochemical device may be mounted in the container. That is, a component (e.g., an electrode) may be associated with the container such that it is immobilized with respect to the container, and in some cases, is supported by the container. A component may be mounted to the container using any common method and/or material known to those skilled in the art (e.g., screws, wires, adhesive, etc). The component may or might not physically contact the container. In some cases, an electrode may be mounted in the container such that the electrode is not in contact with the container, but is mounted in the container such that it is suspended in the container.

Where the catalytic material and/or electrode of the invention is used in connection with an electrochemical device such as a fuel cell, any suitable fuels, oxidizers, and/or reactants may be provided to the electrochemical devices. In a particular embodiment, the fuel is hydrogen gas which is reacted with oxygen gas to produce water as a product. However, other fuels and oxidants can be used. For example, a hydrocarbon gas, such as methane, may be used as a fuel to produce water and carbon dioxide as a product. Other hydrocarbon gases, such as natural gas, propane, hexane, etc., may also be used as fuel. Furthermore, these hydrocarbon materials may be reformed into a carbon containing fuel, such as carbon monoxide, or previously supplied carbon monoxide may also be used as fuel.

The fuel may be supplied to and/or removed from a device and/or system using a fuel transport device. The nature of the fuel delivery may vary with the type of fuel and/or the type of device. For example, solid, liquid, and gaseous fuels may all be introduced in different manners. The fuel transport device may be a gas or liquid conduit such as a pipe or hose which delivers or removes fuel, such as hydrogen gas or methane, from the electrochemical device and/or from the fuel storage device. Alternatively, the device may comprise a movable gas or liquid storage container, such as a gas or liquid tank, which may be physically removed from the device after the container is filled with fuel. If the device comprises a container, then the device may be used as both the fuel storage device while it remains attached to the electrochemical device, and as a container to remove fuel from the electrochemical device. Those of ordinary skill in the art will be aware of systems, methods, and/or techniques for supplying and/or removing fuel from a device or system.

A variety of definitions are now provided which may aid in understanding various aspects of the invention.

In general, the term “aliphatic,” as used herein, includes both saturated and unsaturated, straight chain (i.e., unbranched) or branched aliphatic hydrocarbons, which are optionally substituted with one or more functional groups, as defined below. As will be appreciated by one of ordinary skill in the art, “aliphatic” is intended herein to include, but is not limited to, alkyl, alkenyl, alkynyl moieties. Illustrative aliphatic groups thus include, but are not limited to, for example, methyl, ethyl, n-propyl, isopropyl, allyl, n-butyl, sec-butyl, isobutyl, tert-butyl, n-pentyl, sec-pentyl, isopentyl, tert-pentyl, n-hexyl, sec-hexyl, moieties and the like, which again, may bear one or more substituents, as previously defined.

As used herein, the term “alkyl” is given its ordinary meaning in the art and may include saturated aliphatic groups, including straight-chain alkyl groups, branched-chain alkyl groups, cycloalkyl (alicyclic) groups, alkyl substituted cycloalkyl groups, and cycloalkyl substituted alkyl groups. An analogous convention applies to other generic terms such as “alkenyl,” “alkynyl,” and the like. Furthermore, as used herein, the terms “alkyl,” “alkenyl,” “alkynyl,” and the like encompass both substituted and unsubstituted groups.

In some embodiments, a straight chain or branched chain alkyl may have 30 or fewer carbon atoms in its backbone, and, in some cases, 20 or fewer. In some to embodiments, a straight chain or branched chain alkyl has 12 or fewer carbon atoms in its backbone (e.g., C₁-C₁₂ for straight chain, C₃-C₁₂ for branched chain), has 6 or fewer, or has 4 or fewer. Likewise, cycloalkyls have from 3-10 carbon atoms in their ring structure or from 5, 6 or 7 carbons in the ring structure. Examples of alkyl groups include, but are not limited to, methyl, ethyl, propyl, isopropyl, cyclopropyl, butyl, isobutyl, tert-butyl, cyclobutyl, hexyl, cyclochexyl, and the like. In some cases, the alkyl group might not be cyclic. Examples of non-cyclic alkyl include, but are not limited to, methyl, ethyl, propyl, isopropyl, n-butyl, tert-butyl, n-pentyl, neopentyl, n-hexyl, n-heptyl, n-octyl, n-decyl, n-undecyl, and dodecyl.

The terms “alkenyl” and “alkynyl” refer to unsaturated aliphatic groups analogous in length and possible substitution to the alkyls described above, but that contain at least one double or triple bond respectively. Alkenyl groups include, but are not limited to, for example, ethenyl, propenyl, butenyl, 1-methyl-2-buten-1-yl, and the like. Non-limiting examples of alkynyl groups include ethynyl, 2-propynyl (propargyl), 1-propynyl, and the like.

The terms “heteroalkenyl” and “heteroalkynyl” refer to unsaturated aliphatic groups analogous in length and possible substitution to the heteroalkyls described above, but that contain at least one double or triple bond respectively.

As used herein, the term “halogen” or “halide” designates —F, —Cl, —Br, or —I.

The term “aryl” refers to aromatic carbocyclic groups, optionally substituted, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated Pi electron system, while other, adjoining rings can be cycloalkyls, cycloalkenyls, cycloalkynyls, aryls, and/or heterocycyls. The aryl group may be optionally substituted, as described herein. “Carbocyclic aryl groups” refer to aryl groups wherein the ring atoms on the aromatic ring are carbon atoms. Carbocyclic aryl groups include monocyclic carbocyclic aryl groups and polycyclic or fused compounds (e.g., two or more adjacent ring atoms are common to two adjoining rings) such as naphthyl group. Non-limiting examples of aryl groups include phenyl, naphthyl, tetrahydronaphthyl, indanyl, indenyl and the like.

The terms “heteroaryl” refers to aryl groups comprising at least one heteroatom as a ring atom, such as a heterocycle. Non-limiting examples of heteroaryl groups include pyridyl, pyrazinyl, pyrimidinyl, pyrrolyl, pyrazolyl, imidazolyl, thiazolyl, to oxazolyl, isooxazolyl, thiadiazolyl, oxadiazolyl, thiophenyl, furanyl, quinolinyl, isoquinolinyl, and the like.

It will also be appreciated that aryl and heteroaryl moieties, as defined herein, may be attached via an aliphatic, alicyclic, heteroaliphatic, heteroalicyclic, alkyl or heteroalkyl moiety and thus also include -(aliphatic)aryl, -(heteroaliphatic)aryl, -(aliphatic)heteroaryl, -(heteroaliphatic)heteroaryl, -(alkyl)aryl, -(heteroalkyl)aryl, -(heteroalkyl)aryl, and -(heteroalkyl)-heteroaryl moieties. Thus, as used herein, the phrases “aryl or heteroaryl” and “aryl, heteroaryl, (aliphatic)aryl, -(heteroaliphatic)aryl, -(aliphatic)heteroaryl, -(heteroaliphatic)heteroaryl, -(alkyl)aryl, -(heteroalkyl)aryl, -(heteroalkyl)aryl, and -(heteroalkyl)heteroary” are interchangeable.

Any of the above groups may be optionally substituted. As used herein, the term “substituted” is contemplated to include all permissible substituents of organic compounds, “permissible” being in the context of the chemical rules of valence known to those of ordinary skill in the art. It will be understood that “substituted” also includes that the substitution results in a stable compound, e.g., which does not spontaneously undergo transformation such as by rearrangement, cyclization, elimination, etc. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl group” must still comprise the phenyl moiety and can not be modified by substitution, in this definition, to become, e.g., a pyridine ring. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms.

Examples of substituents include, but are not limited to, aliphatic, alicyclic, heteroaliphatic, heteroalicyclic, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, heteroalkylthio, heteroarylthio, sulfonyl, sulfonamido, ketone, aldehyde, ester, heterocyclyl, aromatic or heteroaromatic moieties, —CF₃, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, -carboxamido, acyloxy, aminoalkyl, alkylaminoaryl, alkylaryl, alkylaminoalkyl, alkoxyaryl, arylamino, aralkylamino, alkylsulfonyl, -carboxamidoalkylaryl, -carboxamidoaryl, hydroxyalkyl, haloalkyl, alkylaminoalkylcarboxy-, aminocarboxamidoalkyl-, cyano, alkoxyalkyl, perhaloalkyl, arylalkyloxyalkyl, (e.g., SO₄(R′)₂), a phosphate (e.g., PO₄(R′)₃), a silane (e.g., Si(R′)₄), a urethane (e.g., R′O(CO)NHR′), and the like. Additionally, the substituents may be selected from F, Cl, Br, I, —OH, —NO₂, —CN, —NCO, —CF₃, —CH₂CF₃, —CHCl₂, —CH₂ORₓ, —CH₂CH₂ORₓ, —CH₂N(Rₓ)₂, —CH₂SO₂CH₃, —C(O)Rₓ, —CO₂(Rₓ), —CON(Rₓ)₂, —OC(O)Rₓ, —C(O)OC(O)Rₓ, —OCO₂Rₓ, —OCON(Rₓ)₂, —N(Rₓ)₂, —S(O)₂Rₓ, —OCO₂Rₓ, —NR_{X}(CO)R_{X}, —NRₓ(CO)N(Rₓ)₂, wherein each occurrence of Rₓ independently includes, but is not limited to, H, aliphatic, alicyclic, heteroaliphatic, heteroalicyclic, aryl, heteroaryl, alkylaryl, or alkylheteroaryl, wherein any of the aliphatic, alicyclic, heteroaliphatic, heteroalicyclic, alkylaryl, or alkylheteroaryl substituents described above and herein may be substituted or unsubstituted, branched or unbranched, cyclic or acyclic, and wherein any of the aryl or heteroaryl substituents described above and herein may be substituted or unsubstituted.

The following references are herein incorporated by reference: U.S. Provisional Patent Application Ser. No. 61/073,701, filed Jun. 18, 2008, entitled “Catalyst Compositions and Electrodes for Photosynthesis Replication and Other Electrochemical Techniques,” by Nocera, et al., U.S. Provisional Patent Application Ser. No. 61/084,948, filed Jul. 30, 2008, entitled “Catalyst Compositions and Electrodes for Photosynthesis Replication and Other Electrochemical Techniques,” by Nocera, et al., U.S. Provisional Patent Application Ser. No. 61/103,879, filed Oct. 8, 2008, entitled “Catalyst Compositions and Electrodes for Photosynthesis Replication and Other Electrochemical Techniques,” by Nocera, et al., U.S. Provisional Patent Application Ser. No. 61/146,484, filed Jan. 22, 2009, entitled “Catalyst Compositions and Electrodes for Photosynthesis Replication and Other Electrochemical Techniques,” by Nocera, et al., U.S. Provisional Patent Application Ser. No. 61/179,581, filed May 19, 2009, entitled “Catalyst Compositions and Electrodes for Photosynthesis Replication and Other Electrochemical Techniques,” by Nocera, et al., and

The following examples are intended to illustrate certain embodiments of the present invention, but do not exemplify the full scope of the invention.

### Example 1

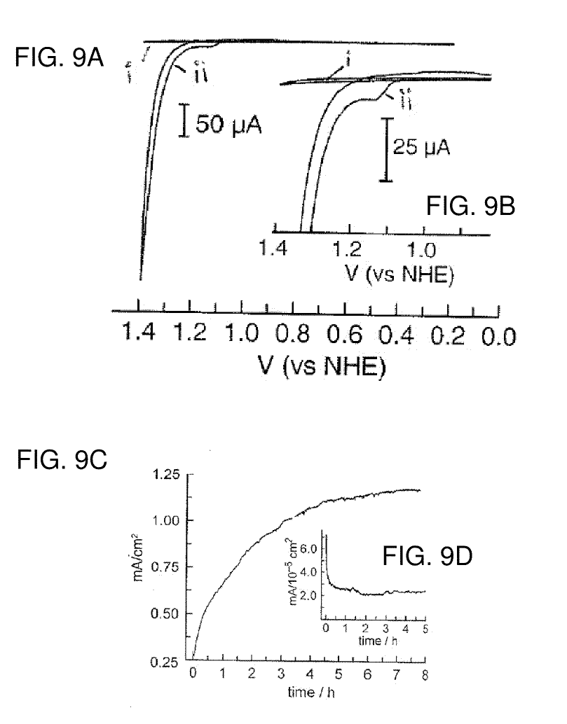

The following gives an example of the formation of an electrode according to a non-limiting embodiment. Cyclic voltammetry of a 0.5 mM solution of Co(NO₃)₂ in 0.1 M potassium phosphate pH 7.0 (herein referred to as neutral KPi electrolyte) exhibited an oxidation wave at 0.915 V followed by the onset of a strong catalytic wave at 1.0 V. As reported in this example, and those following, all voltages are reported relative to a normal hydrogen electrode, NHE, unless otherwise stated. A broad, relatively weak reduction wave was observed on the cathodic scan. FIG. 9A shows the cyclic voltammogram in neutral 0.1 M KPi electrolyte with (i) no Co²⁺ ion present and (ii) a scan with 0.5 mM Co²⁺ present. FIG. 9B shows a magnified version of the same graph in FIG. 9A.

### Example 2

This example relates to the preparation and characterization of a non-limiting example of an electrode according to a non-limiting embodiment. Indium-tin-oxide (ITO) was used as the current collector for bulk electrolysis to ensure a minimal background activity for O₂ production. Application of 1.3 V to the current collector immersed (without stirring) in a 0.1 M potassium phosphate at pH 7.0 containing 0.5 mM Co²⁺, exhibited a rising current density that reached a peak value >1 mA/cm² over 7-8 h. FIG. 9C shows the current density profile for bulk electrolysis at 1.3 V (vs. NHE) in neutral 0.1 M KPi containing 0.5 mM Co²⁺. During the time of the formation of the electrode, a dark coating formed on the ITO surface (e.g., the “catalytic material”) and effervescence from this coating became increasingly vigorous. The same result was observed using either CoSO₄, Co(NO₃)₂, or Co(OTf)₂ as the Co²⁺ source, indicating that the original Co²⁺ counterion and source could be exchanged. The amount of charge passed over the course an 8 h electrolysis exceeded what could be accounted for by stoichiometric oxidation of the Co²⁺ in solution. These observations are indicative of an in situ formation of an oxygen evolving catalytic material. In a control experiment, the current density during bulk electrolysis under identical conditions in the absence of Co²⁺ rapidly drops to a baseline level of ˜25 nA/cm², as shown in FIG. 9D. A catalytic material comprising Co and phosphate has been deposited on many non-limiting current collectors, for example, ITO (indium-tin oxide), FTO (fluorine doped tin oxide), carbon, steel, stainless steel, copper, titanium, nickel. Textured substrates can also be used, for example, nickel foam.

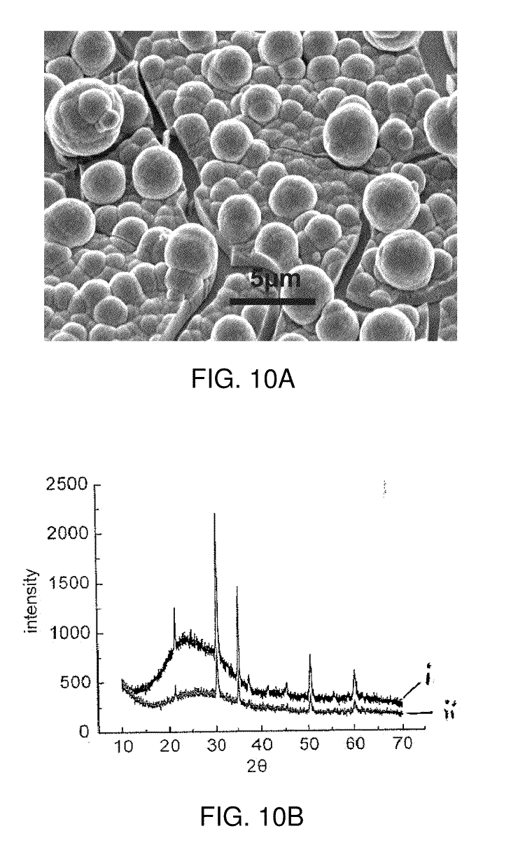

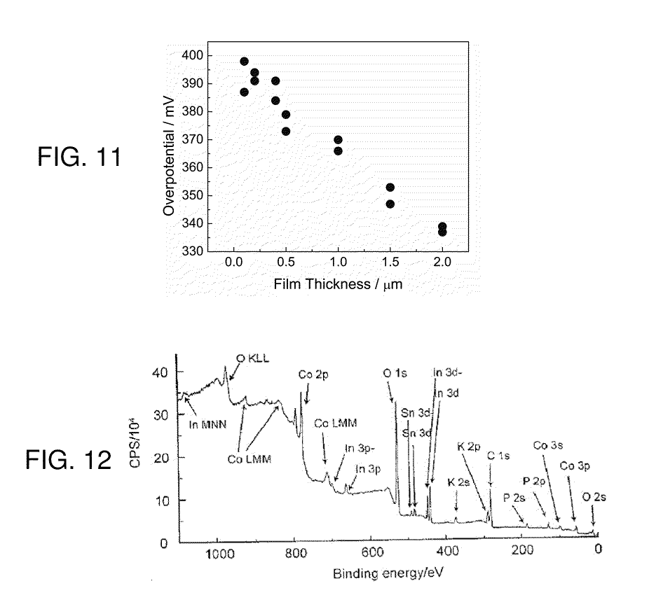

The morphology of the catalytic material formed during electrolysis in the presence of Co²⁺ was examined by scanning electron microscopy (SEM). In this example, the electrocatalytic material comprised of particles that coalesced into a thin film and individual μm-sized particles on top of the film. FIG. 10A shows the SEM image (30° tilt) of the electrocatalytic material on the current collector after 30 C/cm² were passed in neutral 0.1 M KPi electrolyte containing 0.5 mM Co²⁺. The ITO current collector can be seen through cracks in the film that form upon drying, as evidenced by particles that are split into complementary pieces. The film thickness gradually increased over the course of the electrodeposition. At maximum activity under these electrolysis conditions, the film was about 2 um thick. The X-ray powder diffraction pattern of an electrodeposited catalytic material, as shown in FIG. 10B, line (i), showed broad amorphous features and no peaks indicative of crystalline phases other than the peaks associated with the ITO layer (which is shown in FIG. 10B, line (ii)), indicating that the material, in this case, was amorphous. In some embodiments, the overpotential (at an electrode current density of 1 mA/cm²) for the production of oxygen from water may decrease with increasing thickness of the catalytic material. For example, as shown in FIG. 11, the overpotential for the production of oxygen from water was about 0.4 V in cases where the catalytic material (comprising cobalt ions and phosphate anions) was about 0.1 um thickness and the overpotential was about 0.34 V when the catalytic material has a thickness of about 2 um.

In the absence of detectable crystallites, the composition of the electrocatalytic material was analyzed by three complementary techniques. Energy-dispersive X-ray analysis (EDX) spectra were obtained from multiple 100-300 um² regions of several independently prepared samples. These spectra identify Co, P, K and O as the principal elemental components of the material. The analyses indicated a Co:P:K ratio between about 2:1:1 and about 3:1:1 (spectra acquired at 12 kV). Microanalytical elemental analysis of material scraped from an plurality of ITO electrode indicated about 31.1% Co, about 7.70% P and about 7.71% K, corresponding to an approximate 2.1:1.0:0.8 Co:P:K ratio. Finally, the surface of an catalytic material on the ITO current collector was analyzed by X-ray photoelectron spectroscopy, as shown in FIG. 12. All peaks in the XPS spectra were accounted for by the elements detected above in addition to In and Sn from the ITO substrate. The high-resolution P 2p peak was observed at 133.1 eV, which is consistent with phosphate. The Co 2p peaks were observed at 780.7 eV and 795.7 eV within a range typical of Co²⁺ or Co³⁺ bound to O, but do not match the reported spectra for known cobalt oxides.

### Example 3

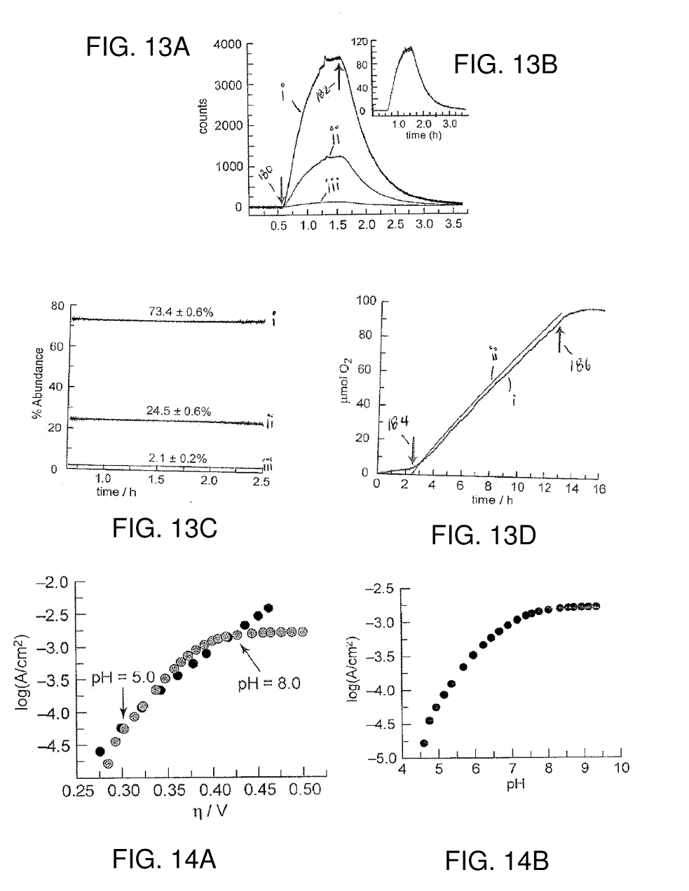

The following example describes the catalytic oxidation of water to form oxygen using an electrode according to a non-limiting embodiment, for example, the electrode describe in Example 2. The following example was performed in neutral KPi electrolyte in the absence of Co²⁺ using ˜1.3 cm² of an electrode prepared according to Example 2. To confirm that water is the source of the O₂ produced, an electrolysis was performed in helium-saturated buffer containing 14.5% ¹⁸OH₂ in a gas tight electrochemical cell in line with a mass spectrometer. Helium carrier gas was continuously flowed through the headspace of the anodic compartment into the mass spectrometer and the relative abundances of ³²O₂, ³⁴O₂ and ³⁶O₂ were monitored at 2 second intervals. Within minutes of initiating electrolysis, the signals for the three isotopes rose above their background levels as the O₂ produced by the catalyst escaped into the headspace. Upon terminating the electrolysis one hour later these signals slowly returned to their background levels. FIG. 13A shows the mass spectrometric detection of isotopically-labeled (i) ^{16,16}O₂, (ii) ^{16,18}O₂, and (iii) ^{18,18}O₂, during electrolysis of a catalytic material on ITO in neutral KPi electrolyte containing 14.5% ¹⁸OH₂. Arrow 180 indicates initiation of electrolysis at 1.3 V (vs. NHE) and arrow 182 indicates termination of electrolysis. FIG. 13B shows an expansion of the ^{18,18}O₂ signal. The ³²O₂, ³⁴O₂, and ³⁶O₂ isotopes were detected in the statistical ratio (73.4%, 24.5%, and 2.1% relative abundances, respectively).

The Faradaic efficiency of the catalyst was measured using a fluorescence-based O₂ sensor. Electrolysis was performed in neutral KPi electrolyte in a gas tight electrochemical cell under an argon atmosphere with the sensor placed in the headspace. After initiating electrolysis at 1.3 V, the percentage of O₂ detected in the headspace rose in accord with what was predicted by assuming that all of the current was due to 4e⁻ oxidation of water to produce O₂. The amount of O₂ produced (95 umoles, 3.0 mg) greatly exceeded the amount of catalyst (˜0.1 mg), which shows no perceptible decomposition over the course of the experiment. FIG. 13D shows the O₂ production (i) measured by fluorescent sensor and (ii) the theoretical amount of O₂ produced assuming a Faradaic efficiency of 100%. Arrow 184 indicates initiation of electrolysis at 1.3 V and arrow 186 indicates termination of electrolysis

The stability of phosphate under catalytic conditions was assayed by ³¹P NMR. An electrolysis in a two compartment cell with 10 mL of neutral KPi electrolyte (1 mmol of Pi) on each side was allowed to proceed until 45 C had been passed through the cell (0.46 mmol electrons). Single, clean ³¹P NMR resonances were observed for the electrolysis solutions from both chambers, indicating that the buffer is robust under these conditions. Together, the mass spectrometry, Faradaic efficiency and ³¹P NMR results demonstrated that the electrodeposited catalyst cleanly oxidizes H₂O to O₂ in neutral KPi solutions.

The current density of a catalytic material on ITO current collector was measured as a function of the overpotential (η). At pH 7.0, appreciable catalytic current was observed beginning at η=0.28 V and a current density of 1 mA/cm² (corresponding to 9 umol O₂ cm⁻² h⁻¹) required η=0.42 V. The Tafel plot deviated slightly from linearity, most likely reflecting an uncompensated IR drop due to the resistivity of the ITO (8-12 Ω/sq). FIG. 14A shows a Tafel plot (black), η=(Vappl−iR)−E(pH 7), of the catalytic material on ITO in neutral 0.1 M KPi electrolyte, corrected for the iR drop of the solution. The plot also shows the pH data converted into a Tafel plot (grey), η=(Vappl+0.0594pH−iR)−E(pH 7), assuming Nernstian behavior and correcting for iR drop of the solution. The pH=5 and pH=8 data points are indicated by arrows. The pH profile of the current density revealed a dependence on the relative proportions of phosphate species in solution. FIG. 14B shows the current density dependence on pH in 0.1 M KPi electrolyte. The potential was set at 1.25 V (vs. NHE) with no iR compensation.

### Example 4

The following is an example of the materials that may be used to prepare and electrode according to a non-limiting embodiment. Co(NO₃)₂ 99.999% can be purchased from Aldrich, CoSO₄ can be purchased from Baker and Co(SO₃CF₃)₂ can be synthesized from CoCO₃.6H₂O according to Byington, A. R.; Bull, W. E. Inorg. Chim. Acta. 21, 239, (1977). KH₂PO₄ can be purchased from Mallinckrodt. All buffers can be prepared with reagent grade water (Ricca Chemical, 18 MΩ-cm resistivity). Indium-tin-oxide coated glass slides (ITO) can be purchased from Aldrich. The ITO, in most of the examples discussed herein, had a 8-12 Ω/sq surface resistivity. The electrochemical to experiments can be performed with a CH Instruments potentiostat or a BASi CV50W potentiostat and a BASi Ag/AgCl reference electrode. Unless otherwise stated, the electrolyte used in the examples discussed herein was 0.1 M potassium phosphate pH 7.0 (neutral KPi electrolyte). Conductive thermoplastic silver composition, DuPont 4922N, can be purchased from Delta Technologies.

### Example 5

The following give a non-limiting example of bulk electrolyses that may be performed on an electrode as described herein. Bulk electrolyses were performed in a two-compartment electrochemical cell with a glass frit junction of fine porosity. For catalyst electrodeposition, the auxiliary side of the cell contained 40 mL of KPi electrolyte and the working side of the cell contained 40 mL of KPi electrolyte containing 0.5 mM Co²⁺. Cobalt solutions were prepared fresh for each experiment. At slightly higher Co²⁺ concentrations (1 mM), a small amount of white precipitate is observed following dissolution of the Co²⁺ source. Although this precipitate was not readily visible at 0.5 mM Co²⁺, these solutions were passed through a 0.45 um syringe filter prior to use to remove microprecipitates. The working electrode was a 1 cm×2.5 cm piece of ITO-coated glass cut from a commercially available slide and rinsed with acetone and deionized water prior to use. Typically, 1 cm×1.5 cm was immersed in the solution. Platinum mesh was used as the auxiliary electrode. Electrolysis was carried out at a selected potential (e.g., about 1.3 V) with or without stirring, with or without IR compensation, and with the reference electrode placed a few mm from the ITO surface.

### Example 6

The following give an example of a cyclic voltammogram experiment that may be performed on an electrode as described herein. A 0.07 cm² glassy carbon button electrode was used as the working electrode and Pt wire as the auxiliary electrode. The working electrode was polished 60 s with 0.05 um alumina particles and sonicated 2×30 in reagent grade water prior to use. Cyclic voltammograms were collected at 50 mV/s and 0.1 mA/V sensitivity in KPi electrolyte and KPi electrolyte containing 0.5 mM CO²⁺. Compensation for iR drop was used for the CV collected in the presence of Co²⁺.

### Example 7

The following give an example of how to obtain data for the preparation of a Tafel plot. Current-potential data were obtained by performing bulk electrolyses in KPi electrolyte at a variety of applied potentials in a two-compartment cell containing 40 mL of fresh KPi electrolyte on each side. Prior to data collection, the solution resistance was measured with a clean ITO electrode using the IR test function. A 1.3 cm² catalyst prepared in an electrodeposition that passed 21 C/cm² was then transferred without drying to this cell and placed in the same configuration with respect to the reference electrode as the ITO that was used to measure the solution resistance. Steady-state currents were measured at a variety of applied potentials while the solution was stirred, starting at about 1.45 V and proceeding in 25-50 mV steps to about 1.1 V. Typically, the current reached a steady state at a particular potential in 2-5 minutes. The measurements were made twice and the variation in steady-state current between two runs at a particular potential was <3%. The solution resistance measured prior to the data collection was used to correct the Tafel plot for IR drop.

### Example 8

The following give an example of the pH dependence that may be observed when using an electrode as described herein. The electrode used to collect data for the Tafel plot was transferred without drying to an electrochemical cell containing 40 mL of 0.1 M potassium phosphate pH 4.5 on each side. Bulk electrolysis was initiated at a selected potential (e.g., about 1.25 V, etc.)while the solution was stirred. At 5 min intervals, a small aliquot (e.g., 10-100 ul (microliter)) of 25 wt % KOH was added to each compartment. The pH was continuously monitored with a micro-pH probe (Orion) placed in the working compartment. The current stabilized at each new pH within 30 s and the pH remained steady within 0.01 units over the course of each 5 min interval. At the conclusion of the experiment, the solution resistance was measured with a blank ITO electrode placed in the same configuration with respect to the reference electrode as the catalyst. This value was used to calculate the IR term in the calculation of the overpotential at each pH. Solution resistance decreased as the pH was increased (e.g., R=45 ohm at pH 4.8; R=33 ohm at pH 7.2; R=31 ohm at pH 9.0)

### Example 9

The following give examples on characterization techniques that may be employed when analyzing and electrode as described herein.

Microanalysis was performed by Columbia Analytics (formerly Desert Analytics) in Tucson, Ariz. Catalysts were prepared on four 2.5 cm×2.5 cm ITO substrates in electrodepositions that passed 5-6 C/cm². The slides were rinsed gently with reagent-grade water and allowed to dry in air. The electrocatalytic material was carefully to scraped off using a razor blade and the combined material was submitted for microanalysis. The sample was further dried for 2 h at 25° C. under vacuum prior to analysis.

Powder X-ray diffraction patterns were obtained with a Rigaku RU300 rotating anode X-ray diffractometer (185 mm) using Cu Kα radiation (λ=1.5405 Å). Data was collected in Bragg-Brettano mode using 0.5° divergence and scatter slits and a 0.3° receiving slit and a scan rate of 1°/min. A pattern was collected for a clean ITO-coated glass substrate and for a catalyst prepared in an electrodeposition that passed 30 C/cm². The pattern for the clean ITO substrate consists of peaks due to ITO crystallites and an amorphous feature due to the glass beneath the ITO layer. The intensity of the diffracted radiation was attenuated for the catalyst sample, most likely due to X-ray absorption by the cobalt ions. Given that the electrodeposited catalyst sample was >2 um thick, the presence of peaks from the relatively thin ITO layer and the absence of any non-ITO associated peaks indicated that the catalytic material, in this instance, was amorphous. An SEM was taken after the powder X-ray diffraction pattern to confirm the thickness of the catalyst coating.

XPS spectra were acquired with a Crates AXIS Ultra Imaging X-ray Photoelectron Spectrometer using a monochromatized Al Kα small-spot source and a 160 mm concentric hemispherical energy analyzer. The sample used for XPS was prepared in an electrodeposition that passed 12 C/cm². The spectra are referenced to the adventitious C is peak (285.0 eV).

NMR spectra were obtained using a Varian Mercury 300 NMR spectrometer. A 1.3 cm² catalyst was prepared in an electrodeposition that passed 30 C/cm² and transferred to a small two-compartment electrochemical cell containing 10 mL 0.1 M KPi buffer on the working side and 8 mL on the auxiliary side. Electrolysis was initiated at 1.3 V without IR compensation and allowed to proceed with stirring until 45 C (0.46 equiv. electrons with respect to phosphate in the working compartment) had been passed through the solution (13 h). A ³¹P NMR spectrum of the electrolysis solution taken directly from each compartment was then obtained. The ³¹P NMR resonance of the starting buffer is 2.08 ppm (referenced to H₃PO₄). The ³¹P NMR spectrum of the solution from the working side was shifted upfield to 1.17 ppm, reflecting a drop in pH over the course of the electrolysis to 6.2. The spectrum of the auxiliary side was shifted downfield to 3.17 ppm, reflecting a pH increase to 10.5. Without wishing to be bound by theory, these pH changes may be a consequence of preferential K⁺ transport vs. H⁺ transport ([K⁺]>10⁶[H⁺]) through the glass frit during electrolysis. No phosphorous-containing species other than phosphate were evident in either spectrum.

SEM images and EDX spectra were obtained with a JSM-5910 microscope (JEOL) equipped with a Rontec EDX system. Following electrodeposition, catalyst samples were rinsed gently with deionized water and allowed to dry in air before loading into the instrument. Images were obtained with an acceleration voltage of 4-5 kV and EDX spectra were obtained with acceleration voltages between 12 kV and 20 kV.

An Agilent Technologies 5975C Mass Selective Detector operating in electron impact ionization mode was used to collect mass spectrometric data. The experiment was performed in a custom built two-compartment gas-tight electrochemical cell with gas inlet and outlet ports and a glass frit junction. One compartment contained the working and reference electrodes and the other compartment contained the auxiliary electrode. The catalyst used was prepared in an electrodeposition that passed 30 C/cm². The electrolyte (pH 7.0) containing 14.6% ¹⁸OH₂ was degassed by bubbling with ultra high purity He for 2 h with vigorous stirring and transferred to the electrochemical cell under He. The cell was connected to the He carrier gas and mass spectrometer and purged for several hours before data collection. The mass spectrometer was operated in selective ion mode that monitored for 28 (N₂), 32 (^{16,16}O₂), 34 (^{18,16}O₂), 36 (^{18,18}O₂), and 35 (Cl₂ fragment) amu ions. The 28 amu signal was used to determine the residual air background. Before electrolysis was initiated, the 28/32 signal ratio was stable at 3.6 and the 28/34 ratio was stable at 226. These ratios were used to obtain the background 32 ion and 34 ion signals at all points during the experiment. The background 36 ion signal was stable at 38.5 prior to electrolysis and this value was used as the 36 ion background for all points. The 35 ion signal was monitored to determine if any Cl₂ was produced during electrolysis via oxidation of adventitious Cl⁻ from the reference electrode. No increase in this signal was observed throughout the experiment. Electrolysis was allowed to proceed for 1 h at 1.3 V without IR compensation.

### Example 10

The following gives an example of how to determine Faradaic efficiency of an electrode, according to one embodiment. An Ocean Optics oxygen sensor system was used for the quantitative detection of O₂. The experiment was performed in a custom built two-compartment gas-tight electrochemical cell with a 14/20 port on each compartment and a Schlenk connection with a Teflon valve on the working compartment. KPi electrolyte (pH 7.0) was degassed by bubbling with high purity N₂ for 2 h with vigorous stirring and transferred to the electrochemical cell under N₂. One compartment contained a Pt mesh auxiliary electrode and the other compartment contained the working and Ag/AgCl reference electrodes. The catalyst used as the working electrode was prepared in an electrodeposition that passed 15 C/cm². The reference electrode was positioned several cm from the surface of the catalyst. The 14/20 port of the working compartment was fitted with a FOXY OR125-73 mm O₂ sensing probe connected to a MultiFrequency Phase Fluorometer. The phase shift of the O₂ sensor on the FOXY probe, recorded at 10 s intervals, was converted into the partial pressure of O₂ in the headspace using a two-point calibration curve (air, 20.9% O₂; and high purity N₂, 0% O₂). After recording the partial pressure of O₂ for 2.5 h in the absence of an applied potential, electrolysis was initiated at 1.3 V without IR compensation. Electrolysis with O₂ sensing was continued for 10.5 h. Upon terminating the electrolysis, the O₂ signal was recorded for an additional 2 h. At the conclusion of the experiment, the volume of the solution and the volume of the headspace in the working compartment were measured (34 mL and 59 mL, respectively). Line (ii) in FIG. 13C was calculated by dividing the charge passed in the electrolysis by 4F and the line (i) was calculated by converting the measured partial pressure of O₂ into umols, correcting for the O₂ in solution using Henry's Law. The final partial pressure of O₂ was 0.040 atm.

### Example 11

The following example describes the formation and use of an electrode comprising a phosphonate and the use of the electrode in an electrolyte comprising chloride ions. The electrode produced in this example is able to produce O₂ selectively in the presence 0.5 M NaCl.

Using methods similar to those describe in the examples above, an electrode was formed wherein the anionic species was methylphosphonate. Similar to the previously discussed examples, electrolysis of simple Co(II) salts in methylphosphonate-buffered aqueous solutions at pH 8.0 leads to the electrodeposition of Co-containing thin films with remarkable activity for anodic production of O₂. For example, electrolysis of 1 mM Co(NO₃)₂ in 0.1 M sodium methylphosphonate, pH 8.0, at 1.3 V vs. NHE, is accompanied by continuous bubbling and the formation of a dark green coating on an ITO anode. Similar behavior is observed with phenyl phosphonate as well. The current in such an electrolysis increases to a plateau over 1-2 hours at about 1.6 mA/cm². After an electrolysis in the presence of Co(NO₃)₂, the anode was placed in fresh Co-free phosphonate buffer and maintained its current density and O₂-evolving activity ³¹P NMR spectroscopy of electrolyzed and fresh buffer verified that the methylphosphonate buffer is not degraded over the course of prolonged electrolysis.

The nature of the active electrode coating that forms upon electrolysis was probed by scanning electron microscopy (SEM). The coating exhibits a great degree of similarity to the previously disclosed films. Cracks form in the film upon drying in preparation for the SEM, revealing the ITO surface underneath. Energy-dispersive x-ray analysis (EDX) of the SEM sample identifies Co, P, O, C, and Na in the film; the presence of C indicates incorporation of the methylphosphonate species. EDX and elemental analysis suggest that, in contrast to the phosphate supported catalyst, this film contains a much higher Co to P ratio (˜5/1 vs. 2/1).

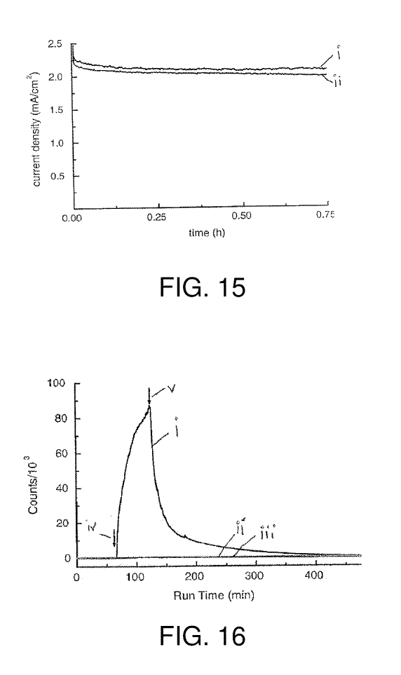

In some cases, the presence of other anions in the buffer, such as sulfate, or pyrophosphate may have a deleterious effect on catalysis and film stability. In this example, formation of the active anode was significantly inhibited in the presence of NaCl concentrations in excess of 0.1 M. However, an active anode which was prepared in the absence of Cl⁻ can then be introduced to a buffer containing 0.5 M NaCl with no appreciable decrease in activity (FIG. 15). FIG. 15 shows a graph of the current density of an electrode versus time for (i) an activated electrode in 0.1 M MePO₃ at pH 8.0 and (ii) an activated electrode in 0.1 M MePO₃ and 0.5 M NaCl at pH 8.0. Furthermore, no dissolution of the catalyst film was observed even upon prolonged electrolysis over the course of several hours.

As another example, an active anode prepared from phosphate or methylphosphonate buffer in the absence of chloride retained high activity when examined in Co-free buffers containing about 0.5 M NaCl. Controlled potential electrolysis at about 1.3 V in either phosphate buffer pH 7.0 or methylphosphonate buffer pH 8.0 revealed sustained currents densities greater than about 0.9 mA/cm². These current densities were comparable to those observed in the absence of NaCl suggesting that chloride, in this cases, did not inhibit O₂ evolving catalysis (vida infra). Notably, EDX analysis of the film after prolonged (16 h) electrolysis in the presence of 0.5 M NaCl, revealed negligible chloride incorporation

An operating voltage of about 1.30 V is slightly greater than the formal HOCl/Cl— redox process (1.28 V at pH 7.0). Faradaic efficiency measurements were conducted at about 1.30 V using a phosphate buffering environment at pH 7.0. Approximately 100% O₂ Faradaic efficiency was observed as the trace was in close agreement with the O₂ measured by fluorescence-based detection of the evolved gases indicating that water was oxidized selectively to O₂. This was further corroborated by direct quantification of oxidized chloride species (HOCl/OCl—). An electrode prepared in the absence of chloride was electrolyzed in the presence of about 0.5 M NaCl for about 16 h (approximately 76.5 C passed) at about 1.30 V and a standard N,N-diethyl-p-phenylenediamine titrimetric assay (e.g., see Example 12 for description) was used to quantify hypochlorite produced. About 9.3 umol of oxidized chloride species were observed account for about 1.80 C, approximately 2.4%, of the total current passed in the experiment. In this embodiment, at significantly higher applied potentials (e.g., about 1.66 V), a decrease in Faradaic efficiency was observed which may suggest that in some cases, chloride oxidation may become competitive with O₂ production at very high overpotential.

Electrolysis conducted in the presence of 0.5 M NaCl produces O₂ nearly exclusively as detected by real-time mass spectral analysis of the evolved gases. FIG. 16 shows the mass spectrometry results for the detection of (i) O₂, (ii) CO₂ and (iii) ³⁵Cl, wherein arrows (iv) and (v) represent the start and end of electrolysis, respectively. No mass fragments associated with Cl₂ are observed although a trace amount (˜0.5% relative to O₂) of CO₂ is observed. The source of the trace CO₂ is under investigation. Notably, no Cl₂ fragments are observed even upon electrolyses conducted at 150 mV past the thermodynamic potential for chloride oxidation. These results indicate that the catalyst selectively oxidized water to O₂ even in the presence of large concentrations of chloride ions.

The electrode produced showed high efficiencies for oxygen production. Activity was maintained for several weeks. The electrode maybe removed from solution, stored and when re-inserted back into aqueous solutions, weeks after storage, oxygen activity resumes without diminishment.

### Example 12

The following example outlines the materials and experiment data relating to Example 13.

Materials. See, for example, the materials disclosed in Example 4.

Electrochemical methods. All electrochemical experiments were performed at ambient temperature with a CH Instruments 730C potentiostat or a BASi CV50W potentiostat and a BASi or CH Instruments Ag/AgCl reference electrode. All electrode potentials were converted to the NHE scale using E(NHE)=E(Ag/AgCl)+0.199 V. Unless otherwise stated, the electrolyte used in this example and in Example 13 was 0.1 M sodium methylphosphonate at about pH 8.0 (herein referred to as MePi electrolyte).

Cyclic voltammetry. A 0.07 cm² glassy carbon button electrode was used as the working electrode and Pt wire as the auxiliary electrode. The working electrode was polished for approximately 60 s with 0.05 um alumina particles and sonicated 2×30 s in reagent grade water prior to use. Cyclic voltammograms (CVs) were collected at approximately 50 mV/s and 0.01 or 0.1 mA/V sensitivity in MePi electrolyte and MePi electrolyte containing approximately 1.0 mM Co²⁺. To illustrate deposition upon oxidation, a polished electrode was used to a record a CV with a switching potential of approximately 1.05 V (vs. NHE) in approximately 1.0 mM Co²⁺ containing MePi electrolyte. After the first full scan, the electrode was removed, rinsed with reagent grade water, and placed back into a Co-free MePi electrolyte solution. A CV with about a 1.30 V switching potential was recorded. Upon polishing the electrode, a clean background was observed. In all cases, CVs were taken without iR compensation.

Bulk electrolysis and in situ catalyst formation. Bulk electrolyses were performed in a two-compartment electrochemical cell with a glass frit junction of fine porosity. For catalyst electrodeposition (e.g., formation of catalytic material), the auxiliary side held approximately 40 mL of MePi electrolyte and the working side held 40 mL of MePi electrolyte containing approximately 1.0 mM Co²⁺. The working electrode was about a 1 cm×2.5 cm piece of ITO-coated glass cut from a commercially available slide and coated with a 0.3-0.5 cm wide strip of silver composition along one 1 cm edge. In some cases, 1 cm×1.5 cm was immersed in the solution. Pt mesh was used as the auxiliary electrode. Electrolysis was carried out at approximately at a selected voltage (e.g., about 1.29 V) without stirring and without iR compensation and with the reference electrode placed a few mm from the ITO surface. For experiments utilizing films prepared from phosphate buffer the above procedure was used with substitution of to MePi for about 0.1 potassium phosphate (KPi), pH about 7.0, about 0.5 mM Co²⁺.

Tafel plot. Current-potential data were obtained by performing bulk electrolyses in MePi electrolyte at a variety of applied potentials in a two-compartment cell containing 40 mL of fresh MePi electrolyte on each side. Prior to data collection, the solution resistance was measured with a clean ITO electrode using the iR test function. A 1.5 cm² catalyst prepared in an electrodeposition that passed 8 C/cm² was then transferred without drying to this cell and placed in the same configuration with respect to the reference electrode as the ITO that was used to measure the solution resistance. Steady-state currents were measured at a variety of applied potentials while the solution was stirred, starting at about 1.25 V and proceeding in approximately 25-50 mV steps to about 0.85 V. In some cases, the current reached a steady state at a particular potential in 2-5 minutes. Measurements were made twice and the variation in steady-state current between two runs at a particular potential was <5%. The solution resistance measured prior to the data collection was used to correct the Tafel plot for iR drop. Current density dependence on pH. See, for example, the experimental procedure described in Example 8.

Elemental Analysis. See, for example, the experimental procedure described in Example 9. The mole ratios of the analyzed materials are shown in Table 1.

TABLE 1
Mole ratios from elemental analysis

| Conditions | Co | P | Na | C |
|---|---|---|---|---|
| MePi, pH 8.0, 1 mM Co²⁺ | 4.5 | 1 | 1.2 | 0.6 |
| MePi, pH 8.0, 10 mM Co²⁺ | 4.5 | 1 | 0.9 | 0.8 |
| MePi, pH 7.0, 10 mM Co²⁺ | 5.6 | 1 | 0.6 | 0.7 |

Scanning electron microscopy (SEM) and energy-dispersive x-ray analysis (EDX). SEM images and EDX spectra were obtained with a JSM-5910 microscope (JEOL) equipped with a Rontec EDX system. Following electrodeposition, catalyst samples were rinsed gently with deionized water and allowed to dry in air before loading into the instrument. Images were obtained with an acceleration voltage of 4-5 kV and EDX spectra were obtained with acceleration voltages between about 12 kV and about 20 kV.

NMR analysis of catalyst film. NMR spectra were obtained using a Varian Mercury 300 or Varian Inova 500 NMR spectrometer. The catalytic material to (approximately 2-3 mg) was dissolved in approximately 200 uL of 1 M HCl to yield a pale green solution. The pH was raised with the addition of about 200 uL of about 2M imidazole and about 40 mg of ethylenediaminetetraacetic acid was added to chelate the Co ions. A ³¹P NMR spectrum was then obtained using a 10 second acquisition delay time to allow for more accurate integration. Phosphate (4.26 ppm) and methylphosphonate (23.26 ppm) in a ratio of approximately 3:1 are the only major species observed. The identity of each was verified by introduction of authentic phosphate and methylphosphonate to the NMR tube after the experiment.

NMR analysis of electrolysis solution. NMR spectra were obtained using a Varian Mercury 300 or Varian Inova 500 NMR spectrometer. In situ catalyst formation and prolonged electrolysis was conducted in a small two-compartment electrochemical cell containing about 5 mL of approximately 0.1 M MePi buffer, about pH 8.0, about 1 mM Co²⁺ on the working side and about 4 mL of MePi buffer without Co²⁺ on the auxiliary side. Electrolysis was initiated at 1.3 V without iR compensation and allowed to proceed with stirring until about 86.7 C (approximately 1.80 equiv. electrons with respect to methylphosphonate in the working compartment; approximately 180 equiv.

with respect to Co²⁺ in the working compartment) had been passed through the solution (about 22 h). A ³¹P NMR and ¹H NMR spectrum of the electrolysis solution taken directly from each compartment was then obtained. The ³¹P resonance of the starting buffer was 21.76 ppm (referenced externally to 85% H₃PO₄) and its ¹H resonance was 1.05 ppm (J_{H-P}=15.5 Hz) (referenced to TMS using the H₂O peak (4.80 ppm)). The ³¹P NMR spectrum of the solution from the working side was shifted downfield to 24.86 ppm and its ¹H resonance was shifted downfield 1.22 ppm (J_{H-P}=16.5 Hz), reflecting a drop in pH over the course of the electrolysis to 6.3. The ³¹P NMR spectrum of the auxiliary side was shifted upfield to 21.07 ppm and its ¹H resonance was shifted upfield to 1.00 ppm (J_{H-P}=16.5 Hz) reflecting a pH increase to 11.9.

Mass Spectrometry. See, for example, the experimental procedure described in Example 9. In some cases, the mass spectrometer was operated in selective ion mode that monitored for 28 (N₂), 32 (^{16,16}O₂), 34 (^{18,16}O₂), 36 (^{18,18}O₂), 35 (Cl₂ fragment) and 44 (CO₂) amu ions. The background 34, 36, and 44 ion signals were stable at 80, 50 and 400 respectively prior to electrolysis and these values were used as the 34, 36, and 44 ion background for all points. The 35 ion signal was monitored to determine if any Cl₂ was produced during electrolysis via oxidation of adventitious Cl⁻ from the reference to electrode. This signal remained at a baseline level throughout the experiment.

Electrolysis was allowed to proceed for about 1 h at approximately 1.29 V without iR compensation. The percent abundance of each isotope over the course of the experiment where the average observed abundance ±2σ was as expected and the statistical abundances were 65.8%, 30.6%, and 3.6%.

Determination of Faradaic efficiency. See, for example, the experimental procedure described in Example 10. The catalyst used as the working electrode was prepared in an electrodeposition that passed 7 C/cm² (for MePi study) and 10 C/cm² (for NaCl studies). The reference electrode was positioned several cm from the surface of the catalyst. For determination of Faradaic efficiency in the MePi buffer, electrolysis with O₂ sensing was continued for about 8.0 h (approximately 57 C passed). Upon terminating the electrolysis, the O₂ signal reached a plateau over the course of the next 3 h. During this time the O₂ level had risen from about 0% to about 6.25%. At the conclusion of the experiment, the volume of the solution (about 48.5 mL) and the volume of the headspace (about 54.2 mL) in the working compartment were measured. The total charge passed in the electrolysis was divided by 4F to get a theoretical O₂ yield of 147.66 umol. The measured partial pressure of O₂ was corrected for dissolved O₂ in solution using Henry's Law and converted, using the ideal gas law, into a measured O₂ yield of 145.4 umol (98.5%).

For determination of Faradaic efficiency in the presence of NaCl, electrolysis with O₂ sensing was continued at about 1.3 V for about 15.1 h (approximately 35 C passed). Upon terminating the electrolysis, the O₂ signal reached a plateau over the course of the next hour. During this time, the O₂ level had risen from about 0% to about 5.39%. At the conclusion of the experiment, the volume of the solution (about 61.5 mL) and the volume of the headspace (about 40.0 mL) in the working compartment were measured. The total charge passed was divided by 4F to produce a theoretical O₂ trace and the measured partial pressure of O₂ was corrected for dissolved O₂ in solution using Henry's law and converted, using the ideal gas law, into an observed O₂ trace. The above procedure was repeated at an applied potential of approximately 1.66 V for about 1.9 h (approximately 50 C passed) in a separate experiment. The O₂ level rose from about 0% to about 2.13% over the course of the experiment. The solution volume (about 57.0 mL) and headspace volume (about 49.0 mL) were measure. The observed O₂ trace is at a significant deficit to the theoretical O₂ trace indicating a diminished Faradaic efficiency.

N,N-diethyl-p-phenylenediamine (DPD) Titrimetry. Upon conclusion of about 16 hours of controlled potential electrolysis at approximately 1.30 V in about 0.1 M KPi buffer, about pH 7.0, about 0.5 M NaCl, about 10 mL of solution from the working compartment (about 40 mL total volume) was diluted 10-fold with reagent grade water. The solution was combined with approximately 5 mL of phosphate buffer solution, approximately 5 mL of DPD indicators solution, and about 1 g of NaI as described in the literature, see, for example, Eaton et al., Standard Methods for the Examination of Water and Wastewater, 21^{th} ed.; American Public Health Association, American Water Works Association, Water Pollution Control Federation: Washington, D.C., 2005; Chapter 4. A pink color rapidly formed. Titration with approximately 1.65 mL of standard ferrous ammonium sulfate solution led to complete loss of color. The molar amount of oxidized chloride species was calculated as described in the literature. The same experiment conducted on about 10 mL of solution from the auxiliary compartment failed to detect any oxidized chloride species.

### Example 13

The following example describes the formation of a catalytic material, wherein the metal ionic species comprises cobalt and the anionic species comprises methylphosphonate.

Cyclic voltammetry on a glassy carbon electrode of an aqueous solution of approximately 1 mM Co²⁺ and approximately 0.1 M Na methylphosphonate (MePi) buffer (about pH 8.0) exhibited a sharp anodic wave at E_{p,a}=0.99 V vs. NHE on the initial scan. This anodic wave is followed by the onset of a large catalytic wave at 1.15 V. The return scan produced a broad cathodic wave at 0.80 V. In some cases, the features were broadened and enhanced on subsequent scans which may suggest adsorption. An electrode was placed in a Co²⁺/MePi solution and the potential was scanned through the anodic wave and then switched prior to the catalytic wave. The electrode was removed from the Co²⁺/MePi solution and placed in a solution of only MePi. A quasi-reversible couple was observed at about 0.85 V prior to the 1.15 V onset potential of the catalytic wave. Without wishing to be bound by theory, the quasi-reversible wave may arise from the Co^{3+/2+} couple. The observed potential for this couple was well below that of Co(OH₂)₆^{3+/2+} (1.86 V) but was in accord with the 1.1 V potential estimated for the Co(OH)²⁺/Co(OH)₂ couple. Polishing the electrode restored a clean background indicating that, in this case, the electrodeposition of a catalytically active species followed oxidation of Co²⁺ to Co³⁺.

The morphology of the catalytic film was investigated by performing bulk electrolysis of MePi solutions containing about 1 mM Co²⁺. Controlled potential electrolysis at about 1.29 V using a 1.5 cm² ITO working electrode resulted in the current approaching an asymptotic limit of 1.5 mA/cm² after about 2 hours. During application of the potential, a dark green film formed on the surface of the ITO electrode. Electrodeposition of the film was accompanied throughout by vigorous effervescence of O₂ (vide infra). The morphology of the film was analyzed by scanning electron microscopy. Early in the course of electrolysis a relatively uniform film was observed with a thickness of approximately 1 um upon passage of about 6 C/cm². Prolonged electrolysis (approximately 40 C/cm² passed) produced a film approximately 3 um thick with the concomitant formation of spherical nodules of about 1 to about 5 um in diameter on the surface of the film.

The chemical composition of the catalytic material (e.g., catalyst) was analyzed by two techniques as described in Example 12. Elemental analysis of the film gave about a 4.6:1 ratio of cobalt to phosphorus. Similar ratios (4-6:1) were observed for depositions carried out with about 10 mM Co²⁺ in MePi buffer at about pH 8.0 and about pH 7.0 (Table 1). These ratios were corroborated by EDX analysis of films that ranged in thickness from approximately 100 nm to greater than about 3 um as well as for those prepared using Co²⁺ concentrations ranging from about 0.1 mM to about 10 mM. In this example, a Co:P ratio of between 4 and 6:1 was observed. In some cases, the methylphosphonate may be partially degraded within the film, but the MePi buffer may remain intact under prolonged electrolysis. As described in Example 12, NMR analysis of the electrolysis solution revealed no other major signals are observed in the NMR of either the working or auxiliary compartment indicating that the buffer, in this case, did not degrade appreciably over the electrolysis times.

Two complementary techniques established the authenticity of water oxidation catalysis, as described in Example 12. The amount of O₂ produced (145 umol) accounted for about 98% of the current passed (about 57 C; about 148 umol) in the experiment, as determined by fluorescence based O₂ sending. Mass spectroscopy analysis (as described in Example 12) showed that the observed isotopic ratio of 66.0:30.4:3.6=^{16,16}O₂:^{18,16}O₂:^{18,18}O₂ was in good agreement with the predicted statistical to ratio of 65.8:30.6:3.6=^{16,16}O₂:^{18,16}O₂:^{18,18}O₂ indicating that water was the source of the O-atoms in the evolved O₂.

The log of current density was measured versus potential to assess catalyst activity. At about pH 8.0 in MePi buffer, the Tafel plot exhibited a slight negative curvature, which may be due to uncompensated iR drop or local pH gradients that develop at large current densities. Similar to the phosphate system, the current-pH profile in MePi buffer exhibits a plateau beyond about pH 8.5.

### Example 14

The following provides non-limiting examples of how the electrolysis of Co²⁺ in phosphate (Pi), methylphosphonate (MePi) and borate (Bi) electrolytes affected the electrodeposition of an amorphous highly-active water oxidation catalyst as a thin-film on a current collector. Specific experiment and synthetic procedures are described in more detail in Example 15.

Cyclic Voltammetry. See, for example, the experimental procedure described in Example 12. The electrolyte may comprise 0.1 M potassium phosphate electrolyte at pH 7.0 (Pi), 0.1 M sodium methylphosphonate electrolyte at pH 8.0 (MePi), and 0.1 M potassium borate electrolyte at pH 9.2 (Bi).

In Bi electrolyte, the anodic wave was observed at E_{p,a}=0.77 V and was well separated from the catalytic wave at 1.10 V. A catalytic current of 100 uA (microamps) was observed at 1.34, 1.27, and 1.20 V for Pi, MePi, and Bi electrolytes, respectively. The 70 mV shift between MePi and Bi reflected the 72 mV shift in the thermodynamic potential for water oxidation between pH 8.0 and 9.2. A broad cathodic wave at E_{p,c}=0.93, 0.81, and 0.55 was observed in Pi, MePi, and Bi, respectively; for the latter electrolyte, the cathodic wave was also followed by a broad cathodic shoulder. On subsequent scans, the sharp anodic pre-feature of all electrolyte solutions was replaced by a broad anodic wave that grows upon repetitive scanning suggesting adsorption of an electroactive species.

Film Preparation and Characterization. To investigate the nature of the catalytic wave, controlled potential electrolysis was performed at 1.3 V in a conventional two compartment cell. In each case, the working compartment was charged with either a 1 mM Co²⁺ solution in MePi electrolyte, or a 0.5 mM Co²⁺ solution in Bi electrolyte, whereas the auxiliary compartment was charged with pure electrolyte. ITO coated glass slides were used as current collectors in each case. In MePi, the current density reached an asymptotic limit of 1.5 mA/cm² over the course of 2 hours. In Bi, the current density reached an asymptotic limit of 2.3 mA/cm² over the course of 10 minutes. In both cases, the rise in current was accompanied by the formation of a dark green film on the ITO current collector and O₂ effervescence (vide infra).

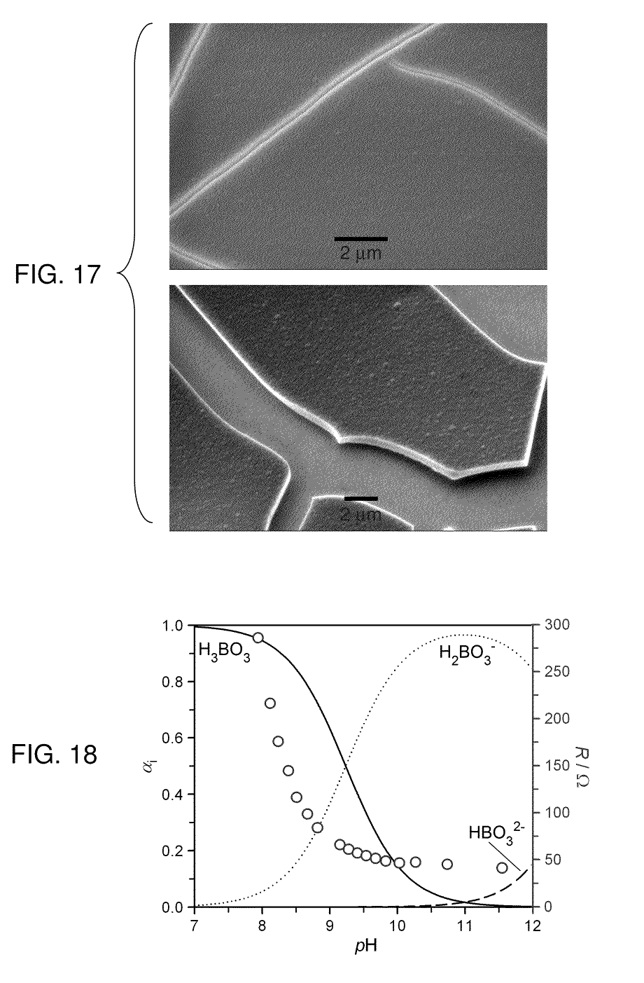

The morphology of films from Pi, MePi and Bi electrolytes (Co-Pi, Co-MePi and Co—Bi, respectively) was analyzed by scanning electron microscopy. FIG. 17 shows SEM images of film grown from MePi electrolyte upon passing 2 C/cm² (top) and 6 C/cm² (bottom).

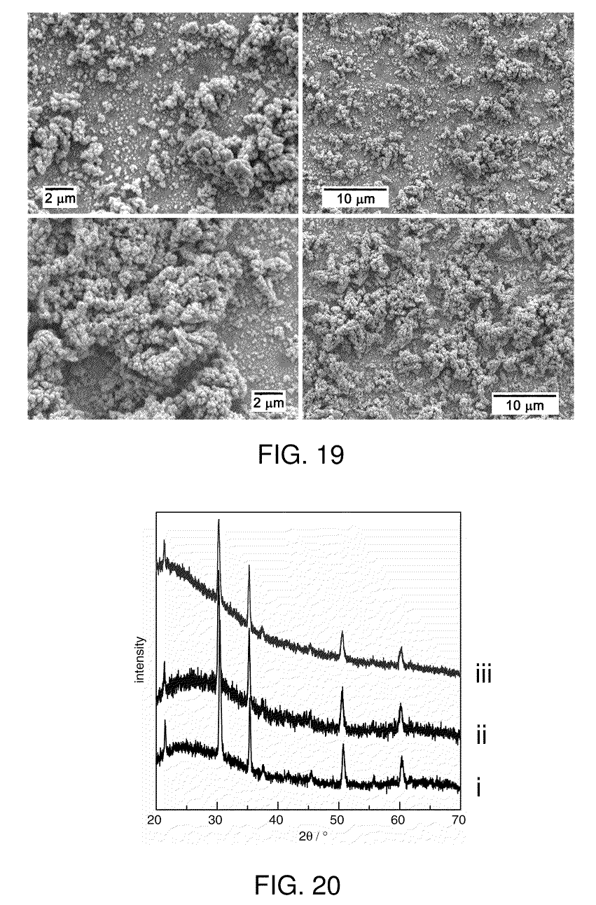

Prolonged electrolysis (passage of 40 C/cm²) produces a film ˜3 um thick with the concomitant formation of spherical nodules of 1 to 5 um in diameter on the surface of the film. These morphological features are similar to those of films deposited from Pi electrolyte. Depositions from Bi electrolyte under quiescent conditions lead to a rapid decrease of current arising from local pH gradients and associated resistive losses due to the formation of neutral H₃BO₃ species. FIG. 18 shows the dependence of solution resistance (R) with pH for a H₃BO₃/KH₂BO₃ electrolyte (circles) overlaid on top of the speciation diagram for H₃BO₃ as a function of pH (lines). Increase of [H₃BO₃] with decreasing pH coincides with an exponential increase in R. As such, bulk electrolyses in Bi electrolyte were conducted with stirring, whereupon stable currents were observed for hours. Unlike Co-Pi or Co-MePi, Co—Bi displays a somewhat different surface morphology. Spherical nodules appeared early in the course of deposition (upon passage of 2 C/cm²) and merged into larger aggregates upon prolonged electrolysis. FIG. 19 shows SEM images of film grown from Bi electrolyte upon passing 2 C/cm² (top) and 6 C/cm² (bottom). SEM images of Co—Bi films grown from quiescent solutions also reveal similar morphological features.

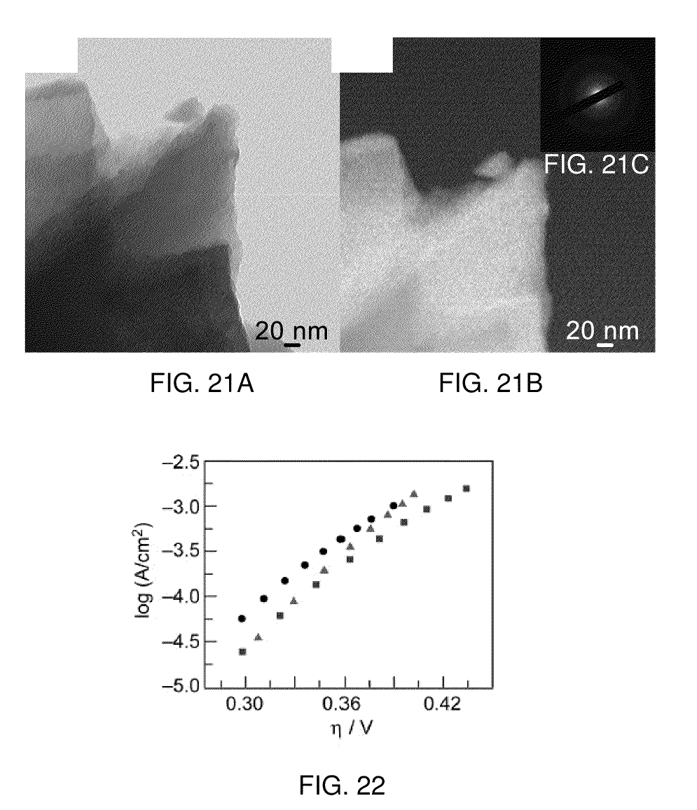

Powder x-ray diffraction patterns of Co-MePi and Co—Bi exhibited broad amorphous features and no detectable crystallites besides those corresponding to the ITO substrate. FIG. 20 shows the powder X-ray diffraction patterns of blank catalyst deposited from (i) Pi, (ii) MePi, and (iii) Bi. ITO crystallites account for the observed diffraction peaks. In line with this observation, transmission electron microscopy did not reveal crystalline domains nor are electron diffraction spots observed on a length scale of 5 nm. FIGS. 21A and 21B show bright field and dark-field TEM images, respectively, of the edge of a small particle detached from a Co-Pi film. FIG. 21C shows an electron diffraction image with no diffraction spots, indicating the amorphous nature of the catalyst. The chemical compositions of the films were determined by elemental analysis and energy dispersive x-ray analysis (EDX). The mole ratios of the species present in the film for all deposition conditions attempted are shown in Table 2.

TABLE 2
Elemental composition of catalyst films.

| Deposition Conditions | Co | P | Na | C | B | K |
|---|---|---|---|---|---|---|
| MePi, pH 8.0, 1 mM Co²⁺ | 4.5 | 1 | 1.2 | 0.6 | | |
| MePi, pH 8.0, 10 mM Co²⁺ | 4.5 | 1 | 0.9 | 0.8 | | |
| MePi, pH 7.0, 10 mM Co²⁺ | 5.6 | 1 | 0.6 | 0.7 | | |
| Bi, pH 9.2, 0.5 mM Co²⁺ | 9.5 | | | | 1 | 1.0 |
| Pi, pH 7.0, 0.5 mM Co²⁺ | 2.7 | 1 | | | | 1.0 |

Water Oxidation Catalysis and Activity. Mass spectrometry establishes that gas effervescence from the electrode is a result of O₂ production from water. See, for example, the experimental procedure described in Example 12. The signals for all three isotopes of O₂ rose from their baseline levels minutes after the onset of electrolysis and then slowly decayed after electrolysis was terminated and O₂ was purged from the head space. The observed isotopic ratio of 66.0:30.4:3.6=^{16,16}O₂:^{18,16}O₂:^{18,18}O₂ is in good agreement with the predicted statistical ratio of 65.8:30.6:3.6=^{16,16}O₂:^{18,16}O₂:^{18,18}O₂. In line with this contention, a ³¹P NMR spectrum of dissolved films of the catalyst showed a phosphate:methylphosphonate ratio of ˜3:1. In some case, oxidation of MePi may occur within the film, as reflected by a P:C ratio of ˜2:1 as determined by microanalysis.

In some embodiments, whereas MePi was partially degraded within the film, NMR of the MePi electrolyte solution did not reveal decomposition of the electrolyte under prolonged electrolysis, as described in Example 14.

The Faradaic efficiencies of the catalysts were determined by fluorescence based O₂ sensing of the evolved gases. In a bulk electrolysis using MePi, the amount of O₂ produced (145 umol) accounted for 98(±5) % of the current passed (57 C; 148 umol). For a Bi electrolyte, the amount of O₂ produced (135 umol) accounted for 104(±5) % of the current passed (50 C; 130 umol).

The log of current versus overpotential relationship (Tafel plot) was used to evaluate the activity of catalysts grown from MePi and Bi electrolytes. FIG. 22 shows the Tafel plots, η=(Vappl−IR−E°), of a catalyst film deposited from and operated in 0.1 M Pi electrolyte, pH 7.0 (), 0.1 M MePi electrolyte, pH 8.0 (▪), and 0.1 M Bi electrolyte, pH 9.2 (▴).

Catalyst Electrodeposition and Activity in Non-buffering Electrolytes. To assess the role of the electrolyte in catalyst formation and activity, in some embodiments, experiments were performed in solutions containing Co²⁺ and electrolytes that are poor proton acceptors (e.g., SO₄²⁻, NO₃⁻, ClO₄⁻) at about neutral pH. CVs of a glassy carbon current collectors in 0.1 M K₂SO₄ at pH 7.0, containing varying concentrations of Co²⁺ were collected. The first and fifth CV scans were taken without pause. The CV traces of 0.5 mM Co²⁺ in the 0.1 M K₂SO₄ solution were indistinguishable from the background scan in the absence of Co²⁺ whereas a slight current enhancement over background was observed at 1.56 V from 5 mM Co²⁺ solutions. At 50 mM Co²⁺, a pronounced anodic wave, with an onset of 1.40 V, was observed. At this concentration, the return scan exhibits a small cathodic wave at E_{p,c}=1.15 V. CVs recorded on Co²⁺ in K₂SO₄ solution exhibit slightly diminished currents on subsequent scans, contrasting those recorded in Pi electrolyte solution from which pronounced current enhancements are observed upon subsequent scanning. The same behavior was observed when 0.1 M NaClO₄, pH 7.0, was substituted for K₂SO₄ as the electrolyte. Without wishing to be bound by theory, in electrolytes that are poor proton acceptors at a selected pH, catalyst formation was not apparent for Co²⁺ ion at modest concentrations. Co-based films electrodeposited from unbuffered electrolyte (SO₄²⁻, NO₃⁻, ClO₄⁻) solutions containing high concentrations of Co²⁺ ion (Co—X films). A film formed on a nickel foil substrate upon controlled current electrolysis (iₐ=8 mA/cm²) of 500 mM Co(SO₄) in reagent grade water in a three electrode single compartment cell. Upon conclusion of electrolysis, the working electrode was placed in fresh electrolyte solution (0.1 M K₂SO₄, pH 7.0) containing no Co²⁺. Electrolysis was initiated with stirring for 1 hr at 1.3 V vs. NHE using the standard two compartment cell separated by a glass frit (as used for all previously described experiments). The current density traces at 1.3 V of a catalyst film operated in 0.1 M Pi electrolyte, pH 7.0 plateau at about 1.0 mA/cm² and in 0.1 M K₂SO₄, pH 7.0 was about 0.07 mA/cm².

The current rapidly declined to 70 uA/cm² after one minute and continues to diminish over the course of electrolysis to 36 uA/cm² after 1 hour. For side-by-side comparison, a catalyst film was prepared on a nickel foil substrate by controlled potential electrolysis (1.40 V) of a 0.5 mM Co²⁺ in Pi electrolyte solution. Upon conclusion of electrolysis, the electrode was placed in fresh Pi electrolyte solution containing no Co²⁺. Electrolysis was initiated for 1 hr at 1.3 V vs. NHE and the same electrode geometry and stir rate was used as chosen for electrolysis in unbuffered solution. Unlike Co—X systems, the current of the Co-Pi system remained stable at ˜1 mA/cm² over the entire course of the electrolysis.

In some embodiments, electrolytes that posses poor buffering capacity lead to diminished activity (vide supra) and to large pH gradients across a two-compartment cell. Without wishing to be bound by theory, this obstacle may be overcome by utilizing a single compartment configuration for water oxidation. To assess the Faradaic efficiency of a single compartment setup, a Co—X film prepared from 500 mM CoSO₄ solutions as described above was electrolyzed using a three electrode configuration in a single compartment cell containing 0.1 M K₂SO₄ at pH 7.0. Evolved O₂ was detected by direct fluorescence-based sensing. Throughout the course of electrolysis, the amount of O₂ evolved was significantly attenuated relative to the amount of O₂ expected on the basis of 100% Faradaic efficiency (e.g., about 40 umol of O₂ had been produced after about 5 hours of electrolysis (expected approximately 100 umol and about 70 umol O₂ had been produced after about 10 hours of electrolysis).

Water Oxidation from Salt Water. In some cases, catalyst function did not require pure water. Controlled potential electrolysis of a Co-Pi film at 1.3 V in Pi electrolyte containing 0.5 M NaCl revealed sustained current densities greater than 0.9 mA/cm². These current densities were comparable to those observed in the absence of NaCl, suggesting that chloride anions does not inhibit O₂ evolving catalysis (vide infra). EDX analysis of a film used for prolonged (16 h, 76.5 C passed) electrolysis in the presence of 0.5 M NaCl revealed that Co and P are retained in a ratio similar to that of the parent film. In addition, EDX analysis also indicated significant incorporation of Na⁺ ion, but only minimal incorporation of Cl⁻ (Na:Cl=˜6:1), suggesting significant exchange of Na⁺ ion for K⁺ ion. Noting the stability of the film in chloride-containing electrolyte, the Faradaic efficiency of water oxidation was quantified in this medium using fluorescence-based sensing of evolved O₂. The amount of oxygen produced at 1.30 V vs. that expected for O₂ production with 100% Faradaic efficiency. The observed O₂ signal rose shortly after initiation of electrolysis as oxygen saturated the solution and filled the headspace, and hence the offset. The observed O₂ signal rose throughout the electrolysis (15 h) and leveled off upon termination of electrolysis at a value in accordance with the net current passed in the experiment (35.3 C, 91.4 umol O₂). These to results showed that water oxidation to O₂ predominates (100±5%) from salt solutions. This property of the system was further corroborated by direct quantification of oxidized chloride species (HOCl and OCl⁻). A Co-Pi film was operated in the presence of 0.5 M NaCl for 16 h (76.5 C passed) at 1.30 V and then the solution was analyzed for hypochlorite using a standard N,N-diethyl-p-phenylenediamine titrimetric assay. 9.3 umol of oxidized chloride species was observed, which accounts for 1.80 C or 2.4% of the total current passed in the experiment. To exclude the possibility of Cl₂ production in this medium, the evolved gases were analyzed in real time by an in-line mass spectrometer. The only gas detected was O₂ and no isotopes of Cl₂ rose above the baseline level during the course of the experiment (6 h).

Discussion. In some embodiments, the electrolyte may be a crucial determinant in the formation, activity and selectivity of self-assembled cobalt-based electrocatalysts for water oxidation. For example, in some cases, in the absence of suitable electrolytes, the generation of oxygen at appreciable activities from neutral water under ambient conditions cannot be achieved.

Large catalytic waves for water oxidation were observed from CVs of low concentrations of Co²⁺ (0.5 mM Co²⁺) in solutions of Pi, MePi or Bi electrolytes. Prior to the onset of catalytic current, an anodic wave was observed in the CV that was consistent with a Co^{3+/2+} couple. The observed potential for this couple was well below that of Co(OH₂)₆^{3+/2+} (1.86 V) but is similar to the 1.1 V potential estimated for the Co(OH)₂^{+/0} couple. The catalytic wave was preserved upon the placement of the once anodically scanned electrode in a fresh electrolyte solution containing no Co²⁺ cation. Polishing the electrode restored a clean background in the CV indicating that a catalytically competent species electrodeposits immediately following oxidation of Co²⁺ to Co³⁺ at modest potentials. This behavior was in sharp contrast to CV traces obtained from Co²⁺ in electrolytes of poor proton-accepting abilities. In electrolytes such as SO₄²⁻ and ClO₄⁻, at neutral pH, no electrochemical features of significance were observed above background for solutions containing 0.5 mM Co²⁺. Only when the Co²⁺ ion concentration was increased by 2 orders of magnitude was a slight enhancement in current observed near the solvent window at 1.56 V. This current enhancement was anodically shifted >150 mV relative to the corresponding wave in Pi at drastically lower Co²⁺ concentration. The electrolyte promoted catalyst formation; in the absence of an effective proton acceptor, at a given pH, the formation of a catalyst film was significantly to inhibited.

Whereas an active catalyst may be generated on an anodic single scan, films of desired thickness may be prepared on conducting electrodes (metal or semiconductor) by controlled potential electrolysis of 0.5 mM Co²⁺ solutions of Pi, MePi and Bi. In most cases, the anionic species composition was balanced by a monovalent cation, regardless of the Co to anionic species ratio. The disparate anionic species incorporation into the bulk material was not reflected in altered activity, suggesting that a common Co-oxide unit effects catalysis in all films. The active unit is <5 nm in dimension as evidenced by the absence of crystalline features in the power X-ray diffraction pattern and diffraction patterns in the TEM. Without wishing to be bound by theory, this is in contrast to the structural properties of Co—X materials, which are asserted to exhibit long range ordering corresponding to CoOₓ crystallites.

The ability of the electrolyte to maintain the pH during water oxidation was manifested in a robust and functional catalyst in the presence of 0.5 M NaCl. Direct measurement of Faradaic efficiency and titrimetry of chloride oxidation products establishes that Co-Pi was able to produce oxygen from salt water at current efficiencies commensurate with those observed for pure water. With decreasing pH, the oxidation of Cl⁻ becomes more thermodynamically competitive with water oxidation. As such, in the absence of proton-accepting electrolytes (such as Co—X), chloride oxidation may interfere with water oxidation. The ability of the Pi electrolyte to preserve the pH of the solution allows O₂ production to out-compete Cl⁻ oxidation.

### Example 15

The following example outlines the materials and experimental set-up and data relating to Example 14.

Materials. See, for example, the materials described in Example 4.

Electrochemical Methods. See, for example, the experimental procedure described in Example 12. The electrolyte may either be MePi or Bi.

Cyclic Voltammetry. See, for example, the experimental procedure described in Example 12. The electrolyte may either be MePi or Bi.

Bulk Electrolysis and in situ Catalyst Formation. See, for example, the experimental procedure described in Example 12. The electrolyte may either be MePi or Bi.

Measurement of the Solution Resistance Dependence on pH in Bi Electrolyte. Quiescent solutions of Co²⁺ in Bi exhibit sudden and significant current drop during bulk electrolysis. As explained Example 14, this was attributed to the formation of neutral H₃BO₃ upon release of protons due water oxidation. To determine the iR drop as a function of pH in Bi, a two-compartment electrolytic cell was charged with fresh 0.1 M solutions of H₃BO₃ to which KOH had been added such that the pH of the solution was adjusted to ˜7.9. An ITO-coated glass plate was used as a current collector and was immersed in the solution such that an area of ˜1 cm² was in contact with the electrolyte. An Ag/AgCl reference electrode was placed at 2-3 mm from the working ITO current collector in a configuration mimicking that used for film growth and Tafel data acquisition. A Pt mesh electrode was used as an auxiliary electrode. The iR test function was used to determine the solution resistance at the initial pH of 7.9 under this configuration. Subsequently, aliquots of concentrated base KOH solution (25-50 uL) were added to each half-cell, and the pH and resistance of the resulting electrolyte solution were measured after each aliquot addition. A plot depicting solution resistance as a function of pH for a Bi electrolyte around the pKₐ of the H₃BO₃/H₂BO₃ couple (pKₐ=9.23) is shown in FIG. 18. The speciation diagram for H₃BO₃ as a function of pH is also presented in FIG. 18.

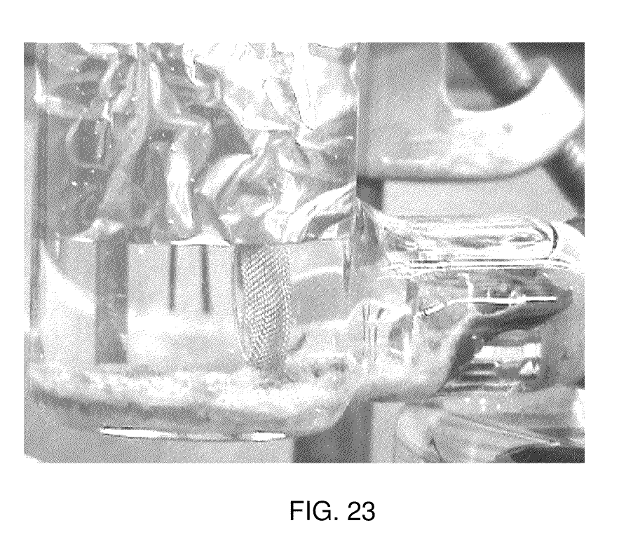

Activity in Poor Proton-Accepting Electrolytes. The anodes coated with the Co-X were prepared using a Ni foil substrate in a controlled current electrolysis at 8 mA/cm² for 300 seconds. Depositions were performed from 0.5 M CoSO₄ solutions using a single compartment, three current collector setup equipped with a Ni foil auxiliary electrode. A two compartment configuration was deemed unsuitable because of dramatic precipitation of Co²⁺ species in the auxiliary chamber over the course of electrolysis. FIG. 23 shows a photograph of auxiliary chamber of a two compartment cell after prolonged electrolysis (8 h) starting with 0.5 M Co(SO₄) in the working chamber and 0.1 M K₂SO₄, pH 7.0, in the auxiliary chamber. Significant precipitation of Co²⁺ that leeched into the auxiliary chamber is observed. Ni foil was chosen as the current collector because the Co catalytic material exhibited more robust adhesion to Ni over ITO, in some embodiments. For the side-by-side comparison with a proton-accepting electrolyte, the amorphous catalyst film was also deposited on a Ni foil substrate from Pi electrolyte, pH 7.0, containing 0.5 mM Co²⁺. In this case, electrolysis was operated in a conventional two compartment cell. Electrodeposition at 1.40 V was carried out until 2 C/cm² was passed. Upon conclusion of the deposition of the amorphous phosphate-grown catalyst and the patented Co catalytic material, each electrode was rinsed with water and placed into the working compartment of a two compartment electrolysis cell containing Pi electrolyte, pH 7.0 or 0.1 M K₂SO₄ (for Co—X), pH 7.0. Electrolysis at 1.30 V was initiated with stirring and without IR compensation.

Tafel Plot Data Collection. See, for example, the experimental procedure described in Example 12. The electrolyte may either be MePi or Bi.

Elemental Analyses. See, for example, the experimental procedure described in Example 12. The electrolyte may either be MePi or Bi.

Scanning Electron Microscopy (SEM) and Energy-dispersive X-ray analysis (EDX). See, for example, the experimental procedure described in Example 12. The electrolyte may either be MePi or Bi.

Powder X-ray Diffraction and Transmission Electron Microscopy. Powder X-ray diffraction patterns for films grown in Pi and MePi were obtained with a Rigaku RU300 rotating anode X-ray diffractometer (185 mm) using Cu Kα radiation (λ=1.5405 Å). Powder X-ray diffraction data for a film grown in Bi was collected on a PANalytical X′Pert Pro diffractometer using Cu Kα radiation (λ=1.5405 Å) (FIG. 20). The features present in the powder diffraction pattern corresponded to crystallites found in the ITO substrate. No non-ITO peaks were observed for catalysts prepared from either MePi or Bi indicating that the electrodeposited films are amorphous. TEM images were collected on a JEOL 200CX General Purpose instrument by depositing dry Co-Pi material on a carbon grid and Cu support (FIG. 21). No crystalline domains and diffraction peaks in the electron diffraction pattern were observed. The length scale for detection was 5 nm.

NMR Analysis of Catalyst Films. See, for example, the experimental procedure described in Example 12. The electrolyte may either be MePi or Bi. NMR Analysis of Electrolyzed Solution. See, for example, the experimental procedure described in Example 12. The electrolyte may either be MePi or Bi. Mass Spectrometry. See, for example, the experimental procedure described in Example 12. The electrolyte may either be MePi or Bi. A similar experiment was used to detect Cl₂ emanating from a 0.5M NaCl solution (Pi electrolyte, pH 7.0) upon electrolysis at 1.30 V. The mass spectrometer was operated in selective ion mode with detection of 28 (N₂), 32 (O₂), 35 (Cl₂ fragment), 37 (Cl₂ fragment), 70, 72, and 74 (Cl₂ isotopes). Determination of Faradaic Efficiency. See, for example, the experimental procedure described in Example 12. The electrolyte may either be MePi or Bi. For determination of Faradaic efficiency in the Bi, electrolysis with O₂ sensing was continued until 50 C passed. Upon terminating the electrolysis, the O₂ signal reached a plateau over the course of the next 3 h. During this time the O₂ level had risen from 0% to 7.46%. At the conclusion of the experiment, the volume of the solution (65.0 mL) and the volume of the headspace (42.0 mL) in the working compartment were measured. The total charge passed in the electrolysis was divided by 4F to get a theoretical O₂ yield of 129.6 umol. The measured partial pressure of O₂ was corrected for dissolved O₂ in solution using Henry's Law and converted, using the ideal gas law, into a measured O₂ yield of 135.0 umol (104.2%).

For determination of Faradaic efficiency from a single compartment electrolysis, an electrode was prepared from 0.5 M CoSO₄ using a Ni foil substrate in a controlled current electrolysis at 6 mA/cm². A single compartment, three current collector setup equipped with a Ni foil auxiliary electrode was used for the deposition. Upon conclusion of the deposition, the electrode was rinsed and placed in the gas-tight cell for Faradaic efficiency measurement. All three electrodes, working, Pt auxiliary, and Ag/AgCl reference were contained in a single compartment. Electrolysis was continued for 20,000 sec at a constant current of 3 mA with stirring. Upon terminating the electrolysis, the O₂ signal reached a plateau over the course of the next 3 hours. During this time, the O₂ level had risen from 0% to 3.33%. At the conclusion of the experiment, the volume of the solution (60.0 mL) and the volume of the headspace (48.5 mL) in the working compartment were measured. The total charge passed was divided by 4F to produce a theoretical O₂ trace and the measured partial pressure of O₂ was corrected for dissolved O₂ in solution using Henry's law and converted, using the ideal gas law, into an observed O₂ trace.

N,N-Diethyl-p-phenylenediamine (DPD) Titrimetry. See, for example, the experimental procedure described in Example 12. The electrolyte may either be MePi or Bi.

### Example 16

The following describes the formation of an electrode according to one embodiment using a nickel foam current collector. The results disclosed herein demonstrate that the electrode, of this example, is capability of achieve current densities comparable to that output by conventional photovoltaic technology (˜10 mA/cm²)

A similar method was used as described in previous examples. Electrolysis of to Co(II) salts in phosphate-buffered aqueous solutions at pH 7.0 led to the electrodeposition of Co-containing thin films. The deposition was carried out with equal facility using a Ni-foam current collector (Marketech International Inc.). The highly macro-porous Ni-foam current collector provides a highly conductive substrate for electrodeposition while maximizing the exposed surface area per apparent or geometric cm². For example, electrolysis of 0.5 mM Co(NO₃)₂ in 0.1 M potassium phosphate, pH 7.0, at 1.3 V vs. NHE was accompanied by continuous bubbling and the formation of a dark green coating on a foam current collector. After an electrolysis in the presence of Co(NO₃)₂, the electrode may be placed in fresh Co-free phosphate buffer and maintains 10 mA/cm² current density at potentials ranging from 1.3-1.35 V vs. NHE.

### Example 17

The following gives an example of the formation of an electrode according to a non-limiting embodiment, in a carbonate buffer.

Bulk electrolysis was conducted in a 0.5 mM Co(II) solution in a 0.5 M KHCO₃ solution (pH=8.4) at 1.3 V (vs. NHE). After several hours, a dark film formed on the ITO-covered glass current collector and bubble formation, presumably due to O₂ evolution, was apparent. The current density continually increased and peaked at 0.6 mA/cm² after several hours. A scanning electron micrograph of a film deposited under these conditions (0.5 mM Co(II) and 0.5 M KHCO₃) is shown in FIG. 5. The film shows morphological features very similar to those observed for Co catalyst films deposited from phosphate and methyl-phosphonate buffers.

### Example 18

As describe in previous examples, the electrodeposition of cobalt-based oxygen evolving catalyst from phosphate electrolyte and other proton-accepting electrolytes was described. Molecular mechanisms involving O₂/H₂O cycles at cobalt centers suggest the involvement of Co²⁺, Co³⁺ and likely Co⁴⁺ oxidation states during catalysis. As will be known to those of ordinary skill in the art, Co²⁺ is a high spin ion and is substitutionally labile whereas Co³⁺ and higher oxidation states are low spin and substitutionally inert in an oxygen-atom ligand field. As the propensity of metal ion dissolution from solid oxides has been shown to correlate with ligand substitution rates, the cobalt oxygen-evolving catalyst may be structurally unstable during turnover. To probe the catalyst dynamics during water-splitting, the following example describes the electrosynthesis of the catalyst using radioactive ⁵⁷Co and ³²P isotopes. By monitoring these radioactive isotopes during water-splitting catalysis, the following example shows, according to some embodiments, that the catalyst is self-healing and that phosphate is responsible for repair.

The cobalt-phosphate water oxidation catalyst (Co-Pi) forms in situ upon the application of a potential of 1.3 V vs. NHE to an ITO or FTO current collector immersed in a 0.1 M phosphate (pH=7.0) electrolyte (Pi) containing 0.5 mM Co²⁺, as described in previous examples. At this potential, Co²⁺ was oxidized to Co³⁺ and an amorphous catalyst deposited on the current collector that incorporated phosphate as a major constituent.

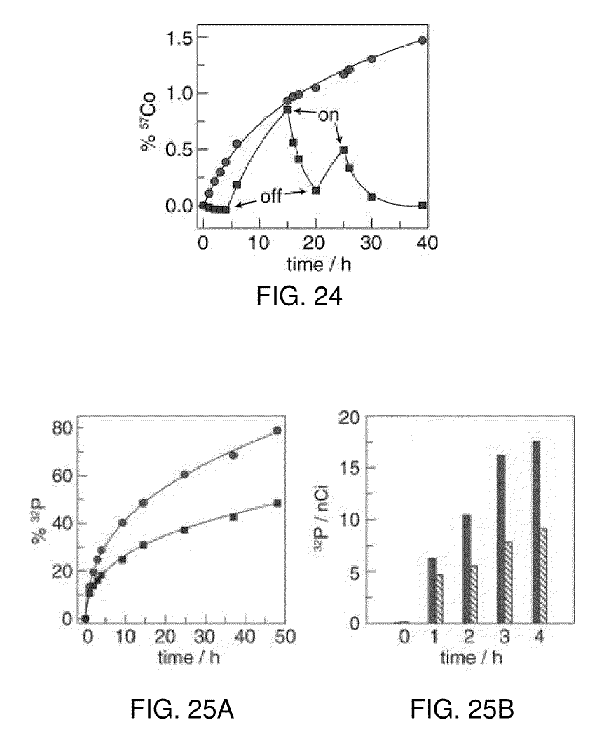

For the studies described here, a Pi solution containing 0.5 mM Co(NO₃)₂ was enriched with 10 mCi of ⁵⁷Co(NO₃)₂. Details of the sample preparation and handling are provided in the Example 19. After deposition, the catalyst films were washed with Pi to remove adventitious ⁵⁷Co²⁺ ion (see Example 19). Two separate electrodes coated with the catalyst were placed in the working compartment of two different electrochemical H-cells containing Co-free Pi electrolyte. A potential of 1.3 V vs. NHE was applied to one electrode and no potential bias was applied to the other; the catalyst was active on the biased electrode, and water-oxidation catalysis proceeded as previously described. Aliquots of the electrolyte were removed from the H-cell at different time points and the radioactivity was quantified for each aliquot at the conclusion of the experiment. The total available ⁵⁷Co was determined at the conclusion of the experiment by acidifying the electrolyte with concentrated HCl to dissolve the catalyst completely (see Example 19). FIG. 24 plots the amount of ⁵⁷Co that leached from the catalyst film as a percentage of the total available ⁵⁷Co. More specifically, FIG. 24 shows the percentage of ⁵⁷Co leached from films of the Co-Pi catalyst on an electrode: with a potential bias of 1.3 V vs. NHE (▪) turned on and off at the times designated; and without an applied potential bias (). Lines were added to figure simply as a guide to the eye. Cobalt was continually released from the catalyst film on the unbiased electrode; after 53 hrs, 2.2% of the cobalt ion was detected in solution. Conversely, no cobalt was observed in the electrolyte solution when the electrode was held at 1.3 V vs. NHE. After the potential bias was removed from the electrode at 3 hrs, ⁵⁷Co promptly dissolved from the catalyst. Re-absorption of the cobalt was observed upon the re-application of the potential to the electrode at 18 and 42 h at which time the cobalt ion concentration in solution was ˜1.7 uM and 1.2 uM, respectively.

Cobalt uptake was complete with continuous application of a potential bias; after 10.5 hours, only 0.07% Co²⁺ remains in solution. Without wishing to be bound by theory, the results of FIG. 24 are consistent with (i) the slow liberation of Co²⁺ from the catalyst in the absence of an applied potential and (ii) re-oxidation of the liberated Co²⁺ to re-form the catalyst upon in the presence of the 1.3 V operating potential.

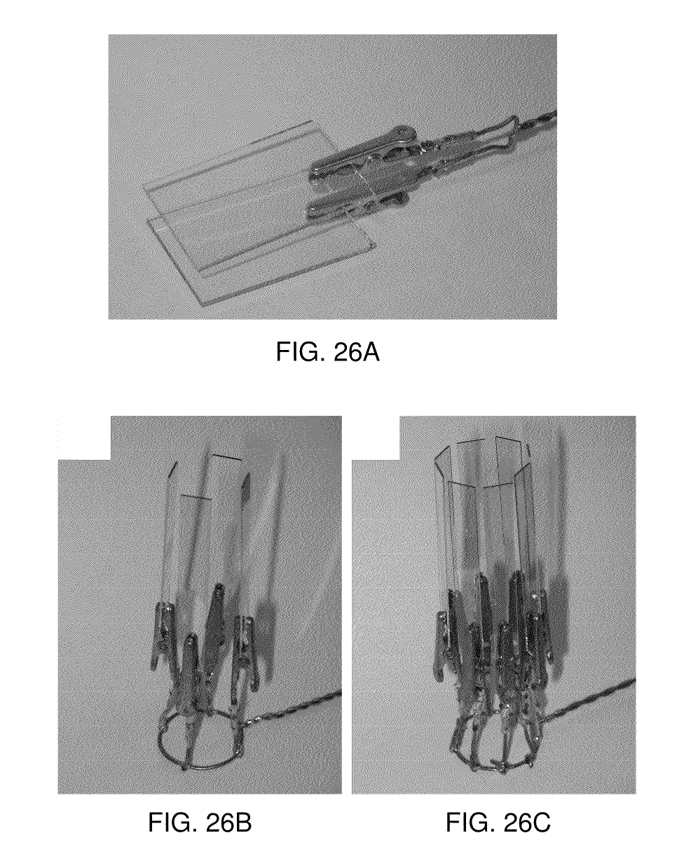

Given the dynamic behavior of cobalt in the catalyst, the other major constituent of the catalyst, phosphate, was monitored by means of a ³²P-phosphate label. Simultaneous electrodepositions of the catalytic material were performed on two current collectors immersed in a Pi solution of 0.5 mM Co(NO₃)₂ that was enriched with 10 mCi of ³²P-orthophosphoric acid. Catalyst films were washed and then placed in two different electrochemical H-cells containing Pi. FIG. 25A shows that ³²P-phosphate leached from a catalyst film with no applied potential at double the rate for a film held at 1.3 V vs. NHE. More specifically, FIG. 25 shows plots monitoring: (A) ³²P leaching from Co-Pi catalyst; and (B) ³²P uptake by the Co-Pi catalyst on an electrode with an applied potential bias of 1.3 V vs. NHE (▪, dashed blocks) and on an unbiased electrode (, solid blocks). The same trend was observed for phosphate incorporation into the catalyst film. Eight ITO current collectors were arranged in a concentric arrangement within the working electrode compartment of the H-cell (see FIG. 26) and the catalyst was electrodeposited from non-isotopically enriched Pi solution. After deposition, the current collectors were separated into two groups of four, and arranged in a concentric array. The two sets of current collectors were immersed in individual H-cells containing Pi electrolyte that was enriched with 1.5 mCi of ³²P-phosphate. One group of current collectors was held against a bias of 1.3 V and the other was left unbiased. Every hour one electrode was removed from each H-cell, washed, and the catalyst was dissolved with concentrated HCl. FIG. 25B plots the total ³²P activity obtained at each time point. Consistent with the results of FIG. 25A, more phosphate exchange was observed for the electrodes under no applied potential bias. Elemental analysis of catalyst films established that the phosphate anionic species composition was balanced by an alkali cation (Na or K). In contrast to the slow exchange of phosphate, >90% exchange of Na for K (or K for Na) was observed after 10 mM of catalyst operation in the alternate electrolyte medium (Table 3 in Example 19). Without wishing to be bound by theory, these data together suggest that the phosphate was coordinated to cobalt since a slower exchange would be expected for Co³⁺, which predominates on the biased electrode. In addition, the much higher exchange of phosphate as compared to cobalt suggests that the metal ion was a constituent of a more robust metal-oxygen framework.

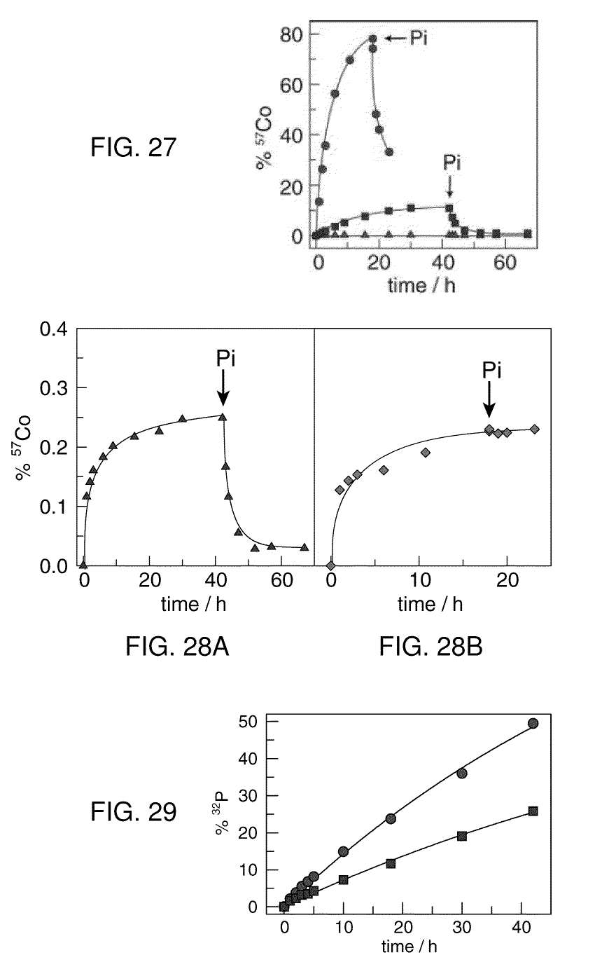

In the absence of proton accepting electrolytes at neutral pH, according to some embodiments, catalyst dissolution was rapid and irreversible. Co-based films (Co—X, e.g., X═SO₄²⁻, NO₃, ClO₄⁻) electrodeposit from unbuffered electrolyte solutions containing high concentrations of Co²⁺ ion. A film was deposited on an ITO electrode from a solution of 25 mM Co(NO₃)₂ containing 2 mCi of ⁵⁷Co(NO₃)₂ in 0.1 M K₂SO₄ (pH=7.0) at a potential bias of 1.65 V. ⁵⁷Co dissolution measurements and assays were performed with a procedure analogous to that employed for FIG. 24 (see Example 19). At the lower potential of 1.3 V vs. NHE, the initial sustained current densities were <0.1 mA/cm². A potential of 1.5 V vs. NHE was applied to Co—X films to achieve current densities (˜1 mA/cm²) comparable to those of Co-Pi operated at 1.3 V. FIG. 27 shows the percentage of ⁵⁷Co leached from Co—X films on an electrode under a potential bias of 1.3 V () and 1.5 V (▪) vs. NHE and an unbiased electrode (▴). Pi was added at the time points indicated by the arrows. The data in FIG. 27 deviates significantly from that in FIG. 24. Whereas an applied potential led to cobalt uptake for Co-Pi, the same applied potential to the Co—X system leads to enhanced cobalt release relative to an unbiased electrode. Moreover, cobalt dissolution increases with increased applied potential. Without wishing to be bound by theory, these results are consistent corrosion of the Co—X system. In the absence of a proton accepting electrolyte, the best proton acceptor was the electrodeposited Co—X film itself. With increased potential, increased production of protons engenders hastened corrosion of these films.

Without wishing to be bound by theory, a repair mechanism was not established in the absence of phosphate or other proton-accepting electrolyte (e.g., borate, methyl-phosphonate) at neutral pH. This contention was demonstrated by adding phosphate to the corroding film of FIG. 27. Addition of KPi electrolyte (1 M, pH=7.0) to attain a final concentration of 0.1 M Pi led to a rapid re-deposition of cobalt into the catalyst film (no precipitation of cobalt was observed, see Example 19).

The results reported here establish that, in some embodiments, phosphate is an important component in the self-healing of the Co-Pi catalyst. Without wishing to be bound by theory, the in situ formation of the catalyst implies a pathway for catalyst self repair. Any Co²⁺ formed in solution during water-splitting catalysis may be re-deposited upon oxidation to Co³⁺ in the presence of phosphate. Moreover, catalyst degradation, in to the absence of an applied bias, may be repaired when the potential is reapplied and phosphate is present in solution. Thus, in some embodiments, phosphate ensures long-term stability of the catalyst system.

### Example 19

The following example outlines the materials and experimental set-up and data relating to Example 18.

Materials. See, for example, the experimental procedure described in Example 12. 10 mCi of ³²P-orthophosphoric acid in 1 mL of 0.02 M HCl (Perkin-Elmer), Opti-Fluor scintillation fluid (Perkin-Elmer) and 0.5 and 10 mCi of ⁵⁷Co(NO₃)₂ in 5 mL of 0.1 M HNO₃ (Eckert & Ziegler Isotope Products) were used as received.

Electrochemical Methods. See, for example, the experimental procedure described in Example 12. Radiochemical Methods. In leaching experiments, all radioactive aliquots were added to 10 mL of Opti-Fluor scintillation fluid and counted on a Tri-Carb 2900TR Liquid Scintillation Analyzer from Packard using the QuantiSmart Version 1.30 software package (Packard). The counting efficiency (ε) for ³²P and ⁵⁷Co was found to be 1.0 and 0.68, respectively, by external calibration. Disintegrations per minute (DPM) were calculated from the counts per minute (CPM) using DPM=CPM/ε. DPM was converted to Aₙ(t)(=the sum of the radioactivity measured for the n^{th} set of aliquots, where a set contains one aliquot from the working compartment and one from the auxiliary compartment collected at time t) in units of nCi by using the conversion, 0.001 nCi=2.2 DPM. The radioactivity of the cell solution prior to the removal of the aliquots, Rₙ(t), was calculated from Aₙ(t) by using Equation 10,

$${R}_{n} ( t ) = {A}_{n} ( t ) ( \frac{{V}_{n} ( t )}{{v}_{n} ( t )} ) \qquad ( 10 )$$

where Vₙ(t)=total volume of the cell solution prior to the removal of the n^{th} set of aliquots at time t, and Vₙ(t)=the total volume of the set of aliquots. To account for the quantity of radiation removed in prior sets of aliquots, the previous Aₙ(t) values were added to Rₙ(t) to furnish the total radioactivity leached off the electrode, TRₘ(t), according to Equation 11.

$$\begin{matrix}{TR}_{m} ( 0 ) = {R}_{n = m} ( 0 ) & m = 1 \\ {TR}_{m} ( t ) = {R}_{n = m} ( t ) + {\sum }_{n = 1}^{m - 1} {A}_{n} ( t ) & m > 1\end{matrix} \qquad ( 11 )$$

TRₘ(t) values were corrected for background radiation, by subtracting TR₁(0) using TR_{m,corr}(t)=TRₘ(t)−TR₁(0). At the conclusion of the experiment, concentrated HCl to was added to the electrolyte with the electrode immersed in the solution to dissolve the catalyst film completely. An aliquot was taken from the solution and the total radioactivity, TR_{m,corr}(acid), was determined by applying the same procedure to calculate previous TR_{m,corr}(t); thus, TR_{m,corr}(acid) accounts for all radioactivity available in the system, i.e., the sum of radioactivity removed from each set of aliquots and the total amount of radiation remaining in the cell. The percent value of the amount of radioactivity leached from the electrode was calculated by dividing TR_{m,corr}(t) by TR_{m,corr}(acid)×100%. The total amounts of radioactivity removed for the different experiments are shown in Table 3 as a percentage of the total available radioactivity in the system.

TABLE 3
Total Percentage of Radioactivity Removed by Taking Aliquots

| | | | vs. % |
|---|---|---|---|
| | | Potential/ | removed in |
| Experiment | Data location | NHE | aliquots |
| ⁵⁷Co leaching from Co-Pi | FIG. 24 (▪) | 1.30 V | 0.03 |
| | FIG. 24 () | no bias | 0.15 |
| ⁵⁷Co leaching from Co-X | FIG. 27 () | 1.51 V | 4.7 |
| | FIG. 27 (▪) | 1.30 V | 0.4 |
| | FIGS. 27, 28 (▴) | no bias | 0.01 |
| | FIG. 28 (▴) | no bias | 0.03 |
| ³²P leaching from Co-Pi | FIG. 25A (▪) | 1.3 V | 8.7 |
| | FIG. 25A () | No bias | 6.5 |
| ³²P leaching from Co-Pi | FIG. 29 (▪) | 1.3 V | 4.3 |
| | FIG. 29 () | no bias | 2.2 |

In ³²P uptake experiments, individual ITO plates with Co-Pi electrodeposited were dissolved with concentrated HCl into 10 mL of Pi electrolyte. The total radioactivity of the acidified catalyst, Rₙ(t), was calculated from a single aliquot, Aₙ(t) using Equation 7.

To minimize errors associated with deposition, electrodes were prepared simultaneously using multi-current collector arrays (FIG. 26) for a given type of experiment. Relative trends for experiments executed with simultaneously deposited catalysts were always preserved. Error among experimental runs was assessed from measurements of electrodeposited catalysts under identical experimental conditions (e.g., deposition time, potential, concentration of reactants, etc.). Two independent ⁵⁷Co leaching experiments using Co-Pi exhibited 1.6% and 1.3% leaching after 30 h in the absence of a potential bias. Similarly, two independent ⁵⁷Co leaching experiments using Co—X exhibited 0.18% and 0.16% leaching after 6 h in the absence of a potential bias. The estimate errors among experimental runs to be ˜15%.

³²P-Phosphate Leaching Experiments. Radiolabeled cobalt-phosphate (Co-Pi) catalyst films were prepared by performing controlled potential electrolysis on Pi containing radiolabeled Co in a two-compartment electrochemical H-cell with a glass frit junction of fine porosity. The auxiliary compartment was filled with 20 mL of Pi electrolyte and the working compartment was filled with 20 mL of Pi electrolyte containing 0.5 mM Co(NO₃)₂. 0.15 mL of ˜1.5 mCi of ³²P-orthophosphoric acid was added to the working compartment. The current collector consisted of two 2.5 cm×3.0 cm pieces of ITO-coated glass cut from commercially available slides. A two-headed alligator clip made in-house was used to connect the current collectors in parallel to the potentiostat and to position them 0.5-1 cm apart such that ITO-coated sides faced each other (FIG. 26A). Typically, a 3.75 cm² area of each current collector was immersed in the solution. The reference electrode was positioned between the current collectors. Electrolysis was carried out at 1.30 V without stirring and without iR compensation. Upon conclusion of electrolysis (15 min, 0.5 C/cm² passed), the electrodes were removed from solution and washed in triplicate by sequential immersion in a stirred 80 mL bath of fresh Pi electrolyte for 5 min

After washing, the electrodes were placed in the working compartments of two separate two-compartment electrochemical H-cells containing 25 mL of Pi in both compartments. The electrodes were submerged such that removal of aliquots did not expose the catalytic film to air. The reference electrode was positioned 2-3 mm from the working electrode. In one cell, electrolysis was carried out at 1.30 V with stirring and without iR compensation. The working compartment of the other cell was stirred but no potential was applied to the electrode. Aliquots were removed from the working and auxiliary chambers of each cell over the course of the experiment to determine the amount of radiolabeled phosphate that leached into the solution. Upon conclusion of the experiment, the reference electrode was removed and 3 mL of concentrated HCl was added to the working compartment of each cell to dissolve the film. This procedure left <0.4% residual radiation on the ITO substrate. An aliquot from the acidified solution was collected to determine the total ³²P content initially incorporated into the film. Each aliquot was combined with 10 mL of scintillation fluid and all samples were counted simultaneously at the conclusion of the experiment.

To exclude any effect attributable to pH change in the H-cell over the course of prolonged electrolysis, a similar experiment was conducted using 1.0 M KPi in place of 0.1 M KPi. For this experiment, deposition was conducted as described above using 1 mL of ˜10 mCi of ³²P-orthophosphoric acid to enrich 19 mL of 0.105 M KPi electrolyte containing 0.5 mM Co²⁺ in the working compartment. Electrolysis was carried out at 1.30 V without stirring and without iR compensation for 4 h (10.7 C/cm² passed). The leaching experiment was conducted using 1 M KPi but all other manipulations were the same.

³²P-Phosphate Uptake by the Co-Pi Catalyst. Non-radiolabeled catalyst films were prepared by performing controlled potential electrolysis on Pi containing Co²⁺ in a two-compartment electrochemical H-cell with a glass frit junction of fine porosity. The auxiliary compartment was filled with 20 mL of Pi electrolyte and the working compartment was filled with 20 mL of Pi electrolyte containing 0.5 mM of Co(NO₃)₂. The current collectors consisted of eight 0.7 cm×5.0 cm pieces of ITO-coated glass. An eight-headed alligator clip made in-house was used to connect the current collectors in parallel to the potentiostat and to position them in a circular arrangement such that ITO-coated sides faced toward the interior (FIG. 26C). Typically, a 1.05 cm² area of each current collector was immersed in the solution. The reference electrode was positioned in the center of the circular electrode array. Electrolysis was carried out at 1.30 V without stirring and without iR compensation. Upon conclusion of electrolysis (2 h, 3.9 C/cm² passed), the electrodes were removed from solution and washed in a stirred 80 mL bath of fresh Pi electrolyte for 5 min

The electrodes were transferred to two separate four-headed clips (FIG. 26B) and placed in the working compartments of two separate two-compartment cells containing 25 mL of Pi electrolyte in both compartments. Radiolabeled ³²P-orthophosphoric acid (˜1.5 mCi) was added to the working compartment of both cells. The reference electrode was positioned in the center of the four electrode array. In one cell, electrolysis was carried out at 1.30 V with stirring and without iR compensation. The working compartment of the other cell was stirred but no potential was applied to the electrodes. Individual electrodes were removed over the course of the experiment to determine the amount of radiolabeled phosphate incorporated into the film. Removed electrodes were washed in triplicate by sequential immersion in a stirred 80 mL bath of fresh Pi electrolyte for 5 mins. The films were subsequently placed in 10 mL of 0.1 M Pi electrolyte and dissolved with 2 mL of concentrated HCl. A 1 mL aliquot of this acidified solution was used to determine the level of phosphate incorporation. All aliquots were combined with 10 mL of scintillation fluid and all samples were counted simultaneously at the conclusion of the experiment.

⁵⁷Co Leaching and Uptake by the Co-Pi Catalyst. Radiolabeled Co-Pi catalyst films were prepared by performing controlled potential electrolysis on ⁵⁷Co-containing Pi solutions in a two-compartment electrochemical H-cell with a glass frit junction of fine porosity. The auxiliary compartment was charged with 20 mL of Pi electrolyte and the working compartment was charged with 20 mL of Pi electrolyte containing 0.5 mM Co(NO₃)₂ enriched with ˜10 mCi of ⁵⁷Co(NO₃)₂. The current collector consisted of two 2.5 cm×4.0 cm pieces of ITO-coated glass cut from commercially available slides. A two-headed alligator clip was used to connect the current collectors in parallel to the potentiostat and to position them 0.5-1 cm apart such that ITO-coated sides faced each other (FIG. 26A). Typically, a 3.75 cm² area of each current collector was immersed in the solution. The reference electrode was positioned between the working electrodes. Electrolysis was carried out at 1.30 V without stirring and without iR compensation. Upon conclusion of electrolysis (4.1 h, 10.0 C/cm² passed), the electrodes were removed from solution and washed in triplicate by sequential immersion in a stirred 80 mL bath of fresh Pi electrolyte for 5 min. After washing, the electrodes were placed in the working compartments of two separate two-compartment H-cells containing Pi electrolyte in both compartments. The reference electrode was positioned 2-3 mm from the working electrode. In one cell, electrolysis was initiated at 1.30 V with stirring and without iR compensation. The potential in the cell was cycled on and off as indicated in FIG. 24 in the text. The working compartment of the other cell was stirred but no potential was applied to the electrode. Aliquots were removed from the working and auxiliary chambers of each cell over the course of the experiment to determine the amount of radiolabeled cobalt in solution. Upon conclusion of the experiment, the reference electrode was removed and 3 mL of concentrated HCl was added to the working compartment of each cell to dissolve the film. An aliquot from the acidified solution was collected to determine the total ⁵⁷Co content initially incorporated in the film. Each aliquot was combined with 10 mL of scintillation fluid and all samples were counted simultaneously at the conclusion of the experiment.

⁵⁷Co Leaching and Phosphate-Induced Uptake by Co—X Films. Radiolabeled Co—X films were prepared by controlled potential electrolysis of ⁵⁷Co-containing K₂SO₄ electrolyte solutions in a single compartment electrochemical H-cell. The electrolysis solution consisted of 20 mL of 0.1 M K₂SO₄ electrolyte (pH 7.0) containing 25 mM of Co(NO₃)₂ enriched with ˜2 mCi of ⁵⁷Co(NO₃)₂. The current collector consisted of two 2.5 cm×4.0 cm pieces of ITO-coated glass cut from commercially available slides. A two-headed alligator clip was used to connect the current collectors in parallel to the potentiostat and to position them 0.5-1 cm apart such that ITO-coated sides faced each other (FIG. 26A). Typically, a 3.75 cm² area of each current collector was immersed in the solution. The reference electrode was positioned between the working electrodes. Electrolysis was carried out at 1.65 V with stirring and without iR compensation. Nickel foil was used as the auxiliary electrode. Upon conclusion of electrolysis (3.8-4.5 h, 16.4-29.2 C/cm² passed), the electrodes were removed from solution and washed in triplicate by sequential immersion in a stirred 80 mL bath of fresh 0.1 M K₂SO₄ (pH 7.0) for 5 min.

After washing, the electrodes were placed in the working compartments of two separate two-compartment electrochemical cells containing 0.1 M K₂SO₄ (pH 7.0) in both compartments. The reference electrode was positioned 2-3 mm from the working electrode. In one cell, electrolysis was initiated at 1.30 V or 1.51 V with stirring and without iR compensation. The working compartment of the other cell was stirred but no potential was applied to the electrode. After 30 h (1.30 V) and 18 h (1.51 V), 1 M KPi (pH 7.0) was added to the working and auxiliary compartments of all four cells to yield a final phosphate concentration of 0.1 M. For one of the cells, where no potential was applied, the electrode was removed prior to phosphate addition to ensure that Co²⁺ precipitation as CO₃(PO₄)₂ (Kₛₚ=2.05×10⁻³⁵) did not affect the data. Aliquots were removed from the working and auxiliary chambers of each cell over the course of the experiment to determine the amount of radiolabeled cobalt in solution. Upon conclusion of the experiment, 3-5 mL concentrated HCl was added to the working compartment of to each cell to dissolve the film. An aliquot from the acidified solution was collected to determine the total ⁵⁷Co content initially incorporated in the film. Each aliquot was combined with 10 mL of scintillation fluid and all samples were counted simultaneously at the conclusion of the experiment.

For films operated at 1.30 V and 1.51 V, significant leaching of cobalt is observed until phosphate is introduced, whereupon, Co is re-deposited onto the electrode rapidly (FIG. 27 in text). For the film that had no applied potential, a small amount of leaching (˜0.25%) is observed until phosphate is introduced, whereupon, the Co concentration in solution declines rapidly to ˜0.05% after 5 h (FIG. 28A). Without wishing to be bound by theory, the decrease in Co concentration in solution may be a result of either indiscriminate precipitation of Co²⁺ as CO₃(PO₄)₂ (Kₛₚ=2.05×10⁻³⁵) or re-deposition onto the electrode surface. Indiscriminate precipitation was ruled out by removing the electrode prior to phosphate addition. No decline in solution cobalt concentration is observed over 5 h (FIG. 28B) indicating that re-deposition onto the electrode is the cause of the observed decrease in FIG. 28A.

Na/K Exchange. Co-Pi catalyst films were prepared on large surface area FTO substrates containing a 0.5 cm wide strip of silver composition (DuPont 4922N, Delta Technologies) along one edge to enhance conductivity. Electrodepositions were carried out in large capacity two compartment electrochemical H-cells separated by a glass frit of fine porosity. The reference electrode was positioned 2-3 mm from the current collector. Depositions were conducted from quiescent solution at 1.30 V using either 0.1 M KPi (pH 7.0) or 0.1 M NaPi (pH 7.0) as supporting electrolyte. The electrode prepared from sodium containing electrolyte was rinsed with reagent grade water and placed in an electrolysis cell containing 0.1 M KPi (pH 7.0). Electrolysis was initiated at 1.30 V for 10 min. The electrode was subsequently rinsed with reagent grade water and dried in air. For the electrode prepared from potassium containing electrolyte, the same procedure was conducted with substitution of NaPi for KPi. Catalytic material was manually removed the FTO substrate to yield 8-12 mg of black powder, which was subjected to elemental microanalysis (Table 4).

TABLE 4
Elemental Composition of Catalyst Films

| Deposition | Operation | Co | P | Na | K |
|---|---|---|---|---|---|
| KPi, pH 7.0, 0.5 mM Co²⁺ | NaPi, pH 7.0 | 2.3 | 1 | 1.0 | <0.09 |
| NaPi, pH 7.0, 0.5 mM Co²⁺ | KPi, pH 7.0 | 2.5 | 1 | <0.08 | 0.9 |

### Example 20

The following example describe experiments regarding determination of the structure of a material comprising cobalt anions and anionic species comprising phosphate, according to a non-limiting embodiment.

Cobalt K-edge X-ray absorption spectroscopy was performed on freshly-prepared Co-Pi catalysts in situ at open circuit potential (OCP) and during active catalysis. These experiments employed a modified two-compartment electrolysis cell containing an X-ray transparent window, the solution-facing side of which was coated with a thin layer of ITO. The ITO served as the working electrode upon which the Co-Pi was deposited and X-ray absorption was measured as a fluorescence excitation spectrum. This configuration prevented interference from the electrolyte solution or bubbles that formed during catalysis.

Experiments were conducted with Co-Pi deposited from freshly prepared 0.5 mM Co²⁺ in 0.1 M KPi onto the ITO held at 1.25 V for 10 mM Following the deposition of Co-Pi, the Co²⁺-containing solution was removed from the cell and replaced with Co²⁺-free KPi. A potential of 1.25 V was applied briefly to the working electrode before the electrolysis cell was switched to open circuit and X-ray absorption spectra were collected. After collecting spectra at open circuit potential (OCP), spectra were collected at 1.25 V. Sustained anodic currents indicative of water oxidation were observed throughout acquisition of the spectra at this potential.

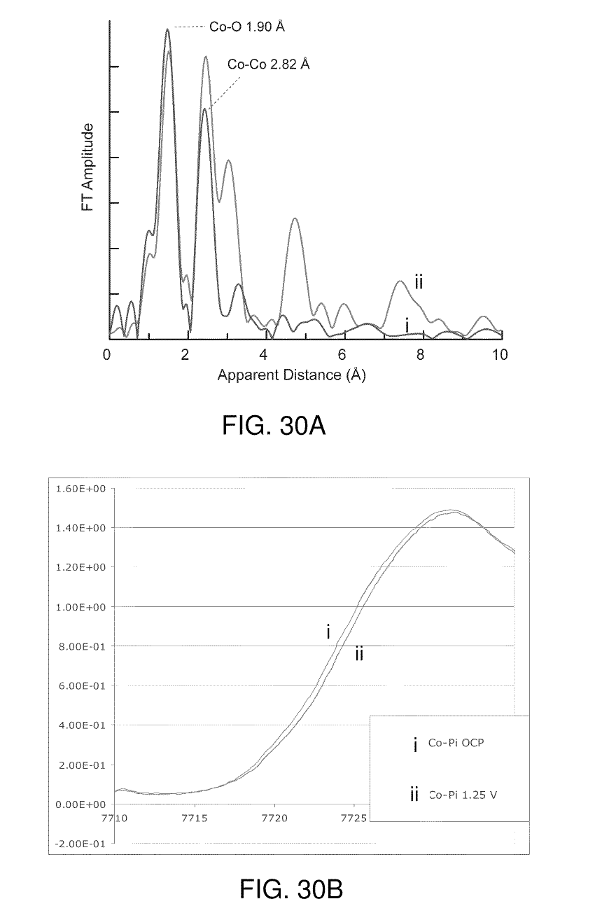

FIG. 30A shows the Fourier transforms of the extended x-ray absorption fine structure (EXAFS) spectrum of Co-Pi at open circuit potential (i). FT of the EXAFS spectrum of a common cobalt oxide, CO₃O₄ (ii), is shown for comparison. EXAFS simulations indicate that the two prominent peaks in the FT for Co-Pi correspond to Co—O and Co—Co distances of 1.90 Å and 2.82 Å, respectively. The corresponding coordination numbers are approximately 6 for Co—O and 3-4 for Co—Co. Without wishing to be bound by theory, these distances are consistent with Co³⁺ ions linked by bis-μ-oxo ligands. A higher-order structure wherein these individual bis-μ-oxo -linked dimers may be incorporated into linked cubanes or partial cubanes. The prominent peaks at higher apparent distance seen for CO₃O₄ are common in cobalt oxides and indicative of linear or approximately linear arrangements of three or more Co ions linked by oxide ligands. In addition, the absence of these peaks in Co-Pi is consistent with the lack of to long-range order in the material.

FIG. 30B shows the X-ray absorption near edge structure (XANES) spectrum for Co-Pi at (i) OCP vs. the same catalyst at (ii) 1.25 V (vs. NHE). Without wishing to be bound by theory, the position and shape of the edge for bulk Co-Pi at OCP are consistent with a structure composed predominantly of Co³⁺, as indicated by comparison to a collection of Co oxide model compounds. At 1.25 V, a shift of ˜0.6 eV in the Co-Pi edge is observed, although the shape remains very similar. This shift is consistent with a transition from a structure containing predominantly Co³⁺ to a structure containing a portion of Co⁴⁺.

### Example 21

The following examples described the operation of an electrode comprising a current collector and a catalytic material comprising cobalt and phosphate (e.g., formed using a method a described herein), using a water source containing at least one impurities.

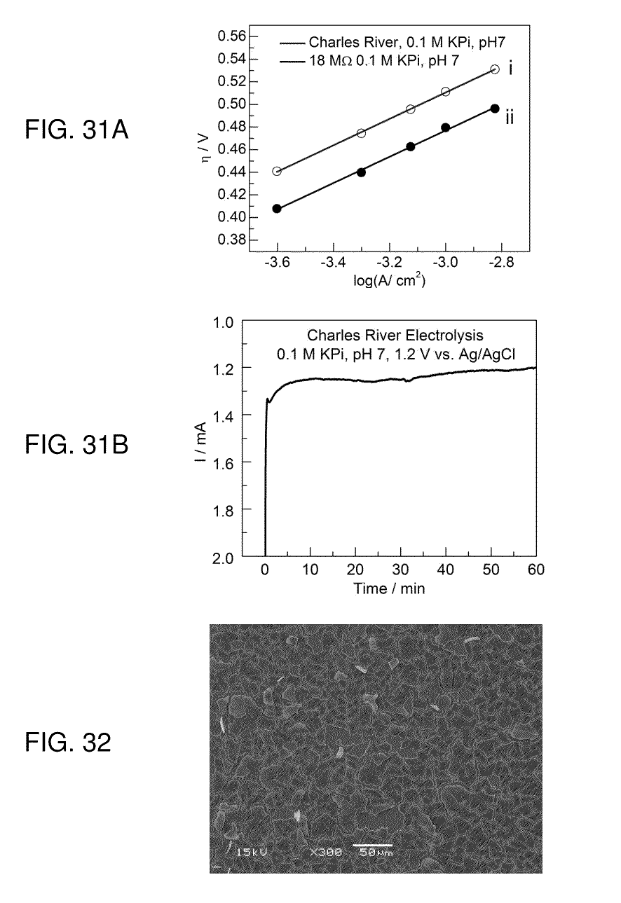

The water source, in the following experiment, was water from the Charles River, collected in Cambridge, Mass. The water was not purified prior to use. FIG. 31A shows a Tafel plot of the Co-Pi catalyst operated 0.1 M KPi solutions buffered at pH 7 prepared with (i) pure water of 18 MΩ resistivity and (ii) unpurified water from the Charles River. The Tafel slope is the approximately the same for both the purified and unpurified water sources, indicating that the mechanism of catalyst operation is unaffected by water impurities, however the overpotential does slightly increase (40 mV) at a given current density. Bulk electrolysis in unpurified Charles River water (FIG. 31B) shows that catalyst operation is stable over a one hour time period. Both experiments were conducted with Co-Pi films prepared on ITO coated glass substrates.

Similar experiments were conducted using a water source comprising Na₂SO₄ or NaNO₂. The collected data indicated that catalyst operation in 0.1 M KPi (pH 7) is unaffected by the presence of the sulfate anion (Na₂SO₄) at concentrations less than or equal to 100 mM and the nitrite anion (NaNO₂) at concentrations less than or equal to 10 mM.

### Example 22

The following example describes an electrolysis device comprising an electrode according to one embodiment, wherein the system is powered by a solar cell operating in a fuel cell mode. The experimental set-up comprised a thin film of Co-Pi on a planar to ITO electrode (1 cm²), a cathode composed of a Pt metal foil (1 cm²), a Nafion membrane separating the two electrodes, and a solution of 0.1 M phosphate buffer at pH 7, arranged as would be understood by those of ordinary skill in the art. The solar cell was used to supply a voltage of about 1.75 V across the anode and cathode. The system operated at a current density of about 0.35 mA/cm².

### Example 23

The following example describes the formation of a catalytic material comprising a first metal ionic species and a second metal ionic species. The catalytic material may be formed by application of a voltage to a current collector immersed in a solution comprising, in this example, 0.1 M methyl phosphonate solution buffered at pH 8.5 and the selected metal ionic species. For example, a voltage of 1.1 V vs. Ag/AgCl (˜1.3 vs. NHE) was applied to an ITO electrode immersed in a solution comprising 0.5 mM Co^{II}(NO₃)₂.6(H₂O) and 0.5 mM Mn^{II}Cl₂.4(H₂O), and 0.1 M methyl phosphonate buffered at pH 8.5. A reddish green material formed on the ITO electrode (FIG. 32). Elemental composition analysis confirmed that Mn was present in the material in an approximate Co:Mn ratio of 3:1 (see Table 5). It should be understood that the Si signal in the data may be accounted for from the glass substrate and the Fe signal is accounted for due to an impurity.

TABLE 5
Elemental Composition of Catalyst Films

| Element | series | [wt. %] | [norm. wt. %] | [norm. at. %] |
|---|---|---|---|---|
| Phosphorus | K-series | 9.398716 | 25.67622 | 34.75209 |
| Cobalt | K-series | 15.94964 | 43.57261 | 30.99541 |
| Manganese | K-series | 5.686832 | 15.53578 | 11.85506 |
| Iron | K-series | 0.154913 | 0.423204 | 0.317683 |
| Silicon | K-series | 5.414645 | 14.79219 | 22.07975 |
| | Sum: | 36.60475 | 100 | 100 |

In another experiment, a catalytic material was prepared using similar conditions as described above, wherein the solution comprised 0.5 mM Cu^{II}(SO₄), 0.5 mM Co^{II}(NO₃)₂, and 0.1 M methyl phosphonate at pH 8.5. The catalytic material formed, in this embodiment, had a ratio of cobalt to copper of about 5:1.

### Example 24

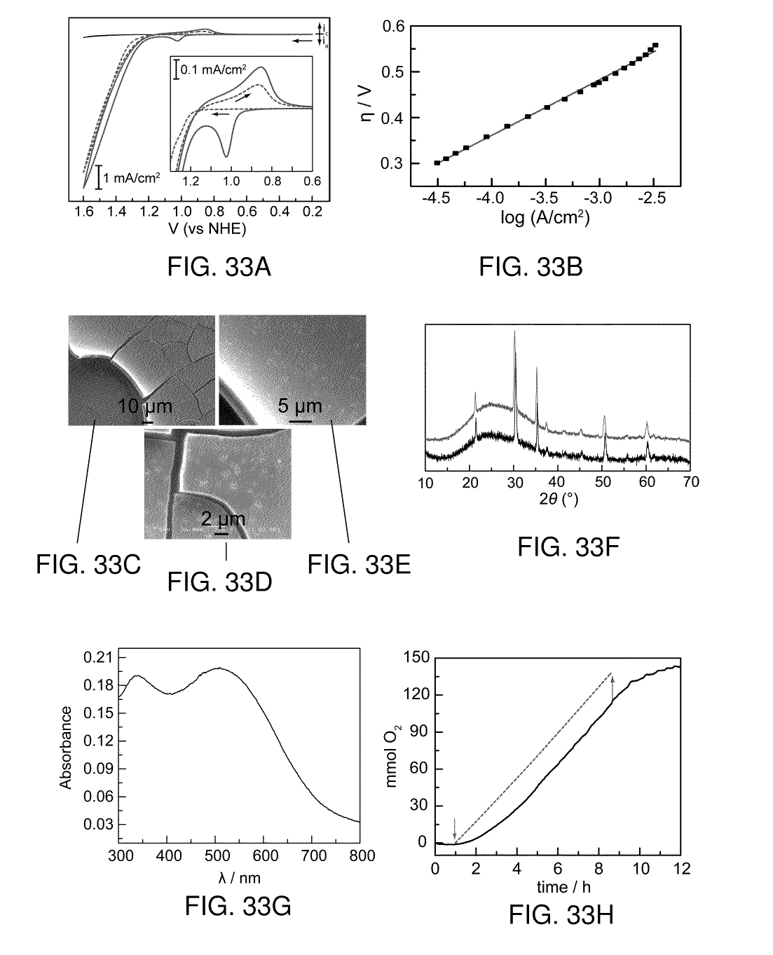

The following describes the synthesis of a catalytic material comprising nickel ions and anion species comprising boron. To form an electrode comprising the catalytic material, cyclic voltammetry (CV) of a 1 mM solution of Ni²⁺°in a 0.1 M H₂BO₃⁻/H₃BO₃ electrolyte at pH 9.2 (Bᵢ electrolyte) was conducted. As shown in FIG. 33A, the cyclic voltammetry shows an onset of a large catalytic wave at 1.2 V on the first anodic sweep of a glassy carbon electrode. Specifically, FIG. 33A shows the (i) first and second (ii) CV scans using a glassy carbon working electrode, 50 mV/s scan rate, of aqueous 1 mM Ni²⁺ solutions in 0.1 M B, electrolyte, pH 9.2, and (iii) CV trace in the absence of Ni²⁺. The cathodic return scan exhibits a broad feature at E_{p,c}=0.87 V vs. NHE, attributed to the reduction of a surface adsorbed species formed during the initial sweep through the catalytic wave. The subsequent CV scan displays a new sharp anodic pre-feature centered at E_{p,a}=1.02 V and a cathodically shifted catalytic wave with an onset potential of 1.15 V. By integration of the anodic pre-feature, we estimate that a monolayer of catalyst is deposited after a single CV scan whereas a film of 10-12 layers thick is produced after 20 scans, thus attesting to the controlled nature of this electrodeposition.

Neither film formation nor catalysis is observed in the absence of the buffering Bᵢ electrolyte. Thus, a CV of a 1 mM aqueous solution of Ni²⁺ in 0.1 M NaNO₃ electrolyte at pH 9.2 is indistinguishable from the electrode background in the absence of Ni²⁺. As was the case with Co, this suggests that a proton-accepting electrolyte, such as borate, is essential for facile electrodeposition and catalysis under these conditions.

The potential-dependent O₂ evolution activity of the Ni oxide film was evaluated in Ni-free Bᵢ electrolyte at pH 9.2. The current density, j, obtained for a thin film grown by passing 300 mC/cm² was measured as a function of the overpotential for O₂ evolution, η. A plot of log(j) vs. η (FIG. 33B) produced a slope of 121 mV/decade.

Microanalyses were performed by Columbia Analytics in Tucson, Ariz. The Ni oxide catalyst was prepared on large surface area (˜25×25 cm²) FTO-coated glass slides using filtered 1 mM Ni²⁺/0.1 M B, solutions. Upon termination of the electrolyses, the slides were immediately removed from the solution, rinsed with reagent-grade water, and allowed to dry in air. The electrodeposited material was carefully scraped off using a to razor blade and the material was submitted for microanalysis. The elemental composition for a sample prepared as above was: Ni, 43.6 wt. %; H, 2.16 wt. %; B, 2.7 wt. %; K, 1.1 wt. %. Without wishing to be bound by theory, a possible formula for the material is Ni_{2/3}^{IV}Ni_{1/3}^{III}O_{4/3}(OH)_{2/3}(H₂BO₃)_{1/3}.H₂O, however, it is unlikely that the composition of a dry film corresponds exactly to that of a film under operational conditions.

SEM micrographs were obtained of the catalytic material with a JSM-5910 microscope (JEOL). Following electrodeposition, catalyst samples were rinsed with deionized water and allowed to dry in air before loading into the instrument. Images were obtained with an acceleration voltage of 5-10 kV. FIGS. 33C-E displays SEM images of a catalyst prepared by passing 10 C/cm² at 1.3 V at various magnifications.

A powder X-ray diffraction pattern for a film grown by passing 10 C/cm² was obtained with a Rigaku RU300 rotating anode X-ray diffractometer (185 mm) using Cu Kα radiation (λ=1.5405 Å). FIG. 33F shows the powder X-ray diffraction patterns for (i) ITO anode, and for (ii) a catalyst film deposited on an ITO substrate. The only peaks in the diffraction pattern correspond to those pertaining to the ITO background, indicating that the electrodeposited nickel oxide catalyst is amorphous.

Spectra were recorded on a Spectral Instruments 400 series diode array spectrometer. The working electrode consisted of a 2 cm×0.8 cm piece of ITO coated quartz cut from a commercially available slide (Delta Technologies Inc.). Working, reference, and Pt auxiliary electrodes were fitted into a standard 1 cm path-length UV-V is cuvette to comprise a one compartment electrolysis cell. The spectrometer was blanked against a filtered solution of B, electrolyte containing Ni²⁺ (1 mM) and spectra were collected periodically while 1.2 V was applied. The spectrum recorded after 9 min of electrolysis is shown in FIG. 33G.

To determine the Faradiac efficiency of the electrode, an Ocean Optics oxygen sensor system was used to detect O₂ quantitatively. The experiment was performed in a custom built two-compartment gas-tight electrochemical cell with a 14/20 port on each compartment and a Schlenk connection with a Teflon valve on the working compartment. The B, electrolyte was degassed by bubbling with high purity N₂ for 12 h with vigorous stirring and it was transferred to the electrochemical cell under N₂. One compartment contained a Ni foam auxiliary electrode and the other compartment to contained the working and Ag/AgCl reference electrodes. The Ni catalyst was prepared from an electrodeposition as described above. The reference electrode was positioned several mm from the surface of the catalyst. The 14/20 port of the working compartment was fitted with a FOXY OR125-73 mm O₂ sensing probe connected to a MultiFrequency Phase Fluorometer. The phase shift of the O₂ sensor on the FOXY probe, recorded at 10 s intervals, was converted into the partial pressure of O₂ in the headspace using a two-point calibration curve (air, 20.9% O₂; and high purity N₂, 0% O₂). After recording the partial pressure of O₂ for 1 h in the absence of an applied potential, electrolysis was initiated at 1.3 V without iR compensation.

For determination of Faradic efficiency in the Bᵢ buffer, electrolysis with O₂ sensing was continued until 53.5 C passed. Upon terminating the electrolysis, the O₂ signal reached a plateau over the course of the next 3 h. During this time the O₂ level had risen from 0% to 6.98%. At the conclusion of the experiment, the volume of the solution (59.5 mL) and the volume of the headspace (48.0 mL) in the working compartment were measured. The total charge passed in the electrolysis was divided by 4F to get a theoretical O₂ yield of 138.3 umol. The measured partial pressure of O₂ was corrected for dissolved O₂ in solution using Henry's Law and converted, using the ideal gas law, into a measured O₂ yield of 143.4 umol (103.7%±5%). FIG. 33H shows (i) O₂ detected by fluorescence sensor, and (ii) theoretical O₂ trace assuming 100% Faradaic efficiency. The arrows indicate start and end of electrolysis.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

Those skilled in the art will recognize, or be able to ascertain using no more than routine experimentation, many equivalents to the specific embodiments of the invention described herein. It is, therefore, to be understood that the foregoing embodiments are to presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. An electrode, comprising:
a catalytic material comprising cobalt ions and anionic species comprising phosphorus.

2. (canceled)

3. A catalytic electrode, comprising:
a catalytic material absorbed or deposited on the electrode during at least some point of a reaction catalyzed by the catalytic material, wherein the electrode does not consist essentially of platinum, and is capable of catalytically producing oxygen gas from water at about neutral pH, with an overpotential of less than 0.4 volts at an electrode current density of at least 1 mA/cm².

4-7. (canceled)

8. The electrode of claim 3, wherein the catalytic material comprises metal ionic species and anionic species.

9. The electrode of claim 1, wherein the catalytic material is associated with a current collector.

10-19. (canceled)

20. The electrode of claim 3, wherein the current collector comprises less than about 99 weight percent platinum.

21. The electrode of claim 3, wherein the metal ionic species comprise cobalt ions.

22. The electrode of claim 3, wherein the metal ionic species comprise at least a first and a second type of metal ionic species.

23-24. (canceled)

25. The electrode of claim 3, wherein the anionic species does not consist essentially of hydroxide or oxide ions.

26. The electrode of claim 3, wherein the anionic species comprise at least a first type and a second type of anionic species.

27-28. (canceled)

29. The electrode of claim 3, wherein the anionic species comprise phosphorus.

30-31. (canceled)

32. The electrode of claim 3, wherein the anionic species is selected from the group comprising forms of phosphate, forms of sulphate, forms of carbonate, forms of arsenate, forms of phosphite, forms of silicate, or forms of borate.

33-38. (canceled)

39. The electrode of claim 1, wherein the catalytic material does not consist essentially of metal oxides or metal hydroxides.

40-41. (canceled)

42. The electrode of claim 3, wherein the current collector has a surface area between about 0.01 m²/g and about 300 m²/g.

43-60. (canceled)

61. The electrode of claim 1, wherein the electrode can catalytically produce oxygen from liquid water.

62. An electrolytic device comprising an electrode of claim 1.

63-202. (canceled)

203. A method, comprising:
producing oxygen gas from water at an overpotential of less than 0.4 volts at an electrode current density of at least 1 mA/cm², wherein the water comprises at least one impurity that is substantially non-participative in the catalytic reaction, present in an amount of at least 1 part per million in the water.

204-213. (canceled)

214. The method of claim 203, comprising producing oxygen gas from water at a water pH of from about 5.5 to about 8.5.

215-252. (canceled)

253. The method of claim 203, wherein the at least one impurity comprises a metal.

254-255. (canceled)

256. The method of claim 203, wherein the at least one impurity is an organic material, a small organic molecule, a bacteria, a pharmaceutical compound, a herbicide, a pesticide, a protein, or an inorganic compound.

257-307. (canceled)

308. The method of claim 203, wherein the electrode is capable of catalytically producing oxygen gas from water with a Faradaic efficiency of at least about 90%.

309-312. (canceled)
